(19) United States
(12) Patent Application Publication
(10) Pub. No.: US 2025/0321399 A1
(43) Pub. Date: Oct. 16, 2025

(54) OPTICAL SYSTEM AND CAMERA MODULE FOR VEHICLE

(71) Applicant: LG INNOTEK CO., LTD., Seoul (KR)

(72) Inventor: Chang Gyun SON, Seoul (KR)

(21) Appl. No.: 18/259,472

(22) PCT Filed: Dec. 28, 2021
(86) PCT No.: PCT/KR2021/020086

§ 371 Date: Jun. 27, 2023

(30) Foreign Application Priority Data
Dec. 28, 2020 (KR) 10-2020-0185116

(51) Int. Cl. G02B 9/62; G02B 1/04; G02B 3/04; H04N 23/55

(52) U.S. Cl. CPC G02B 9/62; G02B 1/041; G02B 3/04; H04N 23/55

(57) ABSTRACT

An optical system for a vehicle disclosed in an embodiment of the invention includes a first to sixth lens disposed along an optical axis in a direction from an object side to a sensor side. The first lens includes an object-side first surface convex and a sensor-side second surface concave on the optical axis, the second lens includes an object-side third surface and a sensor-side fourth surface, and the third lens includes an object-side fifth surface and a sensor-side sixth surface, the fourth lens includes an object-side seventh surface and a sensor-side eighth surface, and the fifth lens includes an object-side ninth surface and a sensor-side tenth surface. The sixth lens includes an object-side eleventh surface convex and a sensor-side eleventh surface concave on an optical axis, and an effective diameter of the first lens is larger than an effective diameter of each of the second to sixth lenses, and the first lens includes a glass material, the sixth lens have the eleventh and twelfth surfaces having aspherical surface and made of a plastic material, and at least three of the second to sixth lenses may be made of a plastic material.

### TECHNICAL FIELD

An embodiment of the invention relates to an optical system and a camera module for a vehicle.

### BACKGROUND ART

ADAS (Advanced Driving Assistance System) is an advanced driver assistance system for assisting the driver in driving, and consists of sensing the situation ahead, determining the situation based on the sensed result, and controlling the vehicle behavior based on the situation judgment. For example, an ADAS sensor device detects a vehicle ahead and recognizes a lane. Then, when the target lane, target speed, and forward target are determined, the vehicle's electrical stability control (ESC), EMS (Engine management system), and MDPS (Motor driven power steering) are controlled. Typically, ADAS may be implemented as an automatic parking system, a low-speed city driving assistance system, a blind spot warning system, and the like. in ADAS, sensor devices for sensing the situation ahead are a GPS sensor, laser scanner, front radar, lidar, etc., and the most representative is a front camera for capturing the front of the vehicle.

In recent years, research on a sensing system for sensing the surroundings of a vehicle for driver's safety and convenience has been accelerated. The vehicle detection system is used for various purposes, such as detecting objects around the vehicle to prevent collisions with objects not recognized by the driver, and automatically parking by detecting empty spaces, and provides the most essential data for automatic vehicle control. As such a detection system, a method using a radar signal and a method using a camera are commonly used. A camera module for a vehicle is used by being built into a front and rear surveillance camera and a dashboard camera in an automobile, and takes a picture or video of a subject. Since the vehicle camera module is exposed to the outside, photographing quality may deteriorate due to humidity and temperature. In particular, the camera module has a problem in that optical characteristics are changed depending on the ambient temperature and the material of the lens.

### DISCLOSURE

### TECHNICAL PROBLEM

An embodiment of the invention may provide an optical system for a vehicle in which a plastic lens and a glass lens are mixed and a camera module having the same. An embodiment of the invention may provide an optical system for a vehicle in which a lens having an aspherical surface and a lens having a spherical surface are mixed on the object-side surface and the sensor-side surface, and a camera module having the same. An embodiment of the invention may provide an optical system having at least six lenses in which a lens made of plastic and a lens made of glass are aligned in a direction of an optical axis, and a camera module including the same.

### TECHNICAL SOLUTION

An optical system for a vehicle according to an embodiment of the invention includes a first lens, a second lens, a third lens, a fourth lens, a fifth lens, and a sixth lens disposed along an optical axis in a direction from an object side to a sensor side, the first lens includes an object-side first surface convex and a sensor-side second surface concave on an optical axis, the second lens includes an object-side third surface and a sensor-side fourth surface, and the third lens includes an object-side fifth surface and a sensor-side sixth surface, the fourth lens includes an object-side seventh surface and a sensor-side eighth surface, the fifth lens includes an object-side ninth surface and a sensor-side tenth surface, the sixth lens includes an object-side eleventh surface convex and a sensor-side twelfth surface concave on the optical axis, an effective diameter of the first lens is larger than an effective diameter of each of the second to sixth lenses, and the first lens includes a glass material, the eleventh and twelfth surfaces of the sixth lens have aspheric surfaces and the sixth lens is made of plastic material, at least three of the second to sixth lenses may be made of a plastic material.

According to an embodiment of the invention, the second lens is made of glass, and a ratio of a lens made of plastic to a lens made of glass in the optical system may be 1:1. The second lens may be made of glass, and a ratio of a lens made of plastic to a lens made of glass in the optical system may be 2:1. In the optical system, TTL is 40 mm or less, and F number may be 1.7 to 2.2.

According to an embodiment of the invention, a center thickness of the fifth lens may be the thickest among the lenses of the optical system. A distance between the first and second lenses may be the largest among distances between lenses in the optical system. An Abbe number of the first lens is the largest among the lenses of the optical system and may be 70 or more. The second lens has the third surface convex and the fourth surface convex on the optical axis, the third lens has the fifth surface convex and the sixth surface concave on the optical axis, and the fourth lens has the seventh surface convex and the eighth surface concave on the optical axis, and the fifth lens may have the ninth surface convex and the tenth surface convex on the optical axis.

According to an embodiment of the invention, a center thickness of the second lens may be the thickest among lenses in the optical system, and a distance between the first and second lenses may be the largest among distances between lenses in the optical system. The Abbe number of the first lens may be the largest among the lenses of the optical system and may be 70 or more, and the Abbe numbers of the third lens and the sixth lens may be 30 or less. The second lens has a third surface convex and a fourth surface concave on the optical axis, the third lens has a fifth surface convex and a sixth surface convex on the optical axis, the fourth lens has a seventh surface convex and an eighth surface convex on the optical axis, and the fifth lens may have a ninth surface convex and a tenth surface concave on the optical axis.

According to an embodiment of the invention, a center thickness of the second lens may be the thickest among lenses in the optical system, and a distance between the second and third lenses may be the largest among distances between lenses in the optical system. The Abbe number of the first lens may be the largest among the lenses of the optical system and may be 70 or more, and the Abbe number of the fourth lens may be 30 or less. The second lens has a concave third surface and a fourth surface convex on the optical axis, the third lens has a fifth surface convex and a sixth surface concave on the optical axis, the fourth lens has a seventh surface convex and an eighth surface concave on the optical axis, and the fifth lens may have a ninth surface convex and a tenth surface concave on the optical axis.

According to an embodiment of the invention, a center thickness of the second lens may be the thickest among lenses in the optical system, and a distance between the first and second lenses may be the largest among intervals between lenses in the optical system. The Abbe number of the first lens may be the largest among the lenses of the optical system and may be 70 or more, and the Abbe numbers of the third lens and the sixth lens may be 30 or less. The second lens has a third surface convex and a fourth surface concave on the optical axis, the third lens has a fifth surface convex and a sixth surface convex on the optical axis, the fourth lens has a seventh surface convex and an eighth surface convex on the optical axis, and the fifth lens may have a ninth surface convex and a tenth surface concave on the optical axis.

According to an embodiment of the invention, a center thickness of the second lens is the thickest among the lenses of the optical system, a center thickness of the fourth lens is the thinnest among the lenses of the optical system, and a distance between the third and fourth lenses may be the largest among the distances between the lenses in the optical system. The Abbe number of the first and third lenses may be the largest among the lenses of the optical system and may be 70 or more, and the Abbe number of the fourth lens may be 30 or less. The second lens has a third surface concave and a fourth surface convex on the optical axis, the third lens has a fifth surface convex and a sixth surface concave on the optical axis, the fourth lens has a seventh surface concave and a eighth surface concave on the optical axis, and the fifth lens may have a ninth surface convex and a tenth surface convex on the optical axis.

According to an embodiment of the invention, the first lens may have negative refractive power, the second lens may have positive refractive power, the fifth lens may have positive refractive power, and the sixth lens may have negative refractive power.

A camera module according to an embodiment of the invention includes an image sensor; an optical filter on the image sensor; a cover glass disposed between the optical filter and the image sensor; an optical system including a first lens, a second lens, a third lens, a fourth lens, a fifth lens, and a sixth lens disposed along an optical axis in a direction from an object side to a sensor side; and an aperture stop disposed on a sensor-side circumference of the third lens or an object-side circumference of the third lens, wherein the first lens includes an object-side first surface convex and a sensor-side second surface concave on an optical axis, the sixth lens includes an object-side eleventh surface convex and a sensor-side twelfth surface concave on an optical axis, an effective diameter of the first lens is larger than an effective diameter of each of the second to sixth lenses, and the first and second lenses include a glass material, the sixth lens includes aspherical eleventh and twelfth surfaces and is made of plastic, and at least three of the second to sixth lenses are made of plastic, and a ration of a plastic lens to a glass lens among the first to sixth lenses may be 1:1 to 2:1.

According to an embodiment of the invention, the first lens may have negative refractive power, the second lens may have positive refractive power, the fifth lens may have positive refractive power, and the sixth lens may have negative refractive power. The third lens may have positive or negative refractive power, and the fourth lens may have positive or negative refractive power.

### ADVANTAGEOUS EFFECTS

The optical system according to an embodiment of the invention suppresses the thermal deformation of the lens at high temperature by mixing a lens made of plastic and a lens made of glass, while the weight of the module may be reduced and the unit price may increase due to the increase in material cost. According to an embodiment of the invention, it is possible to suppress deformation of a lens or deterioration of resolving power at a high temperature. In addition, stable optical performance may be implemented despite changes in ambient temperature. According to an embodiment of the invention, reliability of a vehicle optical system, a camera module, and a vehicle camera device having the same may be improved.

### DESCRIPTION OF DRAWINGS

FIG. 1 is an example of a plan view of a vehicle to which a camera module or optical system according to an embodiment of the invention is applied.

FIG. 2 is a side cross-sectional view showing an optical system for a vehicle according to a first embodiment of the invention.

FIG. 3 is a graph showing relative illumination according to image height in the optical system of FIG. 2.

FIG. 4 is a diagram showing horizontal and vertical FOVs according to aberration characteristics in the optical system of FIG. 2.

FIG. 5 to FIG. 7 are graphs showing a modulation transfer function (MTF) of diffraction at low temperature, room temperature, and high temperature in the optical system of FIG. 2, and are graphs showing modulation of luminance according to spatial frequency.

FIG. 8 to FIG. 10 are graphs showing a MTF at low temperature, room temperature, and high temperature in the optical system of FIG. 2, and are graphs showing a luminance ratio according to a defocusing position.

FIG. 11 to FIG. 13 are diagrams showing graphs of longitudinal spherical aberration, astigmatic field curves, and distortion at low temperature, room temperature, and high temperature in the optical system of FIG. 2.

FIG. 14 to FIG. 16 are graphs showing actual image heights according to lateral color aberration at low temperature, room temperature, and high temperature in the optical system of FIG. 2.

FIG. 17 is a side cross-sectional view showing an optical system for a vehicle according to a second embodiment of the invention.

FIG. 18 is a graph showing relative illumination according to image height in the optical system of FIG. 17.

FIG. 19 is a diagram showing horizontal and vertical FOVs according to aberration characteristics in the optical system of FIG. 17.

FIG. 20 to FIG. 22 are graphs showing the modulation transfer function (MTF) of diffraction at low temperature, room temperature, and high temperature in the optical system of FIG. 17, and are graphs showing the luminance ratio (modulation) according to the spatial frequency.

FIG. 23 to FIG. 25 are graphs showing the MTF at low temperature, room temperature, and high temperature in the optical system of FIG. 17, and are graphs showing the luminance ratio according to the defocusing position.

FIG. 26 to FIG. 28 are graphs of longitudinal spherical aberration, astigmatic field curves, and distortion in the optical system of FIG. 17 at low temperature, room temperature, and high temperature.

FIG. 29 to FIG. 31 are graphs showing actual image heights according to transverse chromatic aberration at low temperature, room temperature, and high temperature in the optical system of FIG. 17.

FIG. 32 is a side cross-sectional view showing an optical system for a vehicle according to a third embodiment of the invention.

FIG. 33 is a graph showing relative illumination according to image height in the optical system of FIG. 32.

FIG. 34 is a diagram illustrating horizontal and vertical FOVs according to aberration characteristics in the optical system of FIG. 32.

FIG. 35 to FIG. 37 are graphs showing the MTF at low temperature, room temperature, and high temperature in the optical system of FIG. 32, and are graphs showing the luminance ratio according to the defocusing position.

FIG. 38 to FIG. 40 are graphs showing the MTF at low temperature, room temperature, and high temperature in the optical system of FIG. 32, and are graphs showing the luminance ratio according to the defocusing position.

FIG. 41 to FIG. 43 are diagrams illustrating graphs of longitudinal spherical aberration, astigmatic field curves, and distortion in the optical system of FIG. 32 at low temperature, room temperature, and high temperature.

FIG. 44 to FIG. 46 are graphs showing actual image heights according to transverse chromatic aberration at low temperature, normal temperature, and high temperature in the optical system of FIG. 32.

FIG. 47 is a side cross-sectional view showing an optical system for a vehicle according to a fourth embodiment of the invention.

FIG. 48 is a graph showing relative illumination according to image height in the optical system of FIG. 47.

FIG. 49 is a diagram showing horizontal and vertical FOVs according to aberration characteristics in the optical system of FIG. 47.

FIG. 50 to FIG. 52 are graphs showing the MTF at low temperature, room temperature, and high temperature in the optical system of FIG. 47, and are graphs showing the luminance ratio according to the defocusing position.

FIG. 53 to FIG. 55 are graphs showing the MTF at low temperature, room temperature, and high temperature in the optical system of FIG. 47, and are graphs showing the luminance ratio according to the defocusing position.

FIG. 56 to FIG. 58 are graphs of longitudinal spherical aberration, astigmatic field curves, and distortion in the optical system of FIG. 47 at low temperature, room temperature, and high temperature.

FIG. 59 to FIG. 61 are graphs showing actual image heights according to transverse chromatic aberration at low temperature, room temperature, and high temperature in the optical system of FIG. 47.

FIG. 62 is a side cross-sectional view showing an optical system for a vehicle according to a fifth embodiment of the invention.

FIG. 63 is a graph showing relative illumination according to image height in the optical system of FIG. 62.

FIG. 64 is a diagram showing horizontal and vertical FOVs according to aberration characteristics in the optical system of FIG. 62.

FIG. 65 to FIG. 67 are graphs showing the MTF at low temperature, room temperature, and high temperature in the optical system of FIG. 62, and are graphs showing the luminance ratio according to the defocusing position.

FIG. 68 to FIG. 70 are graphs showing the MTF at low temperature, room temperature, and high temperature in the optical system of FIG. 62, and are graphs showing the luminance ratio according to the defocusing position.

FIG. 71 to FIG. 73 are diagrams illustrating graphs of longitudinal spherical aberration, astigmatic field curves, and distortion in the optical system of FIG. 62 at low temperature, room temperature, and high temperature.

FIG. 74 to FIG. 76 are graphs showing actual image heights according to transverse chromatic aberration at low temperature, room temperature, and high temperature in the optical system of FIG. 72.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected ”, “coupled” or “joined” to another component, the description may include not only being directly connected, coupled or joined to the other component but also being “connected ”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. In addition, several embodiments described below may be combined with each other unless specifically stated that they cannot be combined with each other. In addition, unless otherwise specified, descriptions for other embodiments may be applied to missing parts in the description of any one of several embodiments.

In the description of the invention, the first lens means the lens closest to the object side, and the last lens means the lens closest to the image side (or sensor surface). Unless otherwise specified in the description of the invention, all units for the radius, thickness/distance, TTL, etc. of the lens are mm. In this specification, the shape of the lens is shown based on the optical axis of the lens. For example, the fact that the object side of the lens is convex means that the object side of the lens is convex in the vicinity of the optical axis, not convex around the optical axis. Therefore, even when it is described that the object side of the lens is convex, the portion around the optical axis on the object side of the lens may be concave. In this specification, it is noted that the thickness and radius of curvature of the lens are measured based on the optical axis of the lens.

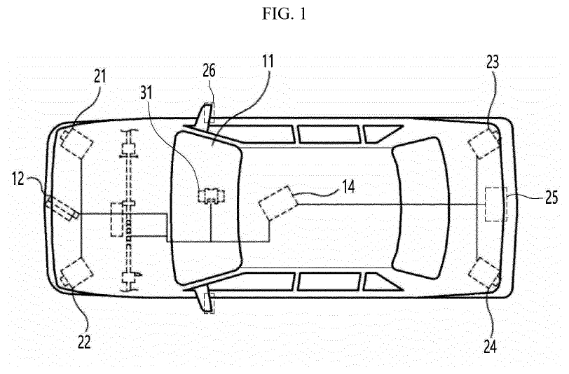

FIG. 1 is an example of a plan view of a vehicle to which a camera module or optical system according to an embodiment of the invention is applied. Referring to FIG. 1, a vehicle camera system according to an embodiment of the invention includes an image generating unit 11, a first information generating unit 12, and a second information generating unit 21, 22, 23, 24, 25, and 26 and a control unit 14. The image generating unit 11 may include at least one camera module 31 disposed in the vehicle, and may generate a front image of the own vehicle or an image of the inside of the vehicle by photographing the front of the vehicle and/or the driver. The image generating unit 11 may generate an image of the surroundings of the own vehicle by capturing not only the front of the own vehicle but also the surroundings of the own vehicle in one or more directions using the camera module 31. Here, the front image and the surrounding image may be digital images, and may include color images, black and white images, and infrared images. In addition, the front image and the surrounding image may include still images and moving images. The image generating unit 11 provides the driver's image, front image, and surrounding image to the control unit 14. Subsequently, the first information generating unit 12 may include at least one radar or/and camera disposed in the own vehicle, and detects the front of the own vehicle to generate first detection information. Specifically, the first information generating unit 12 is disposed in the own vehicle and generates first detection information by detecting the location and speed of vehicles located in front of the own vehicle, presence and location of pedestrians, and the like.

Using the first detection information generated by the first information generating unit 12, it is possible to control the distance between the own vehicle and the preceding vehicle to be constant, it is possible to increase the stability of vehicle operation in a predetermined specific case, such as when the driver wants to change the driving lane of the vehicle or when parking in reverse. The first information generating unit 12 provides the first sensing information to the control unit 14. The second information generating unit 21, 22, 23, 24, 25, and 26 detect each side of the vehicle and generate second detection information. When each side of the vehicle is sensed, it is sensed based on the front image generated by the image generating unit 11 and the first detection information generated by the first information generating unit 12. Specifically, the second information generating units 21, 22, 23, 24, 25, and 26 may include at least one radar or/and camera disposed in the own vehicle, and may detect or capture the position and speed of vehicles located on the side of the own vehicle. Here, the second information generating units 21, 22, 23, 24, 25, and 26 may be disposed at both front corners, side mirrors, and rear center and rear corners of the vehicle, respectively. Such a vehicle camera system may include a camera module having an optical system described in the following embodiment(s), it is possible to protect the vehicle and objects from autonomous driving or surrounding safety by providing or processing the information acquired through the front, rear, each side or corner region of the own vehicle to the user.

A plurality of optical systems of the camera module according to the embodiment of the invention may be mounted in a vehicle in order to enhance safety regulation, self-driving function, and convenience. In addition, the optical system of the camera module is applied to a vehicle as a component for controlling a lane keeping assistance system (LKAS), a lane departure warning system (LDWS), and a driver monitoring system (DMS). Such a camera module for a vehicle may realize stable optical performance even when the ambient temperature changes and provides a module with a competitive price, thereby securing reliability of vehicle components

In the description of the invention, the first lens means the lens closest to the object side, and the last lens means the lens closest to the image side (or sensor-side surface). The last lens may include a lens adjacent to the image sensor. Unless otherwise specified in the description of the invention, the units for the radius, thickness/distance, TTL, etc. of the lens are all mm and are measured based on the optical axis. In this specification, a shape of the lens is shown based on the optical axis of the lens. For example, that the object-side surface of the lens is convex or concave means that the object-side surface of the lens is convex or concave around the optical axis, but does not mean that the object-side surface of the lens is convex or concave. Therefore, even when it is described that the object-side surface of the lens is convex, the portion around the optical axis on the object-side surface of the lens may be concave or vice versa. Also, the “object-side surface” may refer to a surface of a lens facing the object side based on an optical axis, and the “image-side surface” may refer to a surface of a lens facing an imaging surface based on an optical axis. The object-side surface may be an object-side surface or an incident-side surface through which light is incident, and the image-side surface may mean a sensor-side surface or an emission-side surface through which light is emitted.

An optical system according to an embodiment of the invention may include a lens made of glass and a lens made of plastic. The optical system may include at least two lenses made of glass and at least three lenses made of plastic. A ratio of the number of glass lenses to plastic lenses among the lenses in the optical system may be in the range of 1:2 to 2:1. The lenses made of glass of the total lenses in the optical system may be 50% or less, for example, 35% or less, and the lenses made of plastic of the total lenses in the optical system may be 50% or more, for example, 75% or more. The lens in the optical system may include at least 5 or more, for example, 6 or more lenses.

### First Embodiment

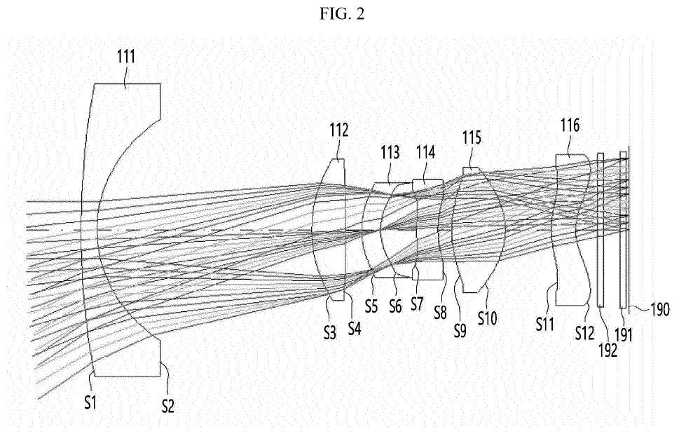

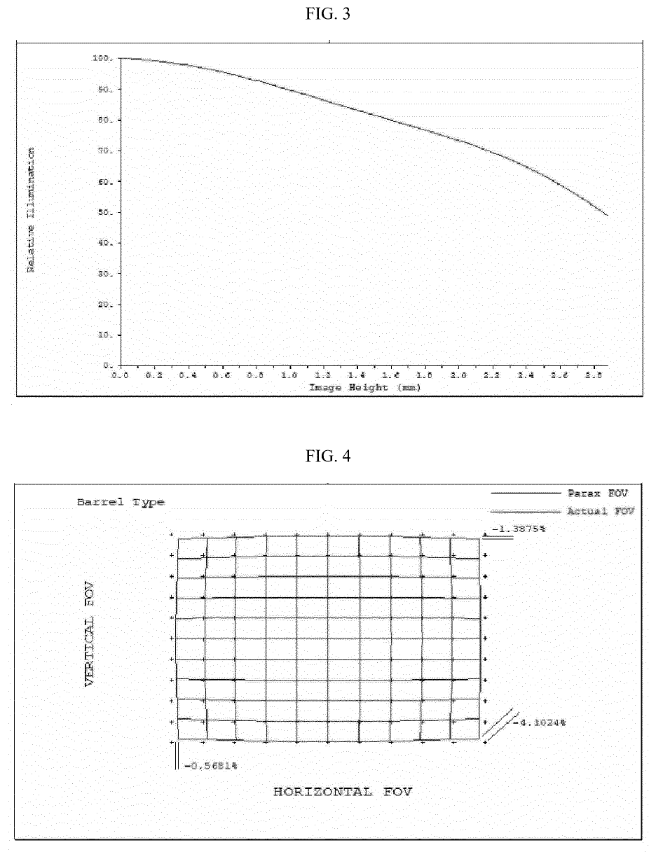

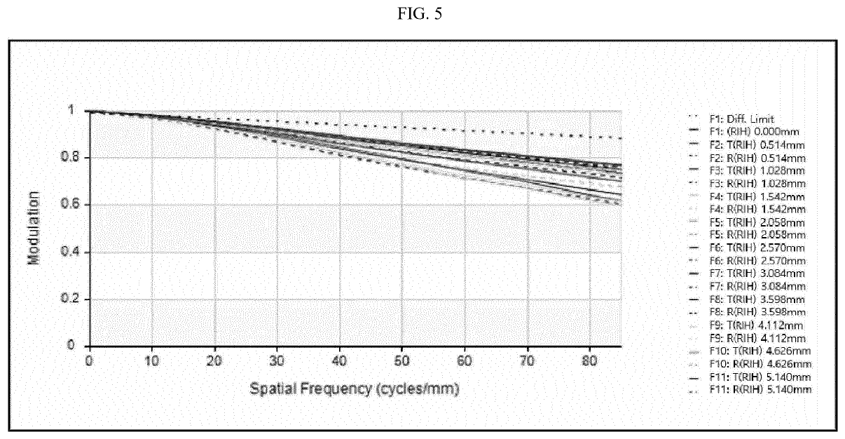

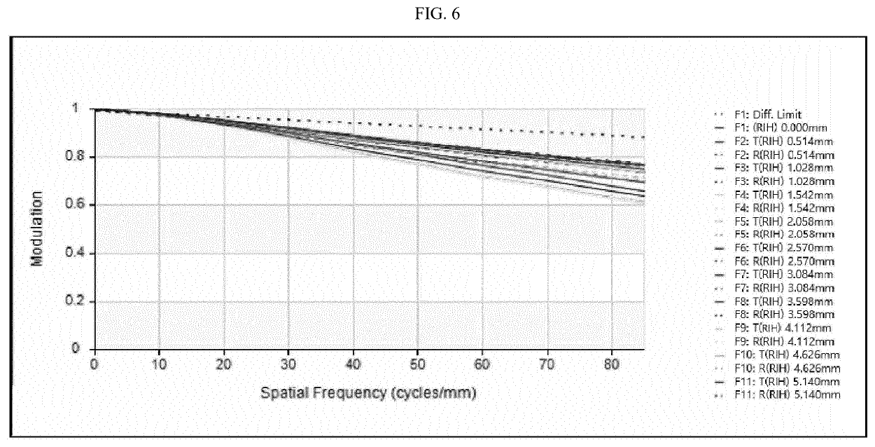

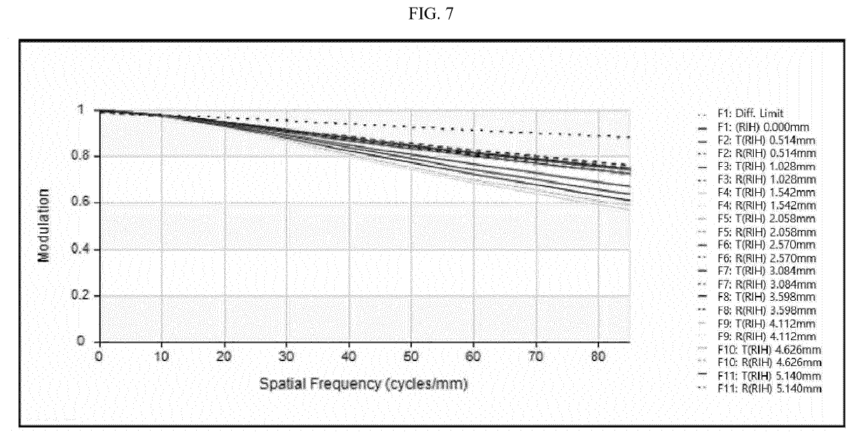

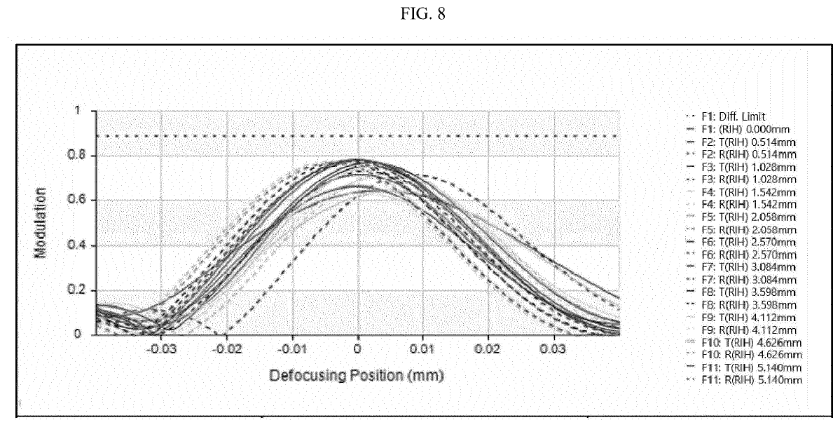

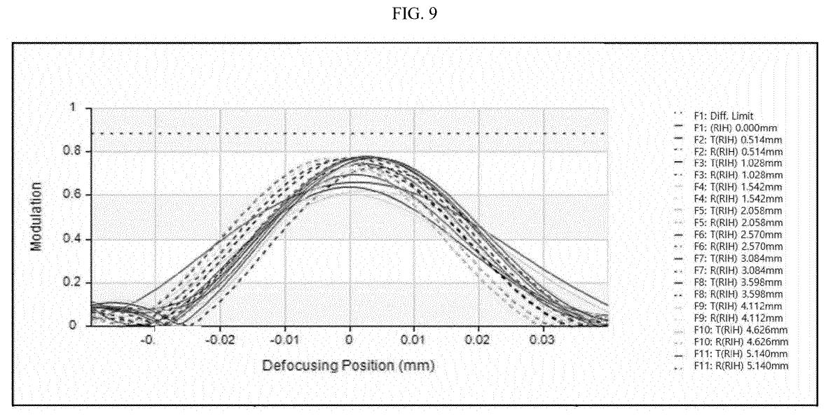

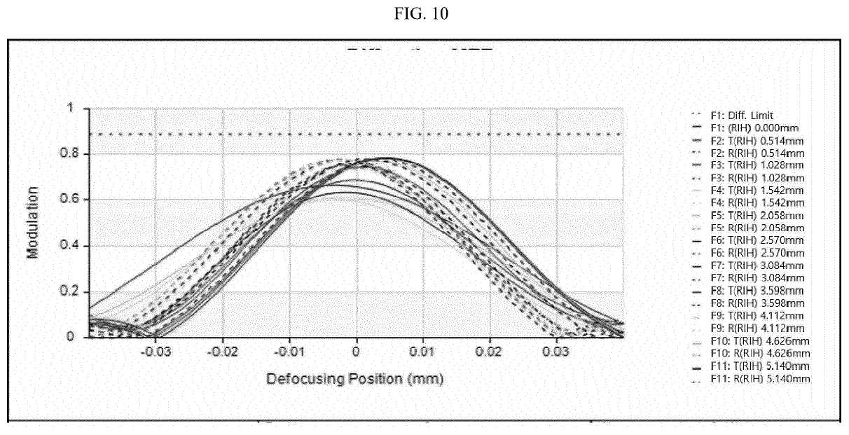

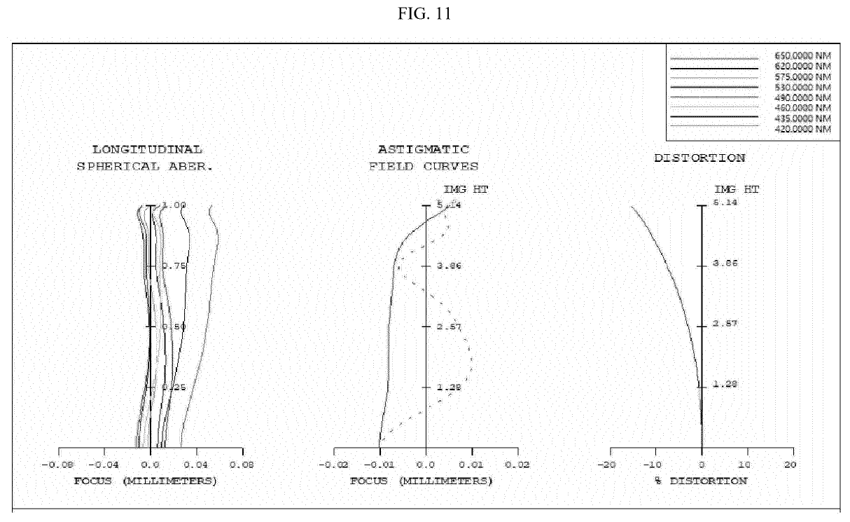

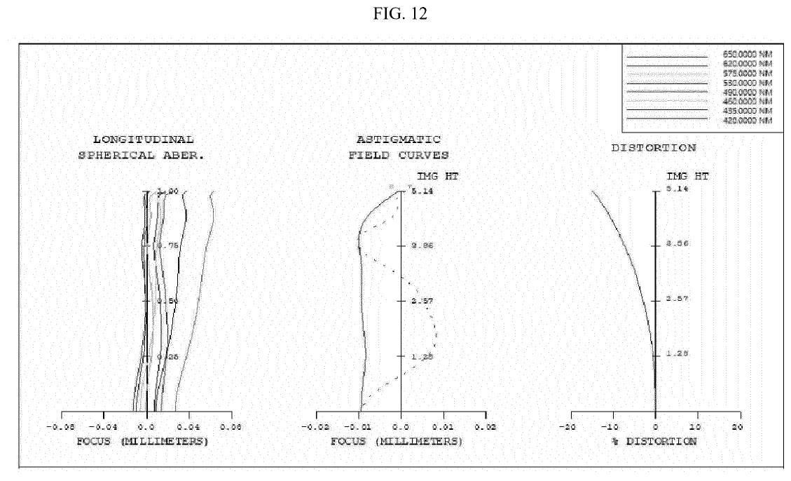

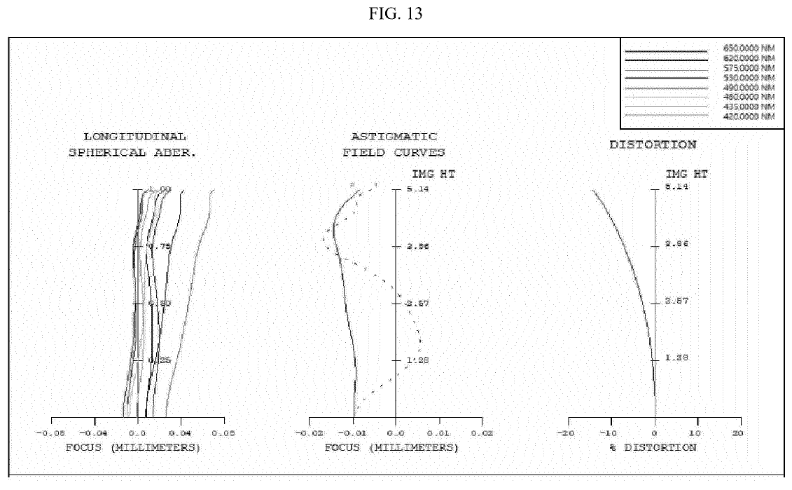

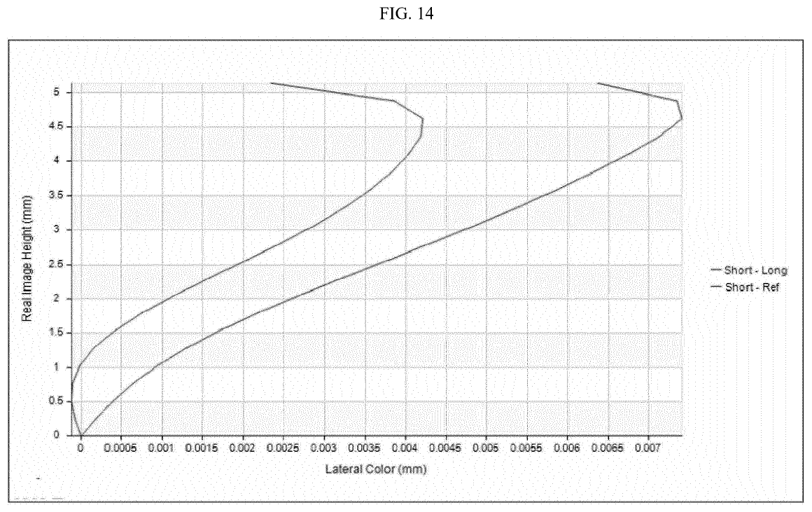

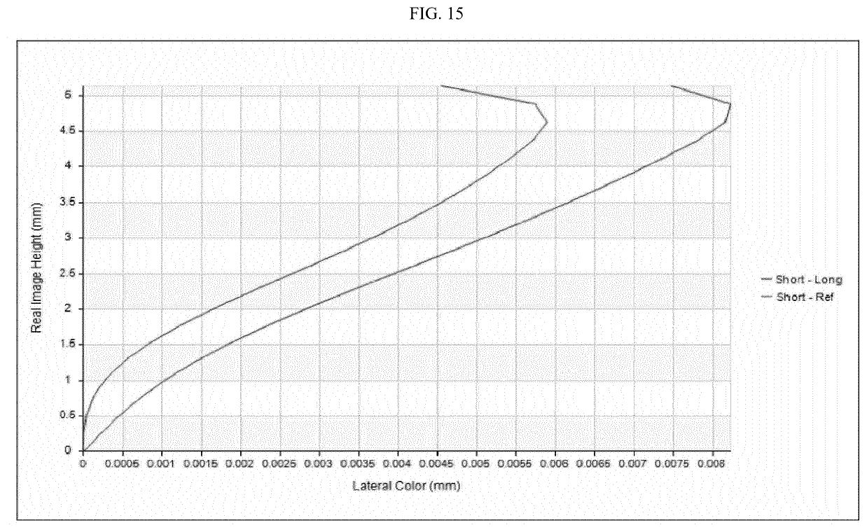

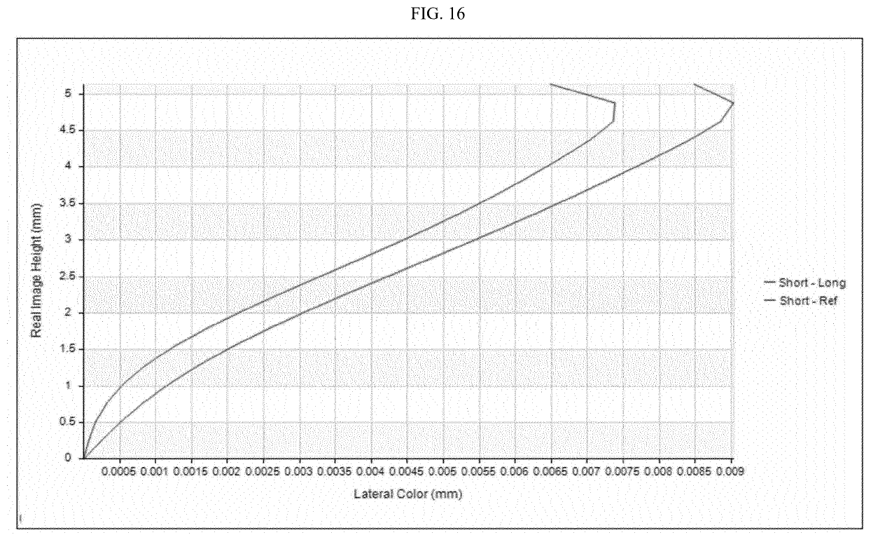

FIG. 2 is a side cross-sectional view showing an optical system for a vehicle according to a first embodiment of the invention, FIG. 3 is a graph showing relative illumination according to image height in the optical system of FIG. 2, FIG. 4 is a diagram showing horizontal and vertical angles of view (FOV) according to aberration characteristics in the optical system of FIG. 2, FIG. 5 to FIG. 7 are graphs showing diffraction MTF at low temperature, room temperature, and high temperature in the optical system of FIG. 2 and are graphs showing luminance ratio (modulation) according to spatial frequency, FIG. 8 to FIG. 10 are graphs showing diffraction MTF at low temperature, room temperature, and high temperature in the optical system of FIG. 2 and are graphs showing the luminance ratio according to the defocusing position, FIG. 11 to FIG. 13 are diagrams showing longitudinal spherical aberration, astigmatic field curves, and distortion graphs at low temperature, room temperature, and high temperature in the optical system of FIG. 2, and FIG. 14 to FIG. 16 are graphs showing actual image heights according to transverse chromatic aberration at low temperature, room temperature, and high temperature in the optical system of FIG. 2.

Referring to FIG. 2, in the optical system, at least five or more lenses 111, 112, 113, 114, 115 and 116 may be stacked, for example, 4 to 8 or 4 to 6 lenses may be stacked. The optical system may include at least five or more solid lenses, and the solid lenses may include at least two plastic lenses and at least two glass lenses. In the optical system according to an embodiment of the invention, the number of lenses made of plastic may be equal to or higher than the number of lenses made of glass. Accordingly, a lens having an aspheric surface and a lens having a spherical surface may be mixed, and a change in properties of a material according to temperature may be suppressed and a deterioration in optical performance (MTF) may be prevented.

The optical system includes a first lens 111, a second lens 112, a third lens 113, a fourth lens, a fifth lens 115, and a sixth lens 116 stacked along an optical axis from the object side to the image side or sensor side. The optical system or a camera module having the same may include an image sensor 190, a cover glass 191 and an optical filter 192. The cover glass 191 and the optical filter 192 may be disposed between the image sensor 190 and the last lens. The optical system may include an aperture stop ST for adjusting the amount of incident light. The aperture stop ST may be disposed between the second lens 112 and the third lens 113 or between the third lens 113 and the fourth lens 114. The circumference of the image-side surface of the second lens 112 and the circumference of the object-side surface or image-side surface of the third lens 113 may function as the aperture stop ST. Alternatively, the circumference of the object-side surface of the fourth lens 114 may function as an aperture stop ST. A lens group disposed on the object side based on the aperture stop ST may be divided into a first lens group and the lens group disposed on the sensor side based on the aperture stop ST may be divided into a second lens group. That is, the first lens group may include at least two or three lenses on the object side, and the second lens group may include at least three or four lenses between the first lens group and the image sensor 190.

The first lens 111 is a lens closest to the subject and may include a glass material. The first lens 111 may be formed of a crown glass material, so that a light dispersion value may be high. The first lens 111 includes a first surface S1 on which light is incident and a second surface S2 on which light is emitted, and both the first surface S1 and the second surface S2 may be spherical surface. The first lens 111 may have negative refractive power and a refractive index of less than 1.55. The first lens 111 may have the lowest refractive index among lenses in the optical system. The first surface S1 of the first lens 111 may be convex toward the object, and the second surface S2 may be concave toward the object. The first lens 111 may have a meniscus shape in which both sides S1 and S2 are convex toward the object side. An outer circumference of the second surface S2 may include a flat effective region. The radius of curvature of the first surface S1 may be four times greater than the radius of curvature of the second surface S2. The first lens 111 may be made of plastic to prevent discoloration when the camera module is exposed to light from inside or outside the vehicle, and may be made of glass or plastic when the camera module is placed inside the vehicle. A distance between the first lens 111 and the second lens 112 on the optical axis may be the largest among distances between lenses in the optical system. The distance between the first lens 111 and the second lens 112 is 10 times or more of the distance between the second lens 112 and the third lens 113. For example, the distance between the first lens 111 and the second lens 112 may be in the range of 14 to 20 times the distance between the second lens 112 and the third lens 113. Alternatively, the distance between the first lens 111 and the second lens 112 may be in the range of 14 to 18 times the distance between the second lens 112 and the third lens 113. The distance between the first lens 111 and the second lens 112 is 5 times or more of the center thickness of the first lens 111. For example, the distance between the first lens 111 and the second lens 112 may be in the range of 5 to 10 times the center thickness of the first lens 111. Alternatively, the distance between the first lens 111 and the second lens 112 may be in the range of 6.5 times to 9.5 times the center thickness of the first lens 111. The center thickness of the first lens 111 may be thinner than the center thickness of the second lens 112. For example, the center thickness of the first lens 111 may be formed 1.5 mm or less or 1.2 mm or less. The Abbe number Vd of the first lens 111 may be the largest among the lenses. The Abbe number Vd of the first lens 111 may be, for example, twice or more than the Abbe number Vd of the third and fourth lenses 113 and 114. The Abbe number Vd of the first lens 111 may be greater than the Abbe number Vd of the second, fifth, and sixth lenses 112, 115 and 116. For example, the Abbe number Vd of the first lens 111 may be 70 or more or in the range of 75 to 90. When expressed as an absolute value, the focal length of the first lens 111 may be greater than that of the second, fourth, and fifth lenses 112, 114 and 115 An effective diameter through which light is incident from the first lens 111 may be larger than the effective diameters of the other second to sixth lenses 112, 113, 114 115 and 116. An effective diameter through which light is incident from the first lens 111 may be larger than the effective diameters of the second to fourth lenses 112, 113 and 114.

The second lens 112 may be made of glass. The second lens 112 has positive (+) refractive power and may be formed of a material having a refractive index of 1.6 or more or 1.7 or more. The refractive index of the second lens 112 may have the highest refractive index among lenses in the optical system. The second lens 112 may be disposed between the first lens 111 and the third lens 113. The second lens 112 includes a third surface S3 on which light is incident and a fourth surface S4 on which light is emitted, and both the third surface S3 and the fourth surface S4 may be spherical. The third surface S3 may be convex toward the object, and the fourth surface S4 may be convex toward the sensor. Expressed as an absolute value, the radius of curvature of the third surface S3 may be smaller than the radius of curvature of the fourth surface S4, for example, 0.2 times or less. When expressed as an absolute value, the radius of curvature of the fourth surface S4 may be greater than that of the first surface S1. The radius of curvature of the fourth surface S4 obtained as an absolute value may be the largest among the lenses of the optical system. A distance between the second lens 112 and the third lens 113 on the optical axis may be less than 1 mm. The center thickness of the second lens 112 may be twice or more of the distance between the second and third lenses 112 and 113, and may be greater than 1.5 mm or in the range of 1.5 mm to 2.5 mm. The Abbe number Vd of the second lens 112 may be 35 or more, for example, 40 or more. The focal length of the second lens 112 may be 20 mm or less. Since the first and second lenses 111 and 112 are made of a glass material on the object side, an expansion problem caused by heat transmitted through the object side may be reduced. The second lens 112 is made of glass and has a high refractive index and a high dispersion value, so that the aberration of incident light may be improved. An effective diameter through which light is incident from the second lens 112 may be larger than the effective diameters of the third and fourth lenses 113 and 114.

The third lens 113 may be made of a plastic material. The third lens 113 has negative (−) refractive power and may be formed with a refractive index of 1.6 or more or a refractive index in the range of 1.6 to 1.72. The third lens 113 may be disposed between the second and fourth lenses 112 and 114. The third lens 113 includes a fifth surface S5 on which light is incident and a sixth surface S6 on which light is emitted, and both the fifth surface S5 and the sixth surface S6 may be aspheric surfaces. The fifth surface S5 may be convex toward the object, and the sixth surface S6 may be concave. The third lens 113 may have a meniscus shape convex toward the object side. The radius of curvature of the fifth surface S5 may be greater than the radius of curvature of the sixth surface S6, and the difference between them may be 5 mm or less. The distance between the third lens 113 and the fourth lens 114 on the optical axis may be larger than the distance between the second and third lenses 112 and 113. A distance between the third lens 113 and the fourth lens 114 may be greater than a center thickness of the third lens 113. The center thickness of the third lens 113 may be 1.5 mm or less, for example, in the range of 1.0 mm to 1.5 mm. The refractive index of the third and fourth lenses 113 and 114 may be the same or may have a difference of 0.3 or less. The Abbe numbers Vd of the third and fourth lenses 113 and 114 may be the same or may have a difference of 10 or less. The Abbe number Vd of the third lens 113 may be less than 30, for example, in the range of 15 to 29. When the focal length of the third lens 113 is obtained as an absolute value, it may be 25 mm or more, for example, in the range of 25 mm to 35 mm.

The fourth lens 114 may be made of a plastic material. The fourth lens 114 has negative (−) refractive power and may be formed with a refractive index of 1.6 or more or a refractive index in the range of 1.6 to 1.72. The fourth lens 114 may be disposed between the third and fifth lenses 113 and 115. Here, when the material of the third to sixth lenses 113, 114, 115, and 116 is formed of a plastic material, the amount of light may be increased by the aspheric surface of the lens. The fourth lens 114 includes a seventh surface S7 through which light is incident and an eighth surface S8 through which light is emitted, and both the seventh surface S7 and the eighth surface S8 may be aspheric surfaces. The seventh surface S7 may be convex toward the object, and the eighth surface S8 may be concave. The radius of curvature of the seventh surface S7 may be greater than that of the third surface S3, and the radius of curvature of the eighth surface S8 is smaller than that of the seventh surface S7, for example, it may be 0.5 times or less.

The distance between the fourth lens 114 and the fifth lens 115 on the optical axis may be smaller than the distance between the third and fourth lenses 113 and 114. The distance between the fourth lens 114 and the fifth lens 115 may be smaller than a center thickness of the fourth lens 114. The center thickness of the fourth lens 114 may be 1.5 mm or less, for example, in the range of 1.0 mm to 1.5 mm. The distance between the fourth lens 114 and the fifth lens 115 may be 1 mm or less, for example, in the range of 0.5 mm to 1 mm. The refractive index of the fourth lens 114 may be higher than that of the fifth lens 115, and the difference between them may be 0.8 or less. The Abbe number Vd of the fourth lens 114 may be smaller than the Abbe number of the fifth lens 115, and may be less than 30, for example, in the range of 15 to 29. When the focal length of the fourth lens 114 is obtained as an absolute value, it may be 20 mm or less, for example, in the range of 10 mm to 20 mm. Here, the aperture stop ST may be disposed around the periphery between the third lens 113 and the fourth lens 114. The aperture stop ST may be disposed around the circumference between the different plastic lenses 113 and 114.

The fifth lens 115 may be made of a plastic material. The fifth lens 113 may have positive (+) refractive power. The refractive index of the fifth lens 115 is lower than that of the fourth lens 114 and may be formed with a refractive index of 1.6 or less or a refractive index in the range of 1.5 to 1.6. The fifth lens 115 may be disposed between the fourth and sixth lenses 114 and 116. The fifth lens 115 includes a ninth surface S9 on which light is incident and a tenth surface S10 on which light is emitted, and both the ninth surface S9 and the tenth surface S10 may be aspheric surfaces. The ninth surface S5 may be convex toward the object, and the tenth surface S10 may be convex. The fifth lens 115 may have a convex shape on both sides. The radius of curvature of the ninth surface S9 may be larger than the radius of curvature of the tenth surface S10, and the difference between them may be 5 mm or less when expressed as an absolute value. The distance between the fifth lens 115 and the sixth lens 116 on the optical axis may be greater than the distance between the second and third lenses 112 and 113. A distance between the fifth lens 115 and the sixth lens 116 may be smaller than a center thickness of the fifth lens 115. The center thickness of the fifth lens 115 may be the largest among the lenses of the optical system, and may be 3 mm or more, for example, in the range of 3 mm to 3.8 mm. The refractive indexes of the fifth and sixth lenses 115 and 116 may be the same or may have a difference of 0.3 or less. The Abbe numbers Vd of the fifth and sixth lenses 115 and 116 may be equal to each other or may have a difference of 10 or less. The Abbe number Vd of the fifth lens 115 may be 50 or more, for example, in the range of 50 to 60. When the focal length of the fifth lens 115 is obtained as an absolute value, it may be 10 mm or less, for example, in the range of 5 mm to 10 mm.

The sixth lens 116 is a lens closest to the image sensor 190 and may be made of a plastic material. The sixth lens 116 has negative (−) refractive power and may be formed with a refractive index of 1.6 or less, for example, in the range of 1.5 to 1.6. The sixth lens 116 includes an eleventh surface S11 on which light is incident and a twelfth surface S12 on which light is emitted, and both the eleventh surface S11 and the twelfth surface S12 may be aspheric surfaces. The eleventh surface S7 may be convex toward the sensor, and the twelfth surface S12 may be concave. At least one or both of the eleventh surface S11 and the twelfth surface S12 of the sixth lens 116 may have an inflection point. The radius of curvature of the eleventh surface S11 may be greater than that of the twelfth surface S12. The center thickness of the sixth lens 116 may be thicker than the center thickness of the first lens 111 and may be greater than 1 mm and may range from 1.1 mm to 2 mm. The Abbe number Vd of the sixth lens 116 may be 50 or more, for example, in the range of 50 to 60. When the focal length of the sixth lens 116 is obtained as an absolute value, it may be 20 mm or more, for example, in the range of 20 mm to 32 mm. An effective diameter through which light is incident from the sixth lens 116 may be larger than the effective diameters of the third and fourth lenses 113 and 114. Each of the lenses 111, 112, 113, 114, 115, and 116 may include an effective region having an effective diameter through which light is incident and a flange portion outside the effective region, which is a non-effective region. The non-effective region may be a region in which light is blocked by a spacer or a light blocking film. Here, the ratio of the lenses disposed on the sensor side and the lenses disposed on the object side with respect to the aperture stop ST may be 1:1.

The image sensor 190 may perform a function of converting light passing through lenses into image data. Here, a housing or lens holder may be disposed outside the optical system, and a sensor holder may be disposed below to surround the image sensor 190 and protect the image sensor 190 from external foreign substances or shocks. The image sensor 190 may be any one of a charge coupled device (CCD), complementary metal-oxide semiconductor (CMOS), CPD, and CID. When the number of image sensors 190 is plural, one may be a color (RGB) sensor and the other may be a black and white sensor. The diagonal size of the image sensor 190 may be greater than or equal to 9 mm, for example, in the range of 9 mm to 12 mm. The optical filter 192 may be disposed between the sixth lens 116 and the image sensor 190. The optical filter 192 may filter light corresponding to a specific wavelength range with respect to light passing through the lenses 111, 112, 113, 114, 115, and 116. The optical filter 192 may be an infrared (IR) blocking filter that blocks infrared rays or an ultraviolet (UV) blocking filter that blocks ultraviolet rays, but the embodiment is not limited thereto. The optical filter 192 may be disposed on the image sensor 190. The cover glass 191 is disposed between the optical filter 192 and the image sensor 190, protects an upper portion of the image sensor 190, and may prevent deterioration in reliability of the image sensor 190.

A vehicle camera module according to an embodiment of the invention may include or remove a driving member (not shown) around the optical system. That is, since the optical system is disposed in the vehicle, it is difficult to control the focus by moving the lens barrel supporting the optical system in a direction of the optical axis or/and a direction perpendicular to the optical axis direction with the driving member, so the driving member may be removed. The driving member may be an actuator or a piezoelectric element for an auto focus (AF) function or/and an optical image stabilizer (OIS) function. Here, the lens barrel supporting the optical system may include a metal material.

In the optical system according to the first embodiment of the invention, the angle of view (angle in a diagonal direction) may be 70 degrees or more, for example, in the range of 73 degrees to 77 degrees. The effective focal length may be greater than or equal to 7 mm, such as in the range of 7 mm to 8 mm. F number of the optical system or camera module may be 2.2 or less, for example, in the range of 1.7 to 2.2. The chief ray angle (CRA) may be greater than or equal to 10 degrees, such as in the range of 10 to 15 degrees. In the optical system, a distance (TTL) between the image sensor 190 and the vertex of the first lens 111 may be 40 mm or less. In addition, the wavelength of light used in the optical system may be in the range of 400 nm to 700 nm.

Table 1 shows lens data in the optical system of FIG. 1.

TABLE 1

| | | | | | Refractive | Abbe | | | |
|---|---|---|---|---|---|---|---|---|---|
| | | | Radius of | Thickness/ | index | number | | Focal | Effective |
| | Surface | Shape | curvature | Distance | Nd | Vd | Diopter | length | radius |
| Lens 1 | S1 | Sphere | 65.695 | 1.000 | 1.497 | 81.607 | | −23.34 | 9.570 |
| | S2 | Sphere | 9.846 | 8.076 | | | −42.84 | | 7.562 |
| Lens 2 | S3 | Sphere | 10.368 | 2.153 | 1.774 | 49.624 | 82.66 | 12.10 | 4.605 |
| | S4 | Sphere | −92.609 | 0.540 | | | | | 4.250 |
| Lens 3 | S5 | Asphere | 6.014 | 1.205 | 1.674 | 19.246 | −33.47 | −29.87 | 3.108 |
| | S6 | Asphere | 4.267 | 1.245 | | | | | 2.500 |
| Stop | | Flat | 1.E+18 | | | | | | |
| Lens 4 | S7 | Asphere | 6.065 | 0.806 | 1.674 | 19.246 | −71.30 | −14.03 | 2.713 |
| | S8 | Asphere | 8.770 | 3.381 | | | | | 3.274 |
| Lens 5 | S9 | Asphere | −6.008 | 1.464 | 1.545 | 56.095 | 141.70 | 7.09 | 3.905 |
| | S10 | Asphere | 5.966 | 1.549 | | | | | 4.100 |
| Lens 6 | S11 | Asphere | 3.860 | 1.386 | 1.545 | 56.095 | −37.01 | −27.02 | 4.528 |
| | S12 | Sphere | 65.695 | 1.000 | | | | | 4.921 |
| BPF | Sa | Flat | 1.E+18 | 0.400 | 1.517 | 64.166 | | | |
| | Sb | Flat | 1.E+18 | 1.000 | | | | | |
| Cover | Sc | Flat | 1.E+18 | 0.400 | 1.517 | 64.166 | | | |
| glass | Sd | Flat | 1.E+18 | 0.200 | | | | | |
| CIS | | Flat | 1.E+18 | 0.000 | | | | | |

In Table 1, the refractive indices of the first to sixth lenses 111, 112, 113, 114, 115, and 116 are the refractive indices at 587 nm, the Abbe numbers Vd of the first to sixth lenses 111, 112, 113, 114, 115, and 116 at d-line (587 nm) may be less than 30 for the second lens 112 and the third lens 113, and may be 50 or more for the number of the first, fifth, and sixth lenses 111, 115, and 116. Effective radius represents a semi-aperture (mm) of each lens surface. The Sa and Sb may be the incident side and the exit side surface of the optical filter, and Sc and Sd may be the incident side and the exit side surface of the cover glass. CIS is an image sensor. When expressed as an absolute value, the diopter may be in the order of third lens>sixth lens>first lens>fourth lens>second lens>fifth lens. Based on Table 1 above, the values of the radius (mm) of curvature, thickness (mm), distance (mm), refractive index, Abbe number, and focal length (mm) may also be expressed by the above relational expression. Table 2 is the aspheric coefficient of each surface of each lens in the optical system of FIG. 1.

TABLE 2

| | | Aspheric coefficient | | | | |
|---|---|---|---|---|---|---|
| Item | Surface | K | A | B | C | D |
| Lens 1 | S1 | | | | | |
| | S2 | | | | | |
| Lens 2 | S3 | | | | | |
| | S4 | | | | | |
| Lens 3 | S5 | 1.5644094 | −0.0021583 | −0.0000441 | −0.0000067 | 5.55E−07 |
| | S6 | 0.2231236 | −0.0028886 | −0.0001023 | 0.0000041 | −4.45E−06 |
| Lens 4 | S7 | 36.7142834 | −0.0065673 | −0.0000235 | −0.0000280 | 3.92E−06 |
| | S8 | −2.0012081 | −0.0054321 | 0.0001848 | 0.0000034 | −2.22E−06 |
| Lens 5 | S9 | −15.1100718 | 0.0012671 | −0.0001276 | 0.0000109 | −3.09E−07 |
| | S10 | −3.1284749 | −0.0024085 | 0.0001352 | −0.0000069 | 2.38E−07 |
| Lens 6 | S11 | −0.7805828 | −0.0062881 | 0.0002059 | −0.0000025 | −8.02E−08 |
| | S12 | −1.9420814 | −0.0058444 | 0.0002938 | −0.0000100 | 1.20E−07 |
| | | Aspheric coefficient | | | | |
| Item | Surface | E | F | G | H | J |
| Lens 1 | S1 | | | | | |
| | S2 | | | | | |
| Lens 2 | S3 | | | | | |
| | S4 | | | | | |
| Lens 3 | S5 | −8.27E−08 | −1.95E−08 | 6.26E−09 | −6.11E−10 | 1.98E−11 |
| | S6 | 1.50E−08 | 1.06E−07 | −3.15E−09 | −2.07E−09 | 1.68E−10 |
| Lens 4 | S7 | −5.68E−07 | −3.51E−08 | 6.49E−09 | 3.63E−10 | −8.34E−11 |
| | S8 | 1.42E−07 | 2.66E−09 | −3.48E−10 | −3.26E−11 | 2.36E−12 |
| Lens 5 | S9 | −2.05E−08 | 1.53E−09 | 7.53E−12 | −3.16E−12 | 6.69E−14 |
| | S10 | 9.63E−09 | −8.13E−10 | 1.52E−12 | 1.17E−12 | −3.58E−14 |
| Lens 6 | S11 | 1.89E−09 | −3.71E−11 | 1.94E−12 | 4.12E−14 | −4.85E−15 |
| | S12 | 3.49E−09 | −1.14E−10 | −1.60E−12 | 5.04E−14 | 2.18E−16 |

FIG. 3 is a graph showing ambient light ratio or relative illumination according to image height in the optical system of FIG. 2, and it may be seen that the ambient light volume ratio is 55% or more from the center of the image sensor to the diagonal end, for example, 70% or more. FIG. 4 is a diagram showing an actual FOV and a Parax FOV for a horizontal FOV (Field of View) and vertical FOV at room temperature (e.g., 22 degrees) in the optical system of FIG. 2. FIGS. 5 to 7 are graphs showing diffraction MTF at low temperature, room temperature, and high temperature in the optical system of FIG. 2, and are graphs showing luminance ratio (modulation) according to spatial frequency. FIGS. 8 to 10 are graphs showing diffraction MTF at low temperature, room temperature, and high temperature in the optical system of FIG. 2, and are graphs showing the luminance ratio according to the defocusing position. As shown in FIGS. 5 to 10, it may be seen that the luminance modulation is hardly changed at a low temperature of −40 degrees, a room temperature of 22 degrees, and a high temperature of 85 degrees. As shown in FIGS. 11 to 13, in the optical system of FIG. 2, longitudinal spherical aberration, astigmatic field curves, and distortion at low temperature, room temperature, and high temperature are ±17 or less (1.0 filed) may be seen. As shown in FIGS. 14 to 16, in the optical system of FIG. 2, it may be seen that the actual image height according to the transverse chromatic aberration at low temperature, room temperature, and high temperature is within 3 pixels between Red-Green, Green-Blue, and Red-Blue. That is, as shown in FIGS. 5 to 16, it may be seen that the change in data according to the temperature change from low temperature to high temperature is not large, less than 10%.

### Second Embodiment

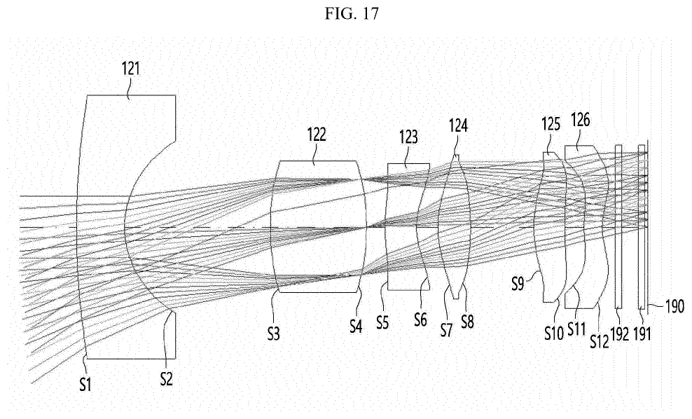

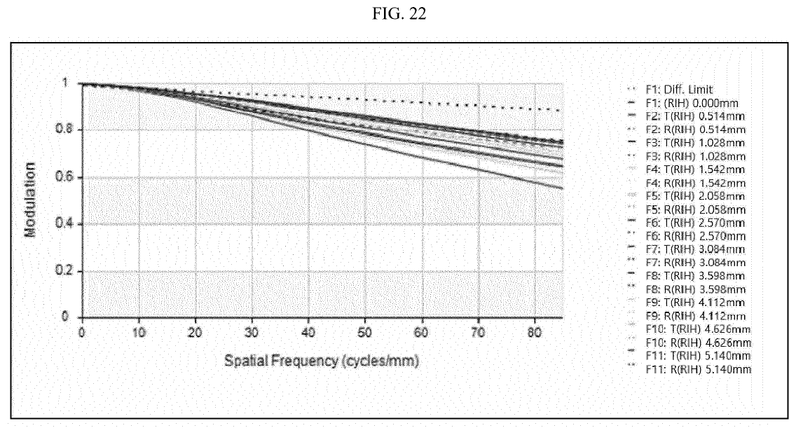

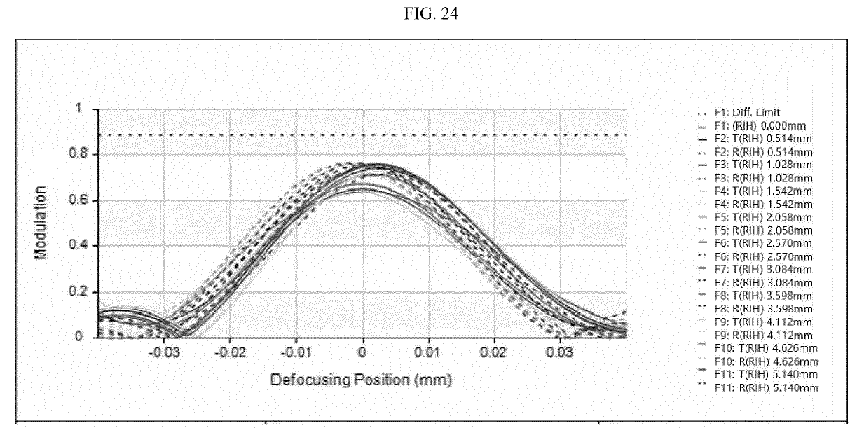

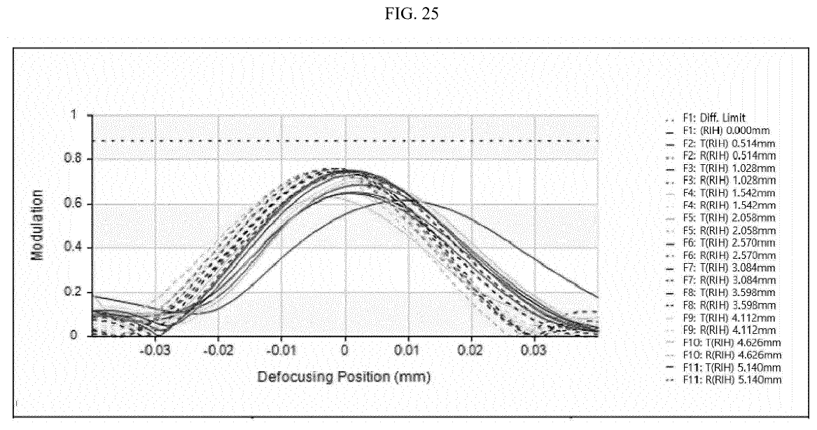

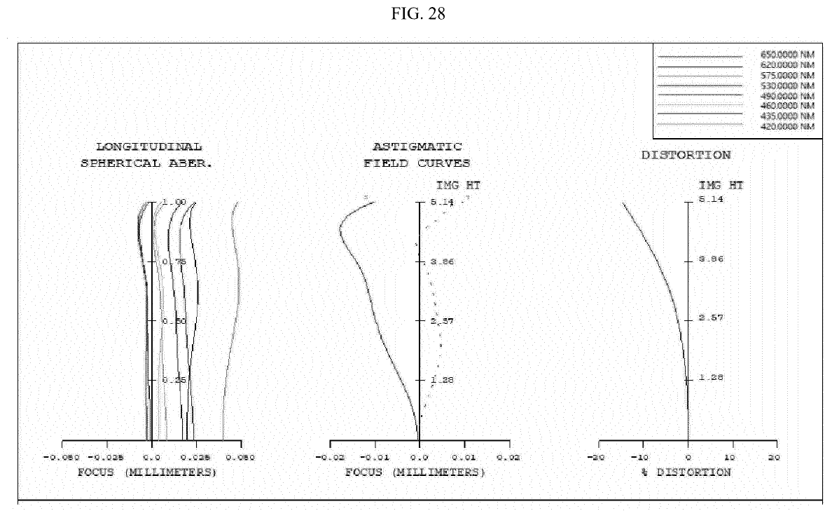

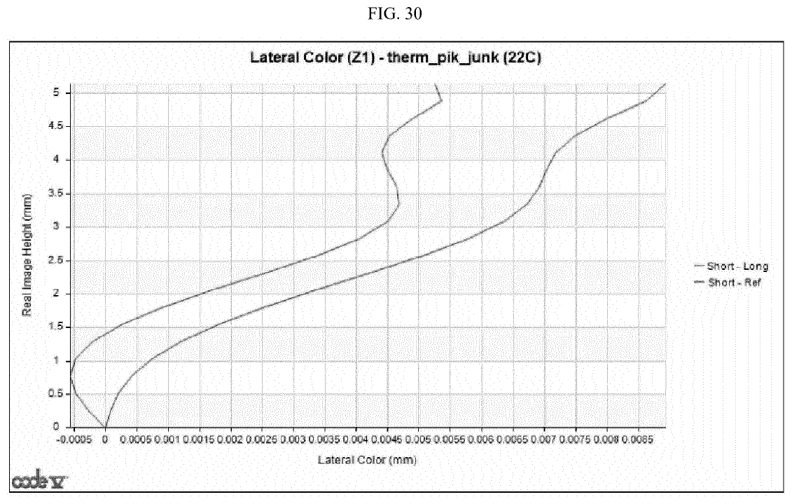

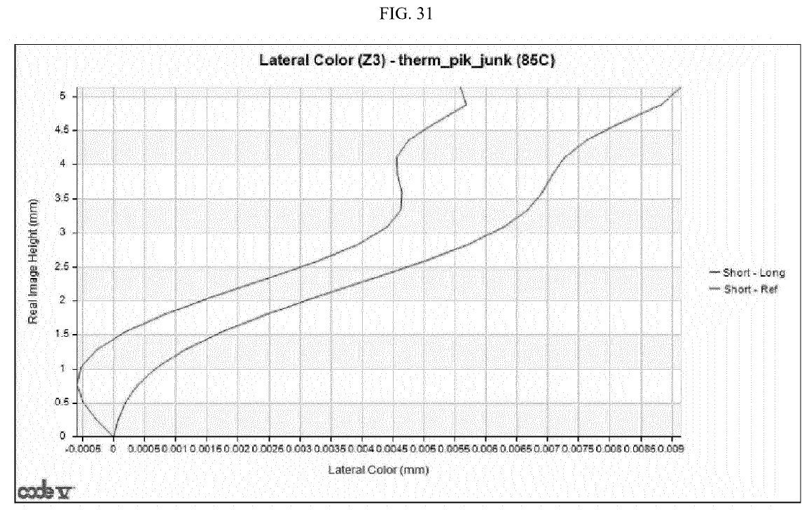

Referring to FIGS. 17 to 31 for the second embodiment. FIG. 17 is a side cross-sectional view showing an optical system for a vehicle according to a second embodiment of the invention. In describing the second embodiment, the same configuration as the first embodiment will be referred to the description of the first embodiment.

Referring to FIG. 17, the optical system may include a first lens 121, a second lens 122, a third lens 123, a fourth lens 124, a fifth lens 125 and a sixth lens 126 stacked along an optical axis in a direction from the object side to the sensor side. The optical system or a camera module having the same may include an image sensor 190, a cover glass 191 and an optical filter 192 disposed between the image sensor 190 and the last lens. The optical system may include an aperture stop ST for adjusting the amount of incident light A lens group disposed on the object side based on the aperture stop ST may be divided into a first lens group and the lens group disposed on the sensor side based on the aperture stop ST may be divided into a second lens group. That is, the first lens group may include the first and second lenses 121 and 122, and the second lens group may include the third to sixth lenses 123, 124, 125, and 126. The aperture stop ST may be disposed on the outer circumference between the second lens 122 and the third lens 123. The circumference of the sensor-side surface of the second lens 122, or the object-side surface of the third lens 123 may function as an aperture stop.

The first lens 121 is a lens closest to the subject and may include a glass material. The first lens 121 may be formed of a crown glass material, so that a light dispersion value may be high. The first lens 121 includes a first surface S1 on which light is incident and a second surface S2 on which light is emitted, and both the first surface S1 and the second surface S2 may be spherical surfaces. The first lens 121 may have a negative refractive power and a refractive index of less than 1.55 or less than 1.5. The first lens 121 may have the lowest refractive index among lenses in the optical system. The first surface S1 of the first lens 121 may be convex toward the object, and the second surface S2 may be concave toward the object. The first lens 121 may have a meniscus shape in which both sides S1 and S2 are convex toward the object side. An outer circumference of the second surface S2 may include a flat effective region. The radius of curvature of the first surface S1 may be six times greater than the radius of curvature of the second surface S2, and the radius of curvature of the second surface S2 may be 10 mm or less. The radius of curvature of the first surface S1 obtained as an absolute value may be the largest among the lenses of the optical system. The first lens 121 may be made of plastic to prevent discoloration when the camera module is exposed to light from inside or outside the vehicle, and may be made of glass or plastic when the camera module is placed inside the vehicle.

A distance between the first lens 121 and the second lens 122 on the optical axis may be the largest among distances between lenses in the optical system. The distance between the first lens 121 and the second lens 122 may be 4 times or more, for example, 4 times to 8 times the distance between the second lens 122 and the third lens 123. The distance between the first lens 121 and the second lens 122 may be 1.5 times or more, for example, 1.5 times to 2.5 times the center thickness of the first lens 121. The center thickness of the first lens 121 may be thinner than the center thickness of the second lens 122, for example, 3.5 mm or less or 3.2 mm or less. The Abbe number Vd of the first lens 121 may be the largest among lenses in the optical system. The Abbe number Vd of the first lens 121 may be, for example, twice or more than the Abbe number Vd of the third and sixth lenses 123 and 126. The Abbe number Vd of the first lens 121 may be greater than the Abbe number Vd of the second, fourth and fifth lenses 122, 124 and 125, and for example, may be 70 or in the range of 75 to 90. When expressed as an absolute value, the focal length of the first lens 121 may be greater than that of the second and fourth lenses 122 and 124. An effective diameter through which light is incident from the first lens 121 may be larger than the effective diameters of the other second to sixth lenses 122, 123, 124, 125, and 126. An effective diameter through which light is incident from the first lens 121 may be larger than the effective diameters of the second to fourth lenses 122, 123, and 124.

The second lens 122 may be made of glass. The second lens 122 may have positive (+) refractive power and may be formed of a material having a refractive index of 1.6 or more or 1.7 or more. The refractive index of the second lens 122 may be higher than that of the first and third lenses 121 and 123. The second lens 122 may be disposed between the first lens 121 and the third lens 123. The second lens 122 includes a third surface S3 through which light is incident and a fourth surface S4 through which light is emitted, and both the third surface S3 and the fourth surface S4 may be spherical. The third surface S3 may be convex toward the object, and the fourth surface S4 may be convex toward the sensor. Expressed as an absolute value, the difference between the radius of curvature of the third surface S3 and the radius of curvature of the fourth surface S4 may be 3 or less. When expressed as an absolute value, the radius of curvature of the third and fourth surfaces S3 and S4 may be 15 or more. A distance between the second lens 122 and the third lens 123 on the optical axis may be 0.8 mm or more. The center thickness of the second lens 122 may be twice or more than the distance between the second and third lenses 122 and 123, and may be 3 mm or more or in a range of 3 mm to 7 mm. The Abbe number Vd of the second lens 122 may be 35 or more, for example, 40 or more. The focal length of the second lens 122 may be 20 or less. Since the first and second lenses 121 and 122 are made of a glass material on the object side, an expansion problem caused by heat transmitted through the object side may be reduced. The second lens 122 is made of glass and has a high refractive index and a high dispersion value, so that the aberration of incident light may be improved.

The third lens 123 may be made of a plastic material. The third lens 123 has negative (−) refractive power and may be formed with a refractive index of 1.6 or more or a refractive index in the range of 1.6 to 1.72. The third lens 123 may be disposed between the second and fourth lenses 122 and 124. The third lens 123 includes a fifth surface S5 on which light is incident and a sixth surface S6 on which light is emitted, and both the fifth surface SS and the sixth surface S6 may be aspheric surfaces. The fifth surface S5 may be convex toward the object, and the sixth surface S6 may be concave. The third lens 123 may have a meniscus shape convex toward the object side. The radius of curvature of the fifth surface S5 may be greater than the radius of curvature of the sixth surface S6, and the difference between them may be 5 mm or more. The distance between the third lens 123 and the fourth lens 124 on the optical axis may be equal to or greater than the distance between the second and third lenses 122 and 123. A distance between the third lens 123 and the fourth lens 124 may be smaller than a center thickness of the third lens 123. The center thickness of the third lens 123 may be greater than or equal to 1.5 mm, for example, in the range of 1.5 mm to 2.5 mm. The refractive indices of the third and fourth lenses 123 and 124 may be the same or may have a difference of 0.3 or less. The Abbe number Vd of the third lens 123 may be smaller than the Abbe number of the fourth lens 124. The Abbe number Vd of the third lens 123 may be less than 30, for example, in the range of 15 to 29. When the focal length of the third lens 123 is obtained as an absolute value, it may be 25 or less, for example, in the range of 10 to 25. Here, the aperture stop ST may be disposed around the periphery between the second lens 132 and the third lens 133. The aperture stop ST may be disposed on the periphery between the glass material and the plastic lens.

The fourth lens 124 may be made of a plastic material. The fourth lens 124 has positive (+) refractive power and may be formed with a refractive index of 1.4 or more or a refractive index in the range of 1.4 to 1.72. The fourth lens 124 may be disposed between the third and fifth lenses 123 and 125. Here, among the materials of the third to sixth lenses 123, 124, 125, and 126, a plastic material lens ratio is disposed higher, so that the amount of light may be increased by the aspheric surface of the lens. The fourth lens 124 includes a seventh surface S7 through which light is incident and an eighth surface S8 through which light is emitted, and both the seventh surface S7 and the eighth surface S8 may be aspheric surfaces. The seventh surface S7 may be convex toward the object, and the eighth surface S8 may be convex. Expressed as an absolute value, the radius of curvature of the seventh surface S7 may be greater than the radius of curvature of the sixth surface S6. The radius of curvature of the eighth surface S8 may be smaller than the radius of curvature of the seventh surface S7, for example, may be 0.5 times or less.

The distance between the fourth lens 124 and the fifth lens 125 on the optical axis may be greater than the distance between the third and fourth lenses 123 and 124. A distance between the fourth lens 124 and the fifth lens 125 may be greater than a center thickness of the fourth lens 124. The center thickness of the fourth lens 124 may be 1.5 mm or more, for example, in the range of 1.5 mm to 2.5 mm. The distance between the fourth lens 124 and the fifth lens 125 may be 1 mm or more, for example, in the range of 1 mm to 2.5 mm. The refractive index of the fourth lens 124 may be smaller than the refractive index of the fifth lens 125, and the difference between them may be 0.5 or less. The Abbe number Vd of the fourth lens 124 may be greater than the Abbe number of the fifth lens 125, and may be greater than or equal to 50, for example, in the range of 50 to 70. When the focal length of the fourth lens 124 is obtained as an absolute value, it may be 15 or less, for example, in the range of 5 to 15.

The fifth lens 125 may be made of glass. The fifth lens 123 may have positive (+) refractive power. The refractive index of the fifth lens 125 is higher than that of the fourth lens 124, and may be formed with a refractive index of 1.6 or more or a refractive index ranging from 1.6 to 1.82. The fifth lens 125 may be disposed between the fourth and sixth lenses 124 and 126. The fifth lens 125 includes a ninth surface S9 on which light is incident and a tenth surface S10 on which light is emitted, and both the ninth surface S9 and the tenth surface S10 may be aspherical surfaces. The fifth lens 125 may be formed of a glass material by injection molding. At least one or both of the ninth surface S9 and the tenth surface S10 of the fifth lens 125 may have an inflection point. The ninth surface SS may be convex toward the object, and the tenth surface S10 may be concave. The radius of curvature of the ninth surface S9 may be smaller than that of the tenth surface S10 and may be 0.5 times or less.

The distance between the fifth lens 125 and the sixth lens 126 on the optical axis may be smaller than the distance between the fourth and fifth lenses 124 and 125. A distance between the fifth lens 125 and the sixth lens 126 may be smaller than a center thickness of the fifth lens 125. The center thickness of the fifth lens 125 may be greater than or equal to 1.3 mm, for example, in the range of 1.3 mm to 2.3 mm. The refractive index of the fifth and sixth lenses 125 and 126 may be the same or may have a difference of 0.3 or less. The Abbe number Vd of the fifth lens 125 may be smaller than the Abbe number of the sixth lens 126, for example, 0.5 times or less. The Abbe number Vd of the fifth lens 125 may be 30 or more, for example, in the range of 30 to 60. When the focal length of the fifth lens 125 is obtained as an absolute value, it may be 15 or more, for example, in the range of 15 to 25.

The sixth lens 126 is a lens closest to the image sensor 190 and may be made of a plastic material. The sixth lens 126 has negative (−) refractive power and may be formed with a refractive index of 1.6 or less, for example, in the range of 1.5 to 1.8. The sixth lens 126 includes an eleventh surface S11 on which light is incident and a twelfth surface S12 on which light is emitted, and both the eleventh surface S11 and the twelfth surface S12 may be aspheric surfaces. The eleventh surface S7 may be convex toward the sensor, and the twelfth surface S12 may be concave. At least one or both of the eleventh surface S11 and the twelfth surface S12 of the sixth lens 126 may have an inflection point. The radius of curvature of the eleventh surface S11 may be greater than that of the twelfth surface S12. The center thickness of the sixth lens 126 may be thinner than the center thickness of the first lens 121 and may be in the range of 0.8 mm or more and 0.8 mm to 1.5 mm. The Abbe number Vd of the sixth lens 126 may be 30 or less, for example, in the range of 15 to 30. When the focal length of the sixth lens 126 is obtained as an absolute value, it may be 20 or less, for example, in the range of 10 to 20. An effective diameter through which light is incident from the sixth lens 126 may be larger than the effective diameters of the third and fourth lenses 123 and 124.

Each of the lenses 121, 122, 123, 124, 125, and 126 may include an effective region having an effective diameter through which light is incident and a flange portion outside the effective region, which is a non-effective region. The non-effective region may be a region in which light is blocked by a spacer or a light blocking film. Here, the ratio between the lenses made of plastic and the lenses made of glass may be 1:1.

For the image sensor 190, the optical filter 192, and the cover glass 191, the description of the first embodiment will be referred to. In the optical system according to the second embodiment of the invention, the angle of view (diagonal line) may be 70 degrees or more, for example, in the range of 73 degrees to 77 degrees. The effective focal length may be greater than or equal to 7 mm, such as in the range of 7 mm to 8 mm. The F number of the optical system or camera module may be 2.2 or less, for example, in the range of 1.7 to 2.2. The chief ray angle (CRA) may be greater than or equal to 10 degrees, such as in the range of 10 to 15 degrees. In the optical system, a distance (TTL) between the image sensor 190 and the vertex of the first lens 121 may be 40 mm or less. In addition, the wavelength of light used in the optical system may be in the range of 400 nm to 700 nm.

Table 3 shows lens data in the optical system of FIG. 17.

TABLE 3

| | | | | | Refractive | Abbe | | | |
|---|---|---|---|---|---|---|---|---|---|
| | | | Radius of | Thickness/ | index | number | | Focal | Effective |
| | Surface | Shape | curvature | Distance | Nd | Vd | Diopter | length | radius |
| Lens1 | S1 | Sphere | 62.898 | 2.935 | 1.497 | 81.607 | | −16.60 | 8.263 |
| | S2 | Sphere | 7.209 | 6.058 | | | −60.23 | | 5.645 |
| Lens 2 | S3 | Sphere | 17.504 | 5.896 | 1.774 | 49.624 | 84.42 | 11.85 | 4.100 |
| | S4 | Sphere | −16.592 | 1.142 | | | | | 3.300 |
| Stop | | Flat | 1.E+18 | | | | | | |
| Lens 3 | S5 | Asphere | 14.521 | 1.906 | 1.674 | 19.246 | −66.33 | −15.08 | 3.586 |
| | S6 | Asphere | 5.706 | 1.227 | | | | | 3.954 |
| Lens 4 | S7 | Asphere | 8.377 | 1.971 | 1.545 | 56.095 | 83.76 | 11.94 | 4.466 |
| | S8 | Asphere | −27.218 | 1.943 | | | | | 4.523 |
| Lens5 | S9 | Asphere | 9.871 | 1.876 | 1.774 | 49.624 | 49.80 | 20.08 | 4.554 |
| | S10 | Asphere | 24.589 | −0.141 | | | | | 4.712 |
| Lens6 | S11 | Asphere | 11.689 | 1.113 | 1.674 | 19.246 | −59.70 | −16.75 | 4.640 |
| | S12 | Asphere | 5.560 | 0.791 | | | | | 5.100 |
| BPF | Sa | Flat | 1.E+18 | 0.400 | 1.517 | 64.166 | | | |
| | Sb | Flat | 1.E+18 | 1.000 | | | | | |
| Cover | Sc | Flat | 1.E+18 | 0.400 | 1.517 | 64.166 | | | |
| glass | Sd | Flat | 1.E+18 | 0.200 | | | | | |
| CIS | | Flat | 1.E+18 | 0.000 | | | | | |

In Table 3, the refractive indices of the first to sixth lenses 121, 122, 123, 124, 125, and 126 are the refractive indices at 587 nm, the Abbe numbers Vd of the first to sixth lenses 121, 122, 123, 124, 125, and 126 at d-line (587 nm) may be less than 30 for the third lens 123 and the sixth lenses 123 and 126, and may be 50 or more for the first and fourth lenses 121 and 124. When expressed as an absolute value, the second and fourth lenses may have a larger diopter than the other lenses. Based on Table 3 above, the values of the radius (mm) of curvature, thickness (mm), distance (mm), refractive index, Abbe number, and focal length (mm) may be expressed as large and small relational expressions through relative comparison. For example, in absolute values, the Abbe number may represent a relational expression in the order of first lens>fourth lens>fifth and second lenses>third and sixth lenses. Table 4 is the aspheric coefficient of each surface of each lens in the optical system of FIG. 17.

TABLE 4

| | | Aspheric coefficient | | | | |
|---|---|---|---|---|---|---|
| Item | Surface | K | A | B | C | D |
| Lens 1 | S1 | | | | | |
| | S2 | | | | | |
| Lens 2 | S3 | | | | | |
| | S4 | | | | | |
| Lens 3 | S5 | −3.6752639 | −0.0020562 | 0.0000231 | 0.0000004 | −5.06E−08 |
| | S6 | −3.2092541 | −0.0017478 | 0.0000280 | −0.0000007 | 1.62E−08 |
| Lens 4 | S7 | −3.4740346 | −0.0001815 | −0.0000145 | −0.0000003 | −7.94E−10 |
| | S8 | −57.2140771 | −0.0009878 | 0.0000107 | −0.0000007 | −2.36E−10 |
| Lens 5 | S9 | −1.0976385 | −0.0000806 | −0.0000375 | −0.0000001 | −1.85E−08 |
| | S10 | 4.8341192 | −0.0001959 | −0.0000604 | −0.0000010 | 4.09E−08 |
| Lens 6 | S11 | 3.0414501 | −0.0073145 | 0.0000900 | 0.0000013 | −2.76E−08 |
| | S12 | −3.7103989 | −0.0055786 | 0.0001640 | −0.0000031 | 6.36E−09 |
| | | Aspheric coefficient | | | | |
| Item | Surface | E | F | G | H | J |
| Lens 1 | S1 | | | | | |
| | S2 | | | | | |
| Lens 2 | S3 | | | | | |
| | S4 | | | | | |
| Lens 3 | S5 | −1.60E−09 | 1.09E−10 | 1.45E−11 | −2.64E−13 | −5.20E−14 |
| | S6 | 5.92E−10 | −2.83E−12 | 1.11E−12 | 6.84E−15 | −1.26E−14 |
| Lens 4 | S7 | −5.10E−10 | 3.44E−11 | 2.02E−12 | 4.07E−14 | −3.90E−15 |
| | S8 | −7.60E−11 | 1.14E−11 | 5.66E−13 | 1.37E−14 | 6.33E−16 |
| Lens 5 | S9 | | | | | |
| | S10 | | | | | |
| Lens 6 | S11 | | | | | |
| | S12 | 1.61E−09 | 2.83E−12 | −1.66E−12 | 6.57E−15 | 5.40E−16 |

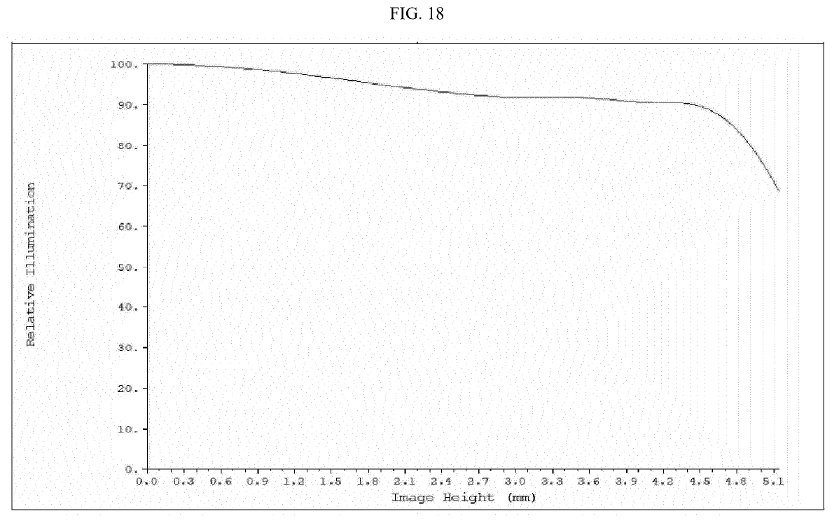

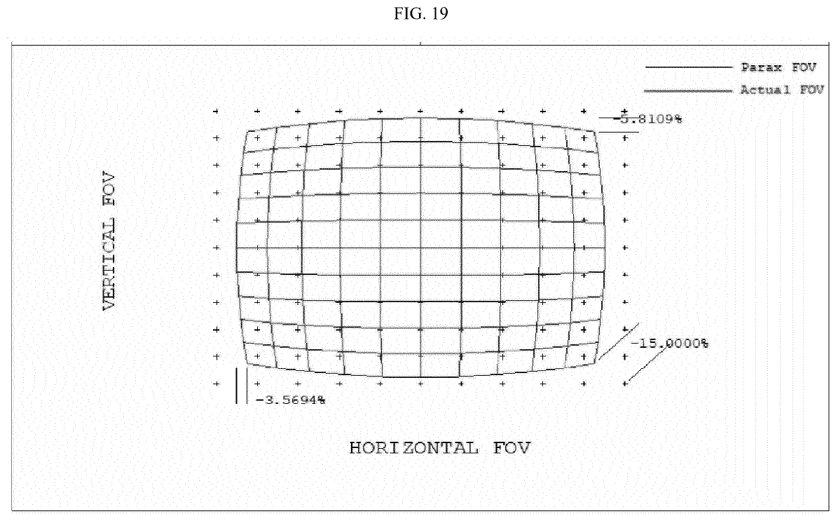

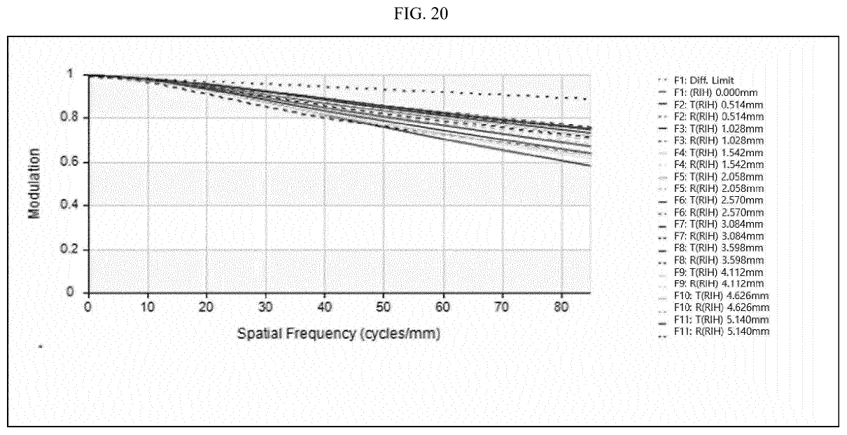

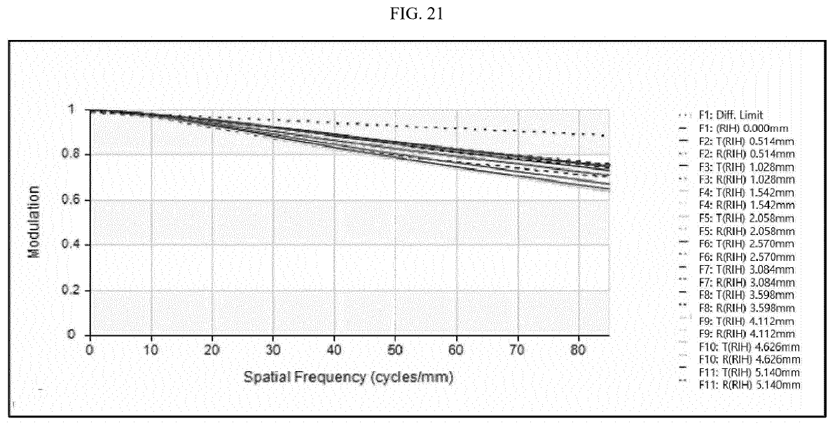

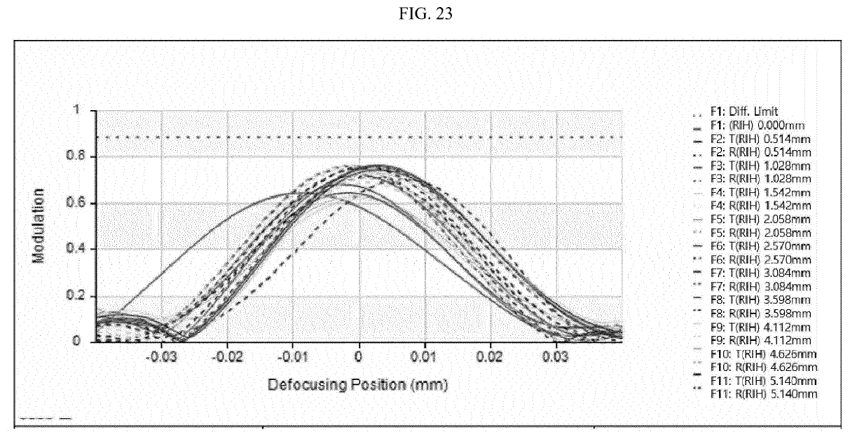

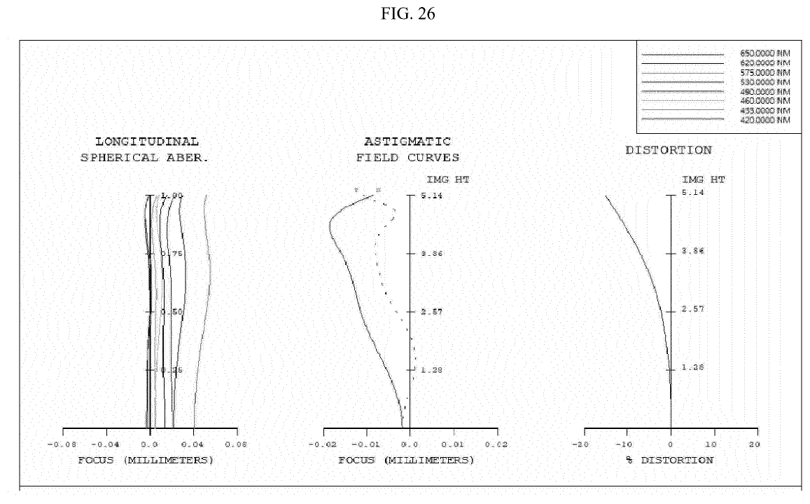

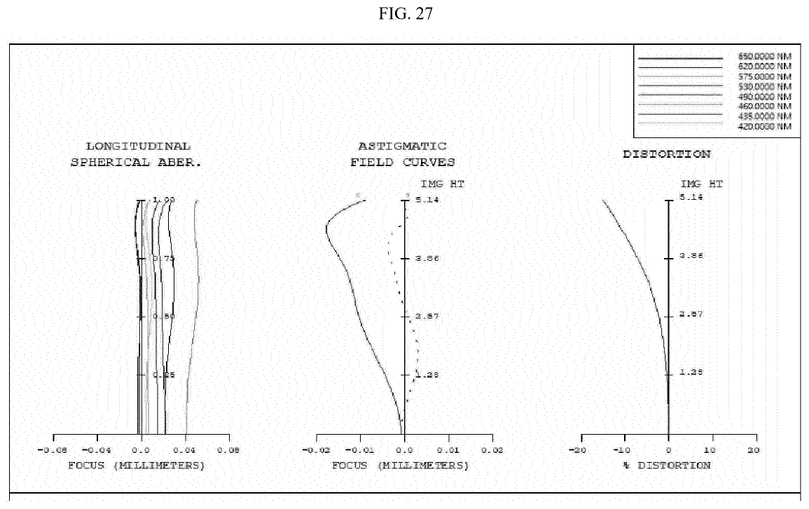

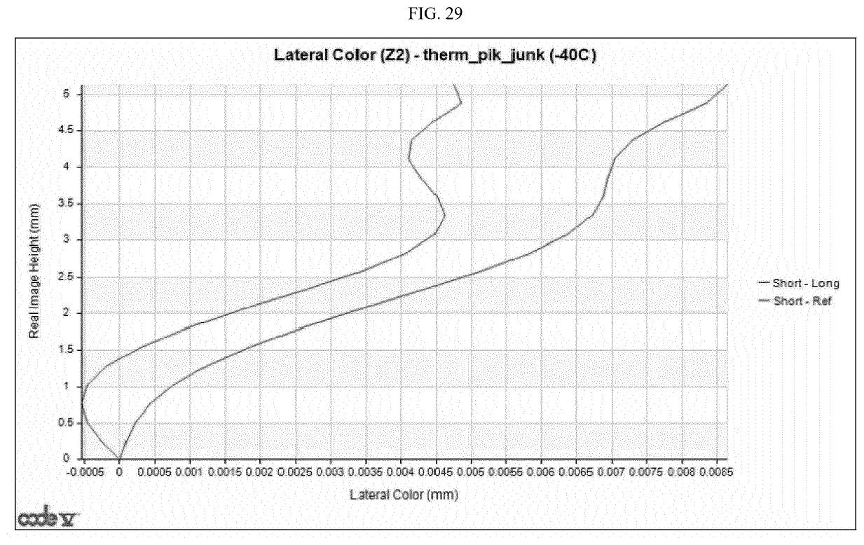

FIG. 18 is a graph showing the ambient light ratio or relative illumination according to the image height in the optical system of FIG. 17, and it may be seen that the ambient light volume ratio is 55% or more from the center of the image sensor to the diagonal end, for example, 70% or more. FIG. 19 is a diagram showing actual FOV and Parax FOV for horizontal FOV (Field of View) and vertical FOV at room temperature (e.g., 22 degrees) in the optical system of FIG. 17. FIGS. 20 to 22 are graphs showing diffraction MTF at low temperature, room temperature, and high temperature in the optical system of FIG. 17, and are graphs showing luminance ratio (modulation) according to spatial frequency. FIGS. 23 to 25 are graphs showing diffraction MTF at low temperature, room temperature, and high temperature in the optical system of FIG. 17, and are graphs showing the luminance ratio according to the defocusing position. As shown in FIGS. 20 to 25, it may be seen that the luminance ratio (modulation) is hardly changed at a low temperature of −40 degrees, a room temperature of 22 degrees, and a high temperature of 85 degrees. As shown in FIGS. 26 to 28, in the optical system of FIG. 17, Longitudinal spherical aberration, astigmatic field curves, and distortion at low temperature, room temperature, and high temperature are ±17 or less may be seen. As shown in FIGS. 29 to 31, in the optical system of FIG. 17, it may be seen that the actual image heights according to the transverse chromatic aberration at low temperature, room temperature, and high temperature are within 3 pixels between Red-Green, Green-Blue, and Red-Blue. That is, as shown in FIGS. 21 to 31, it may be seen that the change in data according to the temperature change from low temperature to high temperature is not large, less than 10%.

### Third Embodiment

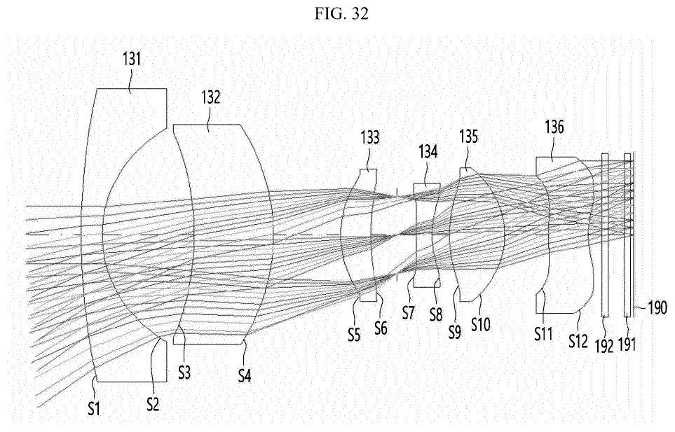

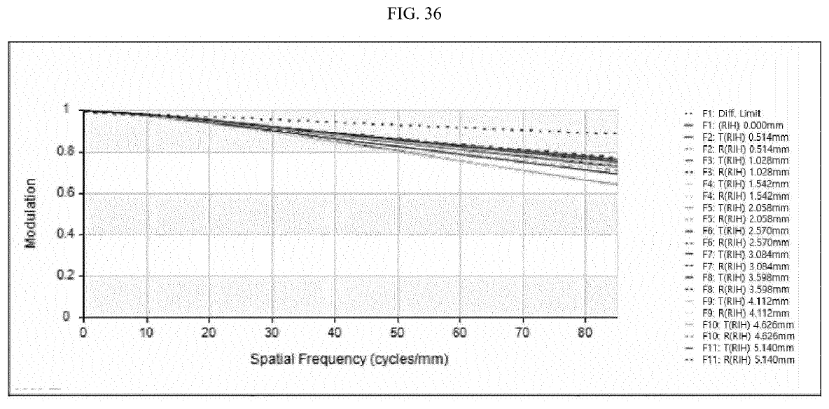

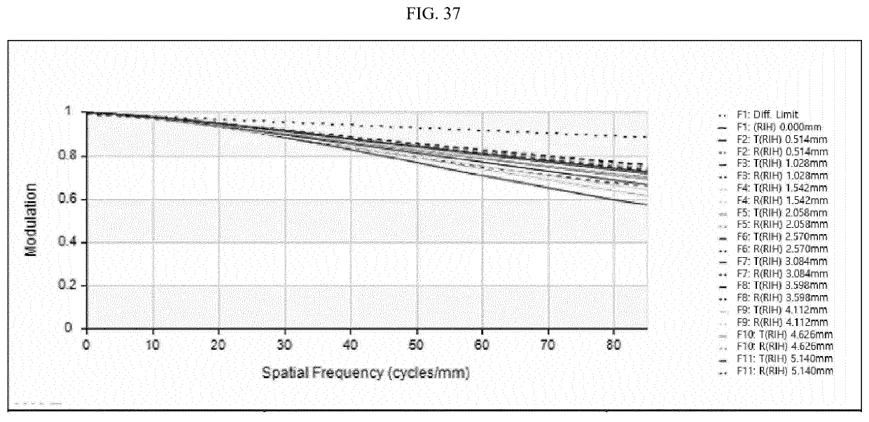

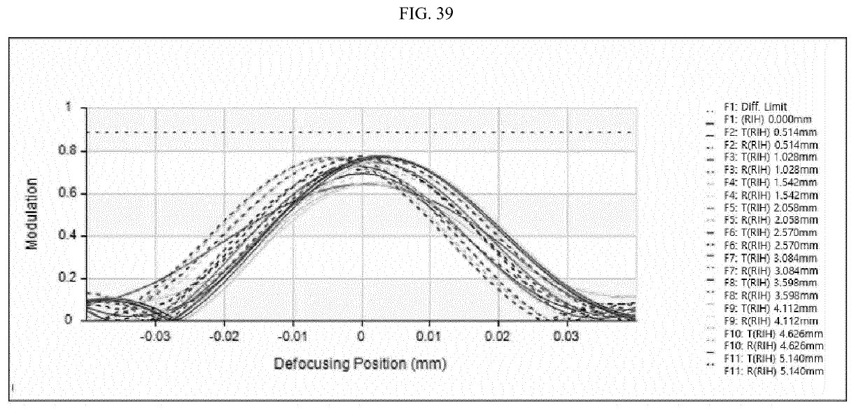

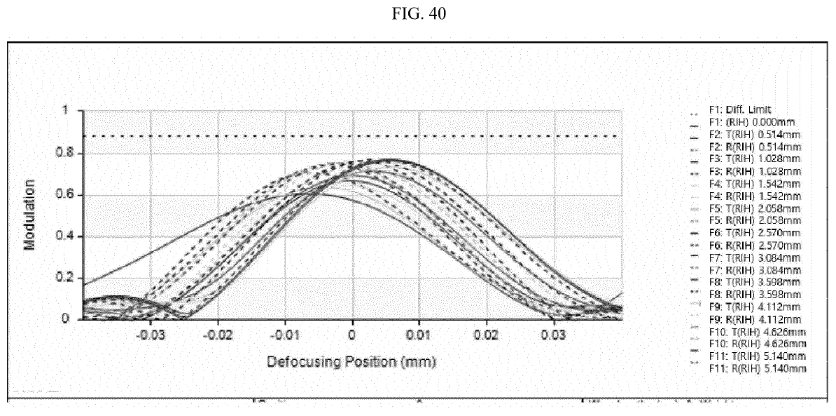

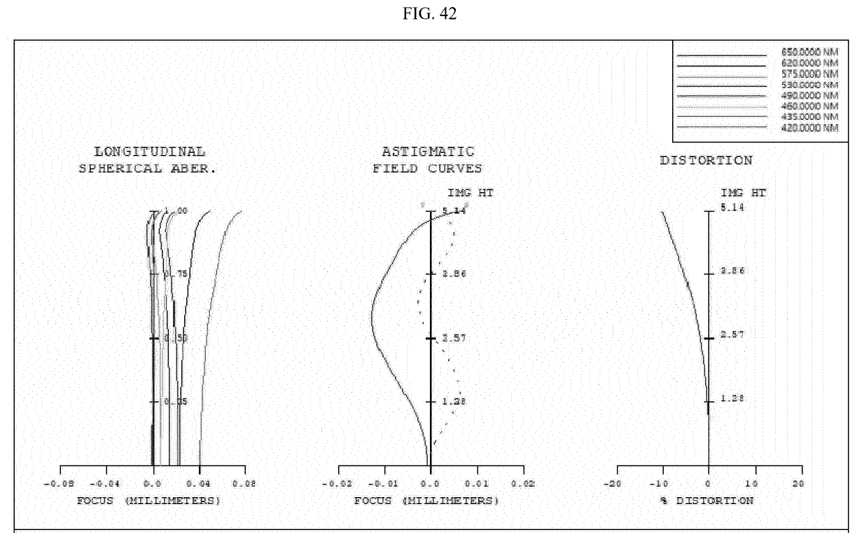

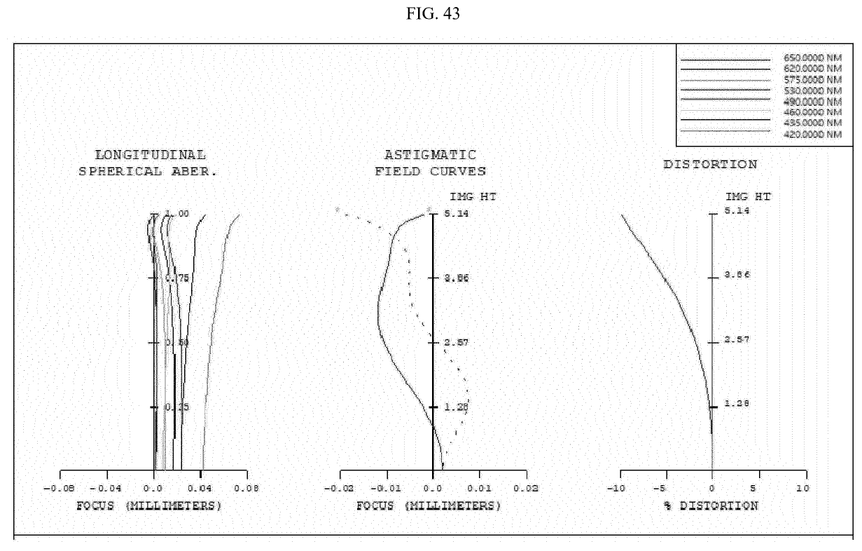

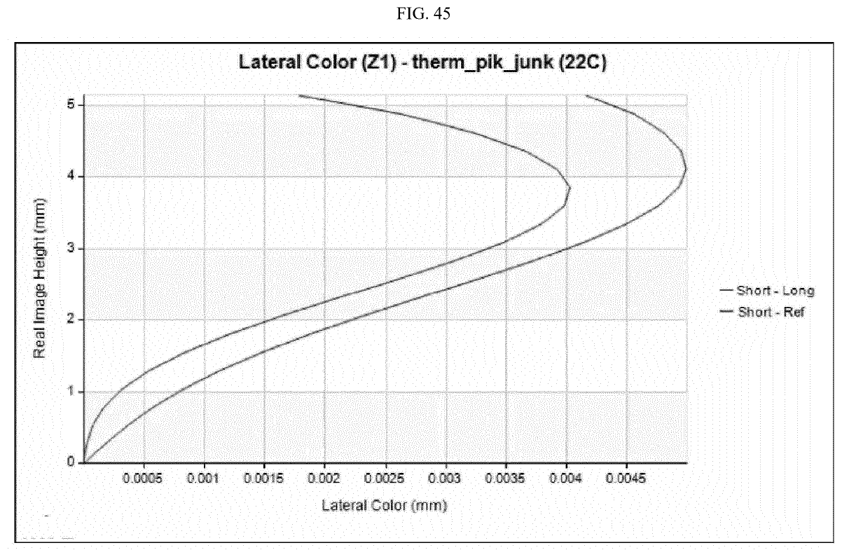

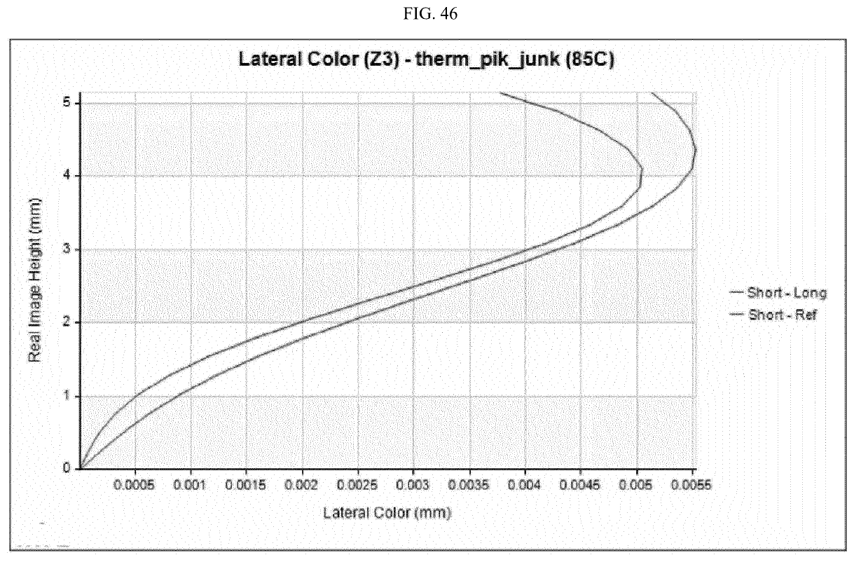

Referring to FIGS. 32 to 46 for the third embodiment FIG. 32 is a side cross-sectional view showing an optical system for a vehicle according to a third embodiment of the invention, and in describing the third embodiment, the same configuration as the first and second embodiments will be referred to the description of the first and second embodiments.

Referring to FIG. 32, the optical system may include a first lens 131, a second lens 132, a third lens 133, a fourth lens 134, a fifth lens 135 and a sixth lens 136 stacked along an optical axis in a direction from the object side to the sensor side. The optical system or a camera module having the same may include an image sensor 190, a cover glass 191 disposed between the image sensor 190 and a last lens 146, and an optical filter 192. The optical system may include an aperture stop ST for adjusting the amount of incident light A lens group disposed on the object side based on the aperture stop ST may be divided into a first lens group and the lens group disposed on the sensor side based on the aperture stop ST may be divided into a second lens group. That is, the first lens group may include the first, second, and third lenses 131, 132, and 133, and the second lens group may include the fourth to sixth lenses 134, 135, and 136. The aperture stop ST may be disposed on the outer circumference between the third lens 133 and the fourth lens 134. A circumference of the sensor-side surface of the third lens 133 or an object-side surface of the fourth lens 134 may function as an aperture stop.

The first lens 131 is a lens closest to the subject and may include a glass material. Since the first lens 131 may be formed of a crown glass material, a light dispersion value may be high. The first lens 131 includes a first surface S1 on which light is incident and a second surface S2 on which light is emitted, and both the first surface S1 and the second surface S2 may be spherical surfaces. The first lens 131 may have negative refractive power and a refractive index of less than 1.55. The first lens 131 may have the lowest refractive index among lenses in the optical system. The first surface S1 of the first lens 131 may be convex toward the object, and the second surface S2 may be concave toward the object. The first lens 131 may have a meniscus shape in which both sides S1 and S2 are convex toward the object side. An outer circumference of the second surface S2 may include a flat effective region. The radius of curvature of the first surface S1 may be four times greater than the radius of curvature of the second surface S2. The radius of curvature of the first surface S1 obtained as an absolute value may be the largest among the lenses of the optical system. The first lens 131 may be made of plastic to prevent discoloration when the camera module is exposed to light from inside or outside the vehicle, and may be made of glass or plastic when the camera module is placed inside the vehicle.

A distance between the first lens 131 and the second lens 132 on the optical axis may be the largest among distances between lenses in the optical system. The distance between the first lens 131 and the second lens 132 may be 1.5 times or more, for example, 1.5 times to 3 times the distance between the second lens 132 and the third lens 133. The distance between the first lens 131 and the second lens 132 may be 2.5 times or more, for example, 2.5 times to 4 times the center thickness of the first lens 131. The center thickness of the first lens 131 may be thinner than the center thickness of the second lens 132, for example, 1.5 mm or less, or may be in the range of 1 mm to 1.3 mm. The Abbe number Vd of the first lens 131 may be the largest among lenses in the optical system. The Abbe number Vd of the first lens 131 may be, for example, twice or more than the Abbe number Vd of the fourth lens 134. The Abbe number Vd of the first lens 131 may be greater than the Abbe number Vd of the second, third, fifth, and sixth lenses 132, 133, 135, and 136, and may be, for example, greater than or equal to 70 or in the range of 75 to 90. When expressed as an absolute value, the focal length of the first lens 131 may be greater than the focal length of the fourth and fifth lenses 134 and 135 and may be smaller than the focal length of the second lens 132. An effective diameter through which light is incident from the first lens 131 may be larger than the effective diameters of the other second to sixth lenses 132, 133, 134, 135, and 136. An effective diameter through which light is incident from the first lens 131 may be larger than the effective diameters of the second to fourth lenses 132, 133, and 134.

The second lens 132 may be made of glass. The second lens 132 has positive (+) refractive power and may be formed of a material having a refractive index of 1.6 or more or 1.7 or more. The refractive indices of the second and third lenses 132 and 33 may have the highest refractive index among the lenses of the optical system, or may be higher than those of the first lens 131 and the fifth and sixth lenses 135 and 136. The second lens 132 may be disposed between the first lens 131 and the third lens 133. The second lens 132 includes a third surface S3 on which light is incident and a fourth surface S4 on which light is emitted, and both the third surface S3 and the fourth surface S4 may be spherical. The third surface S3 may be concave toward the object, and the fourth surface S4 may be convex toward the sensor. The second lens 132 may have a meniscus shape convex toward the sensor. Expressed as an absolute value, the radius of curvature of the third surface S3 may be smaller than the radius of curvature of the fourth surface S4. When expressed as an absolute value, the radius of curvature of the fourth surface S4 may be smaller than that of the first surface S1. When expressed as an absolute value, the difference between the radii of curvature of the third and fourth surfaces S3 and S4 may be 10 or less.

A distance between the second lens 132 and the third lens 133 on the optical axis may be 1.5 mm or more. The center thickness of the second lens 132 may be twice or more than the distance between the second and third lenses 132 and 133, and may be greater than 4.5 mm or in the range of 4.5 mm to 5.5 mm. The Abbe number Vd of the second lens 132 may be 30 or more, for example, 40 or more. The focal length of the second lens 132 may be 40 or more. Since the first and second lenses 131 and 132 are made of a glass material on the object side, an expansion problem caused by heat transmitted through the object side may be reduced. The second lens 132 is made of glass and has a high refractive index and a high dispersion value, so that it can improve the aberration of incident light. An effective diameter through which light is incident from the second lens 132 may be larger than the effective diameters of the third and fourth lenses 133 and 134.

The third lens 133 may be made of glass. The third lens 133 has positive (+) refractive power and may be formed with a refractive index of 1.65 or more or a refractive index in the range of 1.65 to 1.82. The third lens 133 may be disposed between the second and fourth lenses 132 and 134. The third lens 133 includes a fifth surface S5 on which light is incident and a sixth surface S6 on which light is emitted, and both the fifth surface S5 and the sixth surface S6 may be aspheric surfaces. The third lens 133 may be injection molded of a glass material. The fifth surface S5 may be convex toward the object, and the sixth surface S6 may be concave. The third lens 133 may have a meniscus shape convex toward the object side. The radius of curvature of the fifth surface S5 may be smaller than the radius of curvature of the sixth surface S6 and may be in the range of 5 mm or more, for example, in a range of 5 mm to 10 mm. The difference between the two radii of curvature may be 10 mm or more. The distance between the third lens 133 and the fourth lens 134 on the optical axis may be smaller than the distance between the first and second lenses 131 and 132. A distance between the third lens 133 and the fourth lens 134 may be greater than a center thickness of the third lens 133. The center thickness of the third lens 133 may be greater than or equal to 1.5 mm, for example, in the range of 1.5 mm to 2.5 mm. The refractive indices of the third and fourth lenses 133 and 134 may be the same or may have a difference of 0.3 or less. The Abbe number Vd of the third lens 133 may be the smallest among lenses in the optical system, may be 35 or more, and may be in the range of 35 to 55. The focal length of the third lens 133 may be 10 or more, for example, in the range of 10 to 25.

The fourth lens 134 may be made of a plastic material. The fourth lens 134 has negative (−) refractive power and may be formed with a refractive index of 1.6 or more or a refractive index in the range of 1.6 to 1.72. The fourth lens 134 may be disposed between the third and fifth lenses 133 and 135. Here, when the material of the fourth to sixth lenses 134, 135, and 136 is formed of a plastic material, the amount of light may be increased by the aspheric surface of the lens. The fourth lens 134 includes a seventh surface S7 on which light is incident and an eighth surface S8 on which light is emitted, and both the seventh surface S7 and the eighth surface S8 may be aspheric surfaces. The seventh surface S7 may be convex toward the object, and the eighth surface S8 may be concave. Expressed as an absolute value, the radius of curvature of the seventh surface S7 may be larger than that of the third surface S3, and may be three or more times greater than the radius of curvature of the eighth surface S8.

The distance between the fourth lens 134 and the fifth lens 135 on the optical axis may be smaller than the distance between the third and fourth lenses 133 and 134. A distance between the fourth lens 134 and the fifth lens 135 may be equal to or greater than a center thickness of the fourth lens 134. The center thickness of the fourth lens 134 may be 1.5 mm or less, for example, in the range of 0.7 mm to 1.5 mm, and the distance between the fourth lens 134 and the fifth lens 135 may be 1.5 mm or less, and, for example, it may be in the range of 0.6 mm to 1.5 mm. The refractive index of the fourth lens 134 may be higher than that of the fifth lens 135, and the difference between them may be 0.5 or less. The Abbe number Vd of the fourth lens 134 may be smaller than the Abbe number of the fifth lens 135, may be the smallest among lenses in the optical system, and may be less than 30, for example, in the range of 15 to 29. When the focal length of the fourth lens 134 is obtained as an absolute value, it may be 20 or less, for example, in the range of 10 to 20. Here, the aperture stop ST may be disposed around the periphery between the third lens 133 and the fourth lens 134. The aperture stop ST may be disposed on the periphery between the glass material and the plastic lens.

The fifth lens 135 may be made of a plastic material. The fifth lens 133 may have positive (+) refractive power. The refractive index of the fifth lens 135 is lower than that of the fourth lens 134 and may be formed with a refractive index of 1.6 or less or a refractive index in the range of 1.5 to 1.6. The fifth lens 135 may be disposed between the fourth and sixth lenses 134 and 136. The fifth lens 135 includes a ninth surface S9 on which light is incident and a tenth surface S10 on which light is emitted, and both the ninth surface S9 and the tenth surface S10 may be aspherical surfaces. The ninth surface S5 may be convex toward the object, and the tenth surface S10 may be convex. The fifth lens 135 may have a convex shape on both sides. When expressed as an absolute value, the radius of curvature of the ninth surface S9 may be greater than that of the tenth surface S10, and the difference between them may be 5 mm or less. The distance between the fifth lens 135 and the sixth lens 136 on the optical axis may be smaller than the distance between the second and third lenses 132 and 133. A distance between the fifth lens 135 and the sixth lens 136 may be smaller than a center thickness of the fifth lens 135. The center thickness of the fifth lens 135 may be greater than or equal to 3 mm, for example, in the range of 3 mm to 3.8 mm. The refractive indices of the fifth and sixth lenses 135 and 136 may be the same or may have a difference of 0.3 or less. The Abbe numbers Vd of the fifth and sixth lenses 135 and 136 may be the same or may have a difference of 10 or less. The Abbe number Vd of the fifth lens 135 may be 50 or more, for example, in the range of 50 to 60. When the focal length of the fifth lens 135 is obtained as an absolute value, it may be 10 or less, for example, in the range of 5 to 10.

The sixth lens 136 is a lens closest to the image sensor 190 and may be made of a plastic material. The sixth lens 136 has negative (−) refractive power and may be formed with a refractive index of 1.6 or less, for example, in the range of 1.5 to 1.6. The sixth lens 136 includes an eleventh surface S11 on which light is incident and a twelfth surface S12 on which light is emitted, and both the eleventh surface S11 and the twelfth surface S12 may be aspheric surfaces. The eleventh surface S7 may be convex toward the sensor, and the twelfth surface S12 may be concave. At least one or both of the eleventh surface S11 and the twelfth surface S12 of the sixth lens 136 may have an inflection point. The radius of curvature of the eleventh surface S11 may be greater than that of the twelfth surface S12. The center thickness of the sixth lens 136 may be thicker than the center thickness of the first lens 131 and may be in the range of greater than 2 mm or 2 mm to 3 mm. The Abbe number Vd of the sixth lens 136 may be 50 or more, for example, in the range of 50 to 60. When the focal length of the sixth lens 136 is obtained as an absolute value, it may be 15 or more, for example, in the range of 15 to 30. An effective diameter through which light is incident from the sixth lens 136 may be larger than the effective diameters of the third and fourth lenses 133 and 134. Here, the ratio of the lenses disposed on the sensor side and the lenses disposed on the object side with respect to the aperture stop ST may be 1:1.

The image sensor 190, the optical filter 192, and the cover glass 191 will refer to the descriptions disclosed above. In the optical system according to the third embodiment of the invention, the angle of view (diagonal line) may be 70 degrees or more, for example, in the range of 73 degrees to 77 degrees. The effective focal length may be greater than or equal to 7 mm, such as in the range of 7 mm to 8 mm. The F number of the optical system or camera module may be 2.2 or less, for example, in the range of 1.7 to 2.2. The chief ray angle (CRA) may be greater than or equal to 10 degrees, such as in the range of 10 to 15 degrees. In the optical system, a distance (TTL) between the image sensor 190 and the vertex of the first lens 131 may be 40 mm or less. In addition, the wavelength of light used in the optical system may be in the range of 400 nm to 700 nm.

Table 5 shows lens data in the optical system of FIG. 32.

TABLE 5

| | | | | | Refractive | Abbe | | | |
|---|---|---|---|---|---|---|---|---|---|
| | | | Radius of | Thickness/ | index | number | | Focal | Effective |
| | Surface | Shape | curvature | distance | Nd | Vd | Diopter | length | radius |
| Lens1 | S1 | Sphere | 50.367 | 1.326 | 1.497 | 81.607 | −47.00 | −21.27 | 9.202 |
| | S2 | Sphere | 8.693 | 4.119 | | | | | 7.019 |
| Lens 2 | S3 | Flat | 1.E+18 | 1.700 | 1.774 | 49.624 | 18.99 | 52.65 | 6.764 |
| | S4 | Sphere | −20.025 | 4.997 | | | | | 6.900 |
| Lens 3 | S5 | Sphere | −14.917 | 2.141 | 1.774 | 49.624 | −64.47 | −15.04 | 4.160 |
| | S6 | Flat | 1.E+18 | 2.141 | | | | | 3.715 |
| Stop | | Flat | 1.E+18 | | | | | | |
| Lens 4 | S7 | Asphere | 24.505 | 0.986 | 1.674 | 19.246 | −90.61 | −11.04 | 2.834 |
| | S8 | Asphere | 5.672 | 1.000 | | | | | 3.254 |
| Lens5 | S9 | Asphere | 8.339 | 3.486 | 1.545 | 56.109 | 137.66 | 7.26 | 3.931 |
| | S10 | Asphere | −6.485 | 1.407 | | | | | 4.200 |
| Lens6 | S11 | Asphere | 16.811 | 2.483 | 1.545 | 56.109 | −53.18 | −18.80 | 4.092 |
| | S12 | Asphere | 6.053 | 0.867 | | | | | 5.144 |
| BPF | Sa | Flat | 1.E+18 | 0.400 | 1.517 | 64.166 | | | |
| | Sb | Flat | 1.E+18 | 1.000 | | | | | |
| Cover | Sc | Flat | 1.E+18 | 0.400 | 1.517 | 64.166 | | | |
| glass | Sd | Flat | 1.E+18 | 0.200 | | | | | |
| CIS | | Flat | 1.E+18 | 0.000 | | | | | |

In Table 5, the refractive indices of the first to sixth lenses 131, 132, 133, 134, 135, and 136 are the refractive indices at 587 nm, the Abbe number Vd at the d-line (587 nm) of the first to sixth lenses 131, 132, 133, 134, 135, and 136 may less than 30 for the fourth lens 134, and may be 50 or more for the first, second, fifth, and sixth lenses 131, 132, 135, and 136. When expressed as an absolute value, the diopter of the fifth lens may be greater than that of the other lenses. Based on Table 5 above, the values of the radius (mm) of curvature, thickness (mm), distance (mm), refractive index, Abbe number, and focal length (mm) may be expressed as large and small relational expressions through relative comparison. For example, the focal length in an absolute value may represent a relational expression in the order of second lens>first lens>sixth lens>third lens>fourth lens>fifth lens.

Table 6 is the aspheric coefficient of each surface of each lens in the optical system of FIG. 32.

TABLE 6

| | | Aspheric coefficient | | | | |
|---|---|---|---|---|---|---|
| Item | Surface | K | A | B | C | D |
| Lens 1 | S1 | | | | | |
| | S2 | | | | | |
| Lens 2 | S3 | | | | | |
| | S4 | | | | | |
| Lens 3 | S5 | 0.0000000 | 0.0002998 | 0.0000057 | −0.0000005 | 1.62E−08 |
| | S6 | 0.0000000 | 0.0004895 | −0.0000181 | 0.0000003 | −9.50E−08 |
| Lens 4 | S7 | 11.1576006 | −0.0047002 | 0.0000585 | −0.0000058 | −8.32E−07 |
| | S8 | 0.0638358 | −0.0059795 | 0.0002834 | −0.0000204 | −8.97E−08 |
| Lens 5 | S9 | −6.6592575 | −0.0003575 | 0.0000324 | −0.0000011 | −3.77E−08 |
| | S10 | 0.4446335 | −0.0009464 | 0.0000847 | −0.0000024 | 4.73E−08 |
| Lens6 | S11 | −48.6716867 | −0.0044880 | 0.0000269 | 0.0000042 | −1.25E−07 |
| | S12 | −5.4590557 | −0.0033917 | 0.0000553 | −0.0000006 | −7.30E−08 |
| | | Aspheric coefficient | | | | |
| Item | Surfac | E | F | G | H | J |
| Lens 1 | S1 | | | | | |
| | S2 | | | | | |
| Lens 2 | S3 | | | | | |
| | S4 | | | | | |
| Lens 3 | S5 | −3.15E−10 | −7.14E−11 | −3.70E−12 | 7.16E−14 | 4.82E−15 |
| | S6 | −4.53E−09 | 1.40E−10 | 3.42E−12 | 8.08E−13 | −2.74E−14 |
| Lens 4 | S7 | −2.29E−08 | 1.90E−09 | 4.41E−10 | 6.93E−11 | −1.15E−11 |
| | S8 | 6.36E−08 | 1.51E−09 | −2.68E−10 | −1.58E−11 | 1.36E−12 |
| Lens 5 | S9 | 2.43E−09 | −2.71E−11 | −1.21E−12 | −4.88E−13 | 1.18E−14 |
| | S10 | 1.64E−09 | 1.76E−11 | −3.61E−12 | −1.84E−13 | 1.78E−15 |
| Lens6 | S11 | −1.05E−08 | −3.41E−10 | 3.11E−11 | 2.04E−12 | −1.36E−13 |
| | S12 | 1.34E−09 | 5.83E−11 | −4.02E−13 | −7.31E−14 | 1.12E−15 |

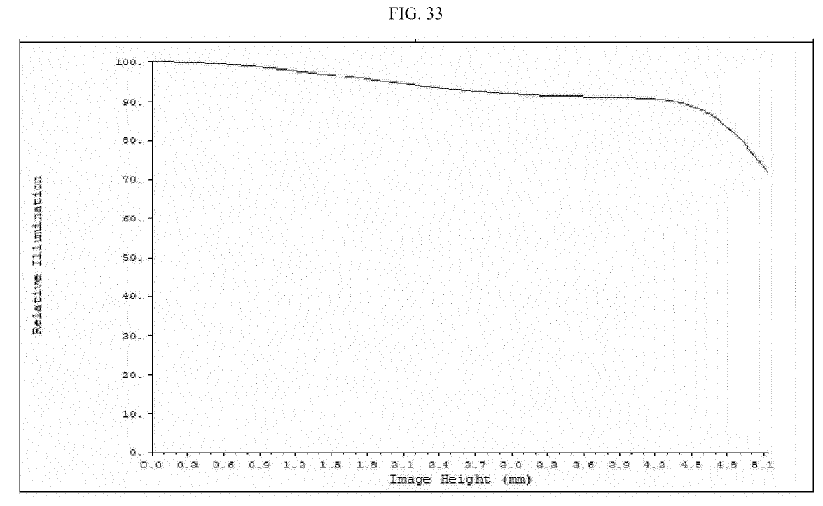

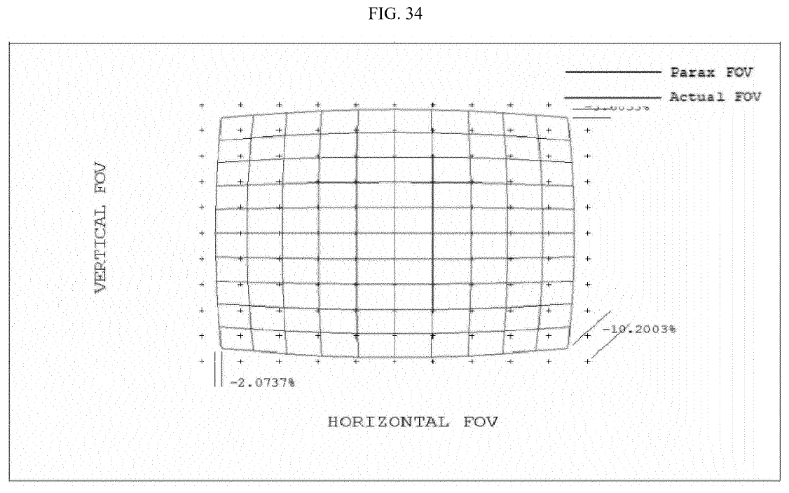

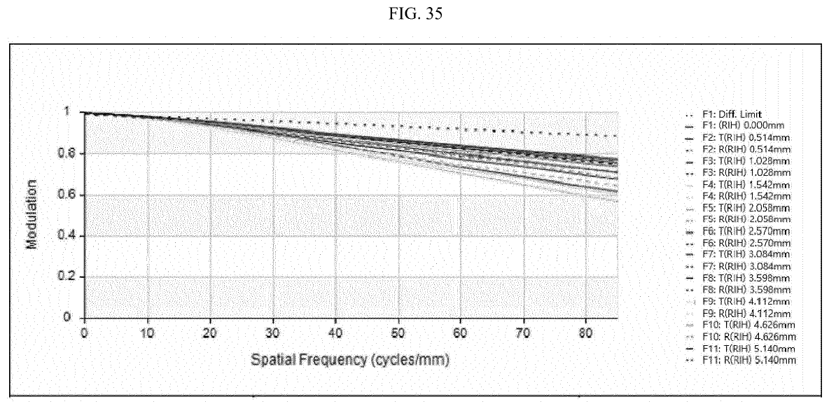

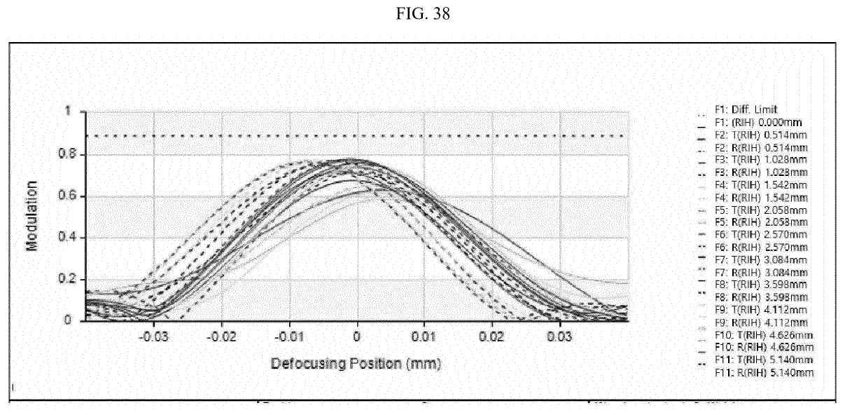

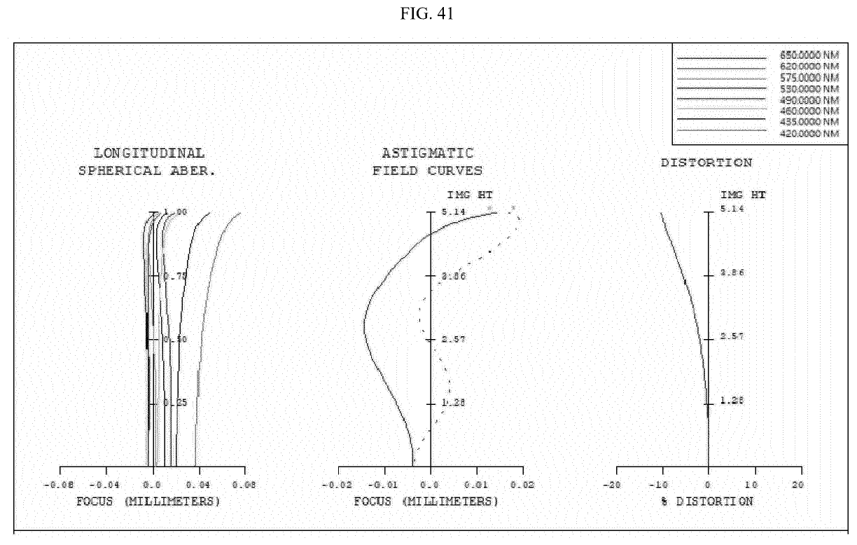

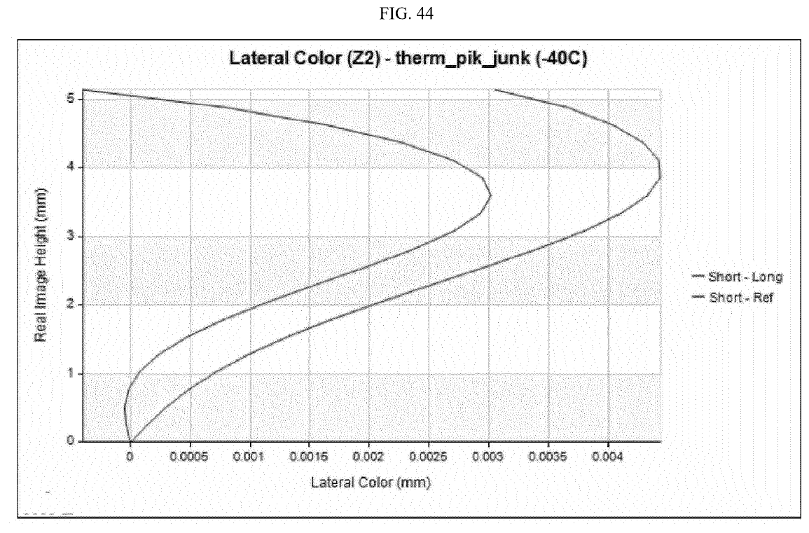

FIG. 33 is a graph showing the ambient light ratio or relative illumination according to the image height in the optical system of FIG. 32, and it may be seen that the ambient light volume ratio is 55% or more from the center of the image sensor to the diagonal end, for example, 70% or more. FIG. 34 is a diagram showing an actual FOV and a Parax FOV for a horizontal FOV (Field of View) and vertical FOV at room temperature (e.g., 22 degrees) in the optical system of FIGS. 32. 35 to 37 are graphs showing diffraction MTF at low temperature, room temperature, and high temperature in the optical system of FIG. 32, and are graphs showing luminance ratio (modulation) according to spatial frequency. FIGS. 38 to 40 are graphs showing the diffraction modulation transfer function (MTF) at low temperature, room temperature, and high temperature in the optical system of FIG. 32, and are graphs showing the luminance ratio according to the defocusing position. As shown in FIGS. 35 to 40, it may be seen that the luminance ratio (modulation) is hardly changed at a low temperature of −40 degrees, a room temperature of 22 degrees, and a high temperature of 85 degrees. As shown in FIGS. 41 to 43, in the optical system of FIG. 32, longitudinal spherical aberration, astigmatic field curves, and distortion at low temperature, room temperature, and high temperature are ±17 or less (1.0 filed) may be seen. As shown in FIGS. 44 to 46, in the optical system of FIG. 32, it may be seen that the actual image heights according to the transverse chromatic aberration at low temperature, room temperature, and high temperature may be within 3 pixels between Red-Green, Green-Blue, and Red-Blue. That is, as shown in FIGS. 35 to 46, it may be seen that the change in data according to the temperature change from low temperature to high temperature is not large, less than 10%.

### Fourth Embodiment

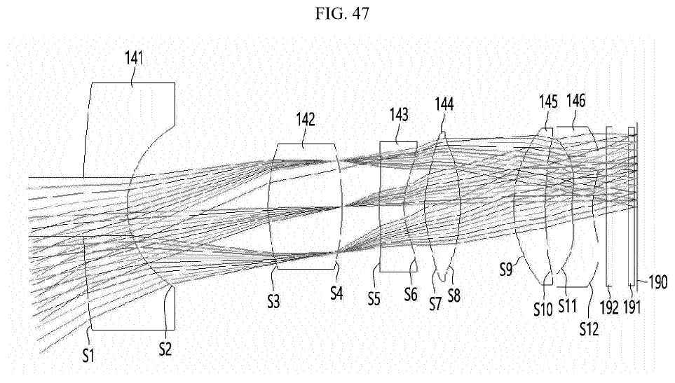

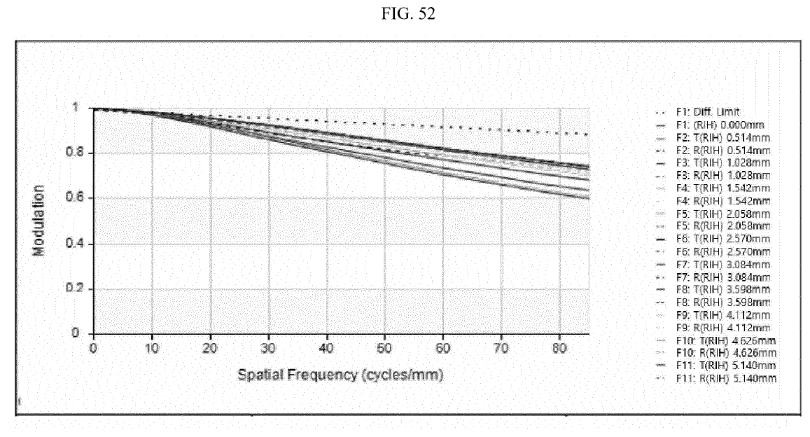

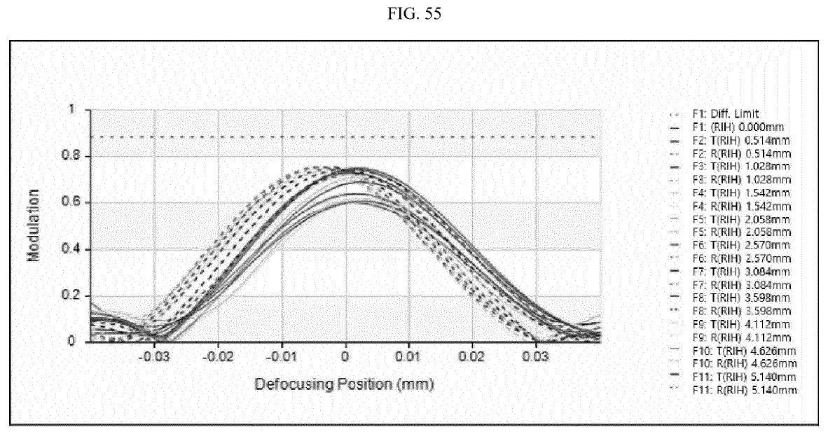

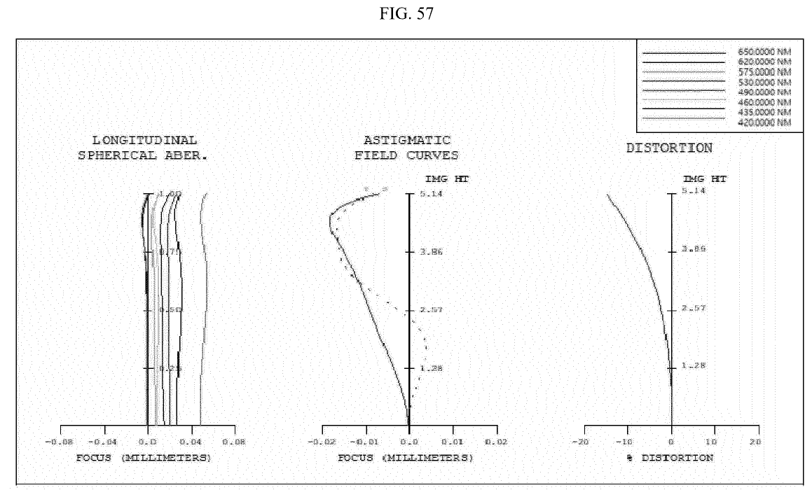

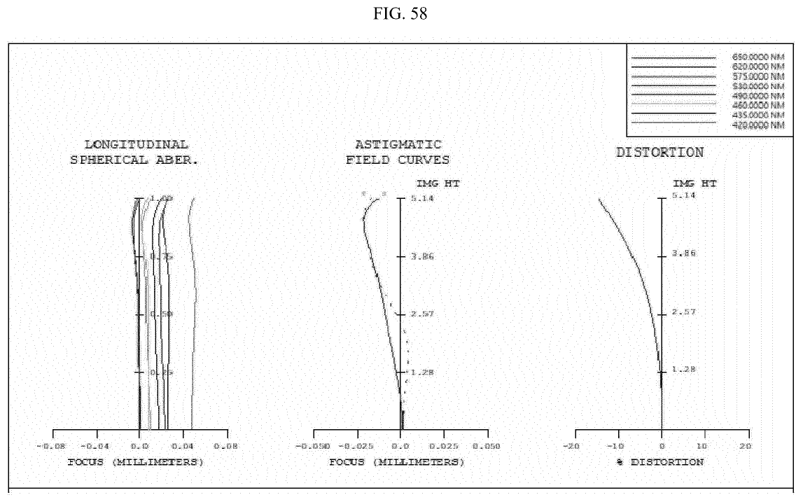

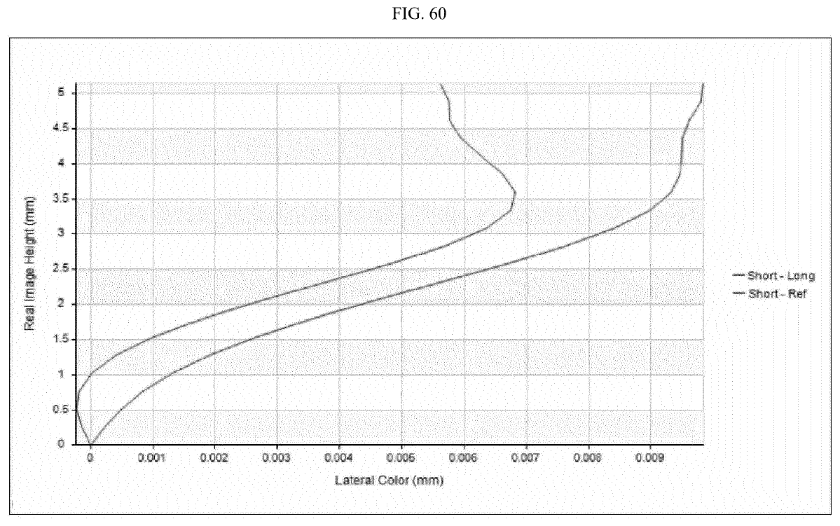

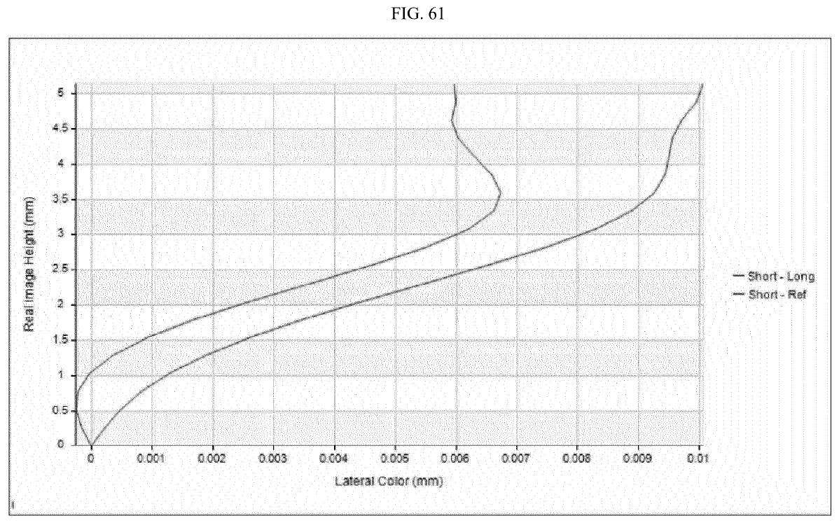

For the fourth embodiment, reference will be made to FIGS. 47 to 61. 47 is a side cross-sectional view showing an optical system for a vehicle according to a fourth embodiment of the invention. In the description of the fourth embodiment, the same configuration as the first to third embodiments will be referred to the description of the first to third embodiments.

Referring to FIG. 47, the optical system may include a first lens 141, a second lens 142, a third lens 143, a fourth lens 144, a fifth lens 145 and sixth lens 146 stacked along an optical axis in a direction from the object side to the sensor side. The optical system may include an aperture stop ST for adjusting the amount of incident light. Based on the aperture stop ST, the lens group disposed on the object side may be divided into a first lens group and the lens group disposed on the sensor side may be divided into a second lens group. That is, the first lens group may include the first and second lenses 141 and 142, and the second lens group may include the third to sixth lenses 143, 144, 145, and 146. The aperture stop ST may be disposed on the outer circumference between the second lens 142 and the third lens 143. The circumference of the sensor-side surface of the second lens 142, or the object-side surface of the third lens 142 may function as an aperture stop.

The first lens 141 is a lens closest to the subject and may include a glass material. The first lens 141 may be formed of a crown glass material, so that a light dispersion value may be high. The first lens 141 includes a first surface SI on which light is incident and a second surface S2 on which light is emitted, and both the first surface S1 and the second surface S2 may be spherical. The first lens 141 may have a negative refractive power and a refractive index of less than 1.55. The first lens 141 may have the lowest refractive index among lenses in the optical system. The first surface S1 of the first lens 141 may be convex toward the object, and the second surface S2 may be concave toward the object. The first lens 141 may have a meniscus shape in which both surfaces S1 and S2 are convex toward the object side. An outer circumference of the second surface S2 may include a flat region. The radius of curvature of the first surface S1 may be six times greater than the radius of curvature of the second surface S2. The radius of curvature of the first surface S1 obtained as an absolute value may be the largest among the lenses of the optical system. The first lens 141 may be made of plastic to prevent discoloration when the camera module is exposed to light from inside or outside the vehicle, and may be made of glass or plastic when the camera module is placed inside the vehicle.

A distance between the first lens 141 and the second lens 142 on the optical axis may be the largest among distances between lenses in the optical system. The distance between the first lens 141 and the second lens 142 may be twice or more, for example, 2 times to 4 times the distance between the second lens 142 and the third lens 143. The distance between the first lens 141 and the second lens 142 may be twice or more, for example, 2 to 4 times the center thickness of the first lens 141. The center thickness of the first lens 141 may be thinner than the center thickness of the second lens 142, for example, 3 mm or less, or may be in the range of 2 mm to 3 mm. The Abbe number Vd of the first lens 141 may be the largest among lenses in the optical system. The Abbe number Vd of the first lens 141 may be, for example, twice or more than the Abbe number Vd of the third and sixth lenses 143 and 146. The Abbe number Vd of the first lens 141 may be greater than the Abbe number Vd of the second, fourth, and fifth lenses 142, 144, and 145, and may be, for example, greater than or equal to 70 or in the range of 75 to 90. When expressed as an absolute value, the focal length of the first lens 141 may be greater than that of the second and fourth lenses 142 and 144. An effective diameter through which light is incident from the first lens 141 may be larger than the effective diameters of the other second to sixth lenses 142, 143, 144, 145, and 146. An effective diameter through which light is incident from the first lens 141 may be larger than the effective diameters of the second to fourth lenses 142, 143, and 144.

The second lens 142 may be made of glass. The second lens 142 has positive (+) refractive power and may be formed of a material having a refractive index of 1.6 or more or 1.7 or more. The refractive index of the second and fifth lenses 142 and 145 may have the highest refractive index among the lenses of the optical system. The second lens 142 may be disposed between the first lens 141 and the third lens 143. The second lens 142 includes a third surface S3 on which light is incident and a fourth surface S4 on which light is emitted, and both the third surface S3 and the fourth surface S4 may be spherical. The third surface S3 may be convex toward the object, and the fourth surface S4 may be convex toward the sensor. Expressed as an absolute value, the radius of curvature of the third surface S3 may be smaller than the radius of curvature of the fourth surface S4. When expressed as an absolute value, the radius of curvature of the fourth surface S4 may be greater than the radius of curvature of the second surface S2. A distance between the second lens 142 and the third lens 143 on the optical axis may be 1 mm or more. The center thickness of the second lens 142 may be 1.5 times or more of the distance between the second and third lenses 142 and 143, and may be 4 mm or more, or may be in the range of 4 mm to 5 mm. The Abbe number Vd of the second lens 142 may be 30 or more, for example, 40 or more. The focal length of the second lens 142 may be 20 or less. Since the first and second lenses 141 and 142 are made of a glass material on the object side, an expansion problem caused by heat transmitted through the object side may be reduced. The second lens 142 is made of glass and has a high refractive index and a high dispersion value, so that it may improve the aberration of incident light.

The third lens 143 may be made of a plastic material. The third lens 143 has negative (−) refractive power and may be formed with a refractive index of 1.6 or more or a refractive index in the range of 1.6 to 1.72. The third lens 143 may be disposed between the second and fourth lenses 142 and 144. The third lens 143 includes a fifth surface S5 on which light is incident and a sixth surface S6 on which light is emitted, and both the fifth surface S5 and the sixth surface S6 may be aspheric surfaces. The fifth surface S5 may be convex toward the object, and the sixth surface S6 may be concave. The third lens 143 may have a meniscus shape convex toward the object side. The radius of curvature of the fifth surface S5 may be greater than the radius of curvature of the sixth surface S6, and the difference between them may be 5 mm or more. The distance between the third lens 143 and the fourth lens 144 on the optical axis may be smaller than the distance between the second and third lenses 142 and 143. A distance between the third lens 143 and the fourth lens 144 may be smaller than a center thickness of the third lens 143. The center thickness of the third lens 143 may be greater than or equal to 1.2 mm, for example, in the range of 1.2 mm to 1.8 mm.

The refractive index of the third lens 143 may be greater than that of the fourth lens 144. The Abbe number Vd of the third lens 143 may be smaller than the Abbe number of the fourth lens 144, may be less than 30, and may be, for example, in the range of 15 to 29. When the focal length of the third lens 143 is obtained as an absolute value, it may be 25 mm or less, for example, in the range of 10 mm to 25 mm. Here, the aperture stop ST may be disposed around the periphery between the second lens 142 and the third lens 143. The aperture stop ST may be disposed on a circumference between a lens made of glass and a lens made of plastic.

The fourth lens 144 may be made of a plastic material. The fourth lens 144 has positive (+) refractive power and may be formed with a refractive index of 1.6 or less or a refractive index in the range of 1.5 to 1.6. The fourth lens 144 may be disposed between the third and fifth lenses 143 and 145. Here, when the material of the third, fourth, and sixth lenses 143, 144, and 146 is formed of a plastic material, the amount of light may be increased by the aspheric surface of the lens. The fourth lens 144 includes a seventh surface S7 on which light is incident and an eighth surface S8 on which light is emitted, and both the seventh surface S7 and the eighth surface S8 may be aspherical surfaces. The seventh surface S7 may be convex toward the object, and the eighth surface S8 may be convex. Expressed as an absolute value, the radius of curvature of the seventh surface S7 may be smaller than that of the eighth surface S8. Expressed as an absolute value, the radius of curvature of the seventh surface S7 may be smaller than the radius of curvature of the third surface S3. The radius of curvature of the eighth surface S8 may be 1.5 times greater than the radius of curvature of the seventh surface S7.

The distance between the fourth lens 144 and the fifth lens 145 on the optical axis may be smaller than the distance between the second and third lenses 142 and 143. A distance between the fourth lens 144 and the fifth lens 145 may be smaller than a center thickness of the fourth lens 144. The center thickness of the fourth lens 144 may be 1.6 mm or more, for example, in the range of 1.6 mm to 2.6 mm, and the distance between the fourth lens 144 and the fifth lens 145 may be 2 mm or less, for example, in the range of 1 mm to 2 mm. The refractive index of the fourth lens 144 may be lower than the refractive index of the fifth lens 145, and the difference between them may be 0.5 or less. The Abbe number Vd of the fourth lens 144 may be greater than the Abbe number of the fifth lens 145, and may be 50 or more, for example, in the range of 50 to 70. When the focal length of the fourth lens 144 is obtained as an absolute value, it may be 20 or less, for example, in the range of 5 to 20.

The fifth lens 145 may be made of glass. The fifth lens 143 may have positive (+) refractive power. The refractive index of the fifth lens 145 is higher than that of the fourth lens 144, and may be formed with a refractive index of 1.7 or more or a refractive index in the range of 1.7 to 1.82. The fifth lens 145 may be disposed between the fourth and sixth lenses 144 and 146. The fifth lens 145 includes a ninth surface S9 on which light is incident and a tenth surface S10 on which light is emitted, and both the ninth surface S9 and the tenth surface S10 may be spherical. The ninth surface S5 may be convex toward the object, and the tenth surface S10 may be concave. The radius of curvature of the ninth surface S9 may be smaller than that of the tenth surface S10, and the difference between them may be 10 mm or more. The distance between the fifth lens 145 and the sixth lens 146 on the optical axis may be smaller than the distance between the second and third lenses 142 and 143. A distance between the fifth lens 145 and the sixth lens 146 may be smaller than a center thickness of the fifth lens 145. The center thickness of the fifth lens 145 may be greater than or equal to 1.5 mm, for example, in the range of 1.5 mm to 2.5 mm. The refractive index of the fifth lens 145 may be greater than the refractive index of the sixth lens 146. The Abbe number Vd of the fifth lens 145 may be greater than twice the Abbe number of the sixth lens 146. The Abbe number Vd of the fifth lens 145 may be 30 or more, for example, in the range of 30 to 60. When the focal length of the fifth lens 145 is obtained as an absolute value, it may be 30 mm or less, for example, in the range of 10 mm to 30 mm.

The sixth lens 146 is a lens closest to the image sensor 190 and may be made of a plastic material. The sixth lens 146 has negative (−) refractive power and may be formed with a refractive index of 1.6 or less, for example, in the range of 1.45 to 1.6. The sixth lens 146 includes an eleventh surface S11 on which light is incident and a twelfth surface S12 on which light is emitted, and both the eleventh surface S11 and the twelfth surface S12 may be aspheric surfaces. The eleventh surface S7 may be convex toward the sensor, and the twelfth surface S12 may be concave. At least one or both of the eleventh surface S11 and the twelfth surface S12 of the sixth lens 146 may have an inflection point. The radius of curvature of the eleventh surface S11 may be greater than that of the twelfth surface S12. The center thickness of the sixth lens 146 may be thinner than the center thickness of the first lens 141 and may be in the range of 2 mm or less, or 0.8 mm to 2 mm. The Abbe number Vd of the sixth lens 146 may be less than 30, for example, in the range of 10 to 29. When the focal length of the sixth lens 146 is obtained as an absolute value, it may be 25 mm or less, for example, in the range of 14 mm to 25 mm. An effective diameter through which light is incident from the sixth lens 146 may be larger than the effective diameters of the third and fourth lenses 143 and 144.

For the image sensor 190, the optical filter 192, and the cover glass 191, the description of the first embodiment will be referred to. In the optical system according to the fourth embodiment of the invention, the angle of view (diagonal line) may be 70 degrees or more, for example, in the range of 73 degrees to 77 degrees. The effective focal length may be greater than or equal to 7 mm, such as in the range of 7 mm to 8 mm. The F number of the optical system or camera module may be 2.2 or less, for example, in the range of 1.7 to 2.2. The chief ray angle (CRA) may be greater than or equal to 10 degrees, such as in the range of 10 to 15 degrees. In the optical system, a distance (TTL) between the image sensor 190 and the vertex of the first lens 141 may be 40 mm or less. In addition, the wavelength of light used in the optical system may be in the range of 400 nm to 700 nm.

Table 7 shows lens data in the optical system of FIG. 47.

TABLE 7

| | | | | | | Abbe | | | |
|---|---|---|---|---|---|---|---|---|---|
| | | | Radius of | Thickness/ | Refractive | number | | Focal | Effective |
| | Surface | Shape | curvature | Distance | index Nd | Vd | Diopter | length | radius |
| Lens 1 | S1 | Sphere | 74.690 | 2.762 | 1.497 | 81.607 | −60.84 | −15.91 | 8.020 |
| | S2 | Sphere | 7.091 | 6.058 | | | | | 5.529 |
| Lens 2 | S3 | Sphere | 16.984 | 4.683 | 1.774 | 49.624 | 84.74 | 12.23 | 4.050 |
| | S4 | Sphere | −19.034 | 2.306 | | | | | 3.300 |
| Stop | | Flat | 1.E+18 | | | | | | |
| Lens 3 | S5 | Asphere | 15.340 | 1.577 | 1.674 | 19.246 | −69.14 | −14.46 | 3.781 |
| | S6 | Asphere | 5.760 | 1.226 | | | | | 4.212 |
| Lens 4 | S7 | Asphere | 9.607 | 2.212 | 1.545 | 56.095 | 85.32 | 11.72 | 4.800 |
| | S8 | Asphere | −17.728 | 1.691 | | | | | 4.855 |
| Lens 5 | S9 | Sphere | 9.827 | 1.968 | 1.774 | 49.624 | 52.41 | 19.08 | 5.091 |
| | S10 | Sphere | 26.528 | 0.602 | | | | | 4.880 |
| Lens 6 | S11 | Asphere | 12.964 | 1.266 | 1.674 | 19.246 | −57.98 | −17.25 | 4.809 |
| | S12 | Asphere | 5.929 | 0.839 | | | | | 5.200 |
| BPF | Sa | Flat | 1.E+18 | 0.400 | 1.517 | 64.166 | | | |
| | Sb | Flat | 1.E+18 | 1.000 | | | | | |
| Cover | Sc | Flat | 1.E+18 | 0.400 | 1.517 | 64.166 | | | |
| glass | Sd | Flat | 1.E+18 | 0.200 | | | | | |
| CIS | | Flat | 1.E+18 | 0.000 | | | | | |

In Table 8, the refractive indices of the first to sixth lenses 141, 142, 143, 144, 145, and 146 are the refractive indices at 587 nm, the Abbe numbers Vd of the first to sixth lenses 141, 142, 143, 144, 145, and 146 at d-line (587 nm) may be less than 30 for the third lens 143 and the sixth lens 146 and may be 50 or more for the first and fourth lenses 141 and 144. Effective radius represents the radius of each lens. Based on Table 8 above, values of radius (mm) of curvature, thickness (mm), distance (mm), refractive index, Abbe number, and focal length (mm) may be expressed as large and small relational expressions through relative comparison. For example, the Abbe number may represent a relational expression in the order of the first lens>the fourth lens>the second and fifth lenses>the third and sixth lenses. Table 8 is the aspherical coefficient of each surface of each lens in the optical system of FIG. 47.

TABLE 8

| | | Aspherical coefficient | | | | |
|---|---|---|---|---|---|---|
| Item | Surface | K | A | B | C | D |
| Lens 1 | S1 | | | | | |
| | S2 | | | | | |
| Lens 2 | S3 | | | | | |
| | S4 | | | | | |
| Lens 3 | S5 | −20.6736681 | −0.0021989 | 0.0000496 | −0.0000006 | −2.80E−08 |
| | S6 | −4.8313063 | −0.0016277 | 0.0000446 | −0.0000008 | 3.69E−09 |
| Lens 4 | S7 | −7.0809749 | −0.0001074 | −0.0000077 | −0.0000003 | 2.09E−08 |
| | S8 | −15.1636399 | −0.0009005 | 0.0000123 | −0.0000006 | 1.06E−08 |
| Lens 5 | S9 | | | | | |
| | S10 | | | | | |
| Lens 6 | S11 | 3.9427194 | −0.0059390 | 0.0000621 | 0.0000030 | −8.66E−08 |
| | S12 | −4.0008157 | −0.0041338 | 0.0001038 | −0.0000017 | 1.71E−08 |
| | | Aspherical coefficient | | | | |
| Item | Surface | E | F | G | H | J |
| Lens 1 | S1 | | | | | |
| | S2 | | | | | |
| Lens 2 | S3 | | | | | |
| | S4 | | | | | |
| Lens 3 | S5 | −1.33E−10 | −1.13E−11 | 1.25E−12 | 1.08E−13 | −9.89E−15 |
| | S6 | 3.57E−11 | −1.16E−11 | 1.24E−13 | 3.84E−15 | −1.19E−15 |
| Lens 4 | S7 | −5.67E−11 | 2.05E−12 | 2.82E−14 | −1.22E−15 | −7.33E−18 |
| | S8 | 9.98E−11 | 4.42E−12 | 1.26E−13 | 4.35E−15 | 4.55E−17 |
| Lens 5 | S9 | | | | | |
| | S10 | | | | | |
| Lens 6 | S11 | | | | | |
| | S12 | 7.69E−11 | −1.73E−13 | −3.32E−13 | 4.40E−15 | |

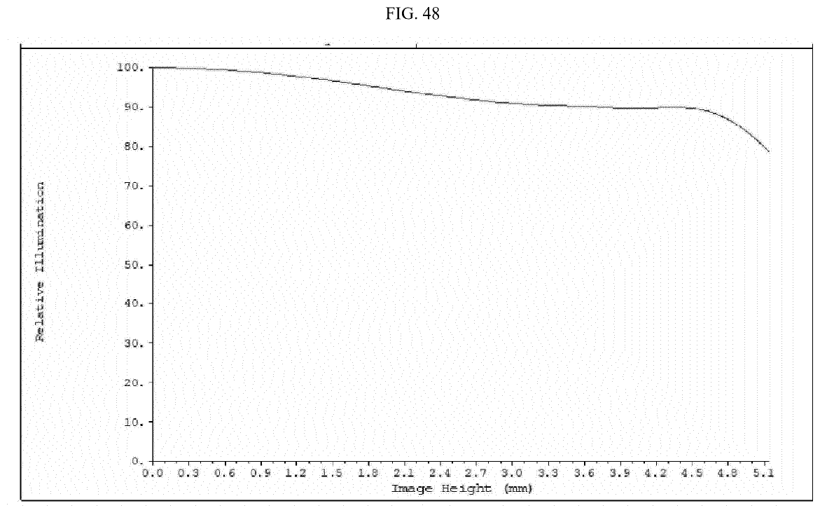

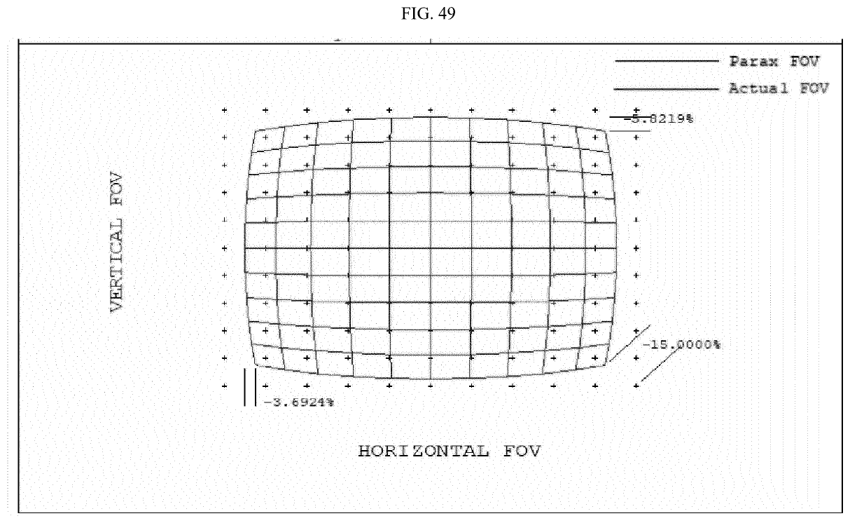

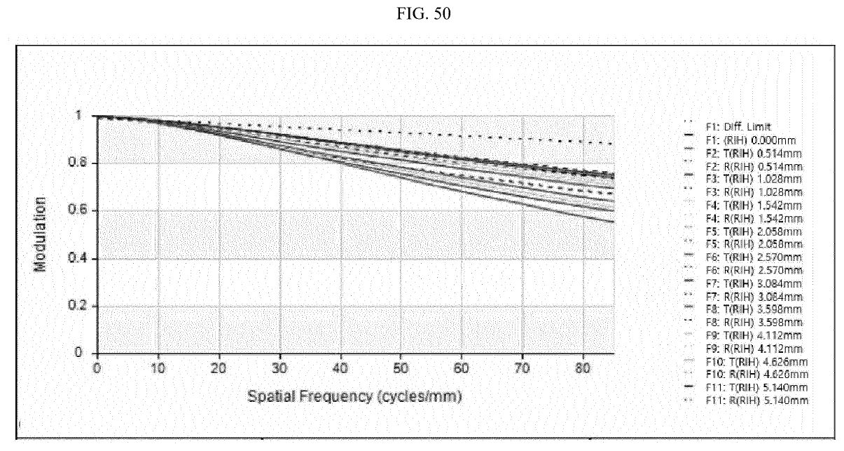

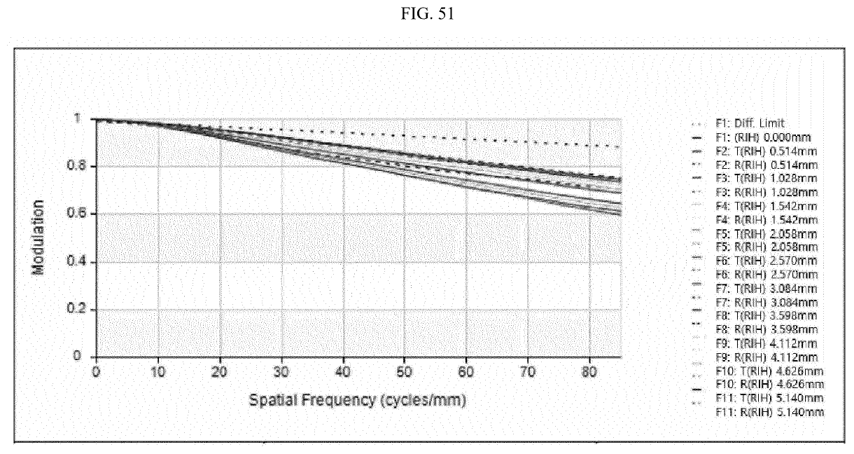

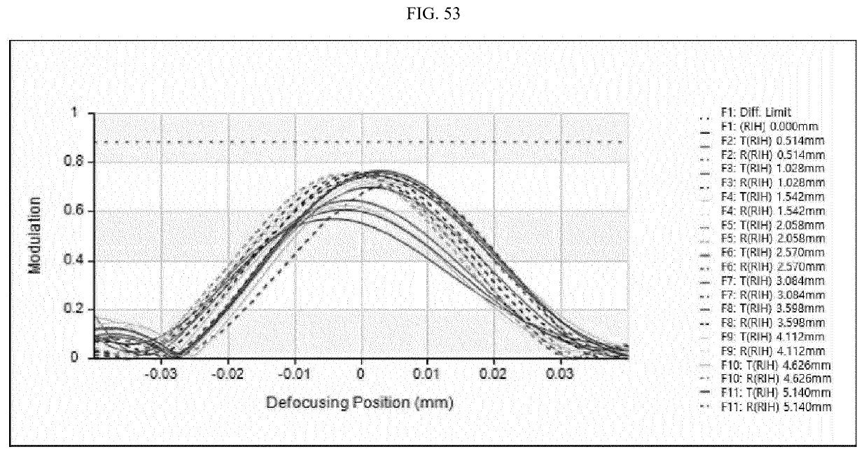

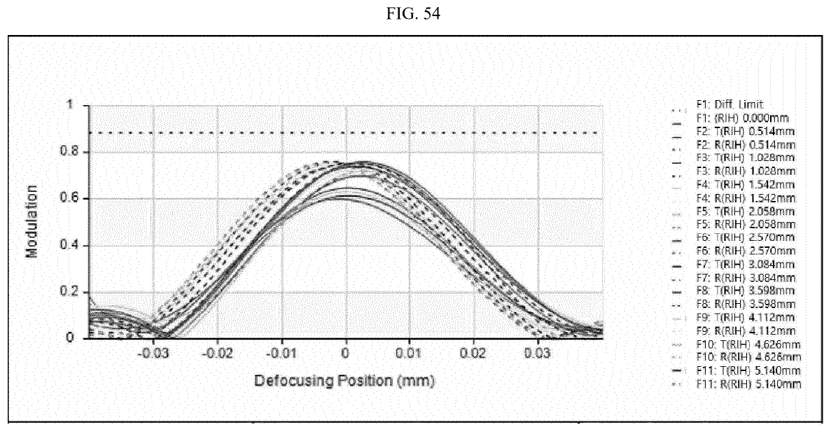

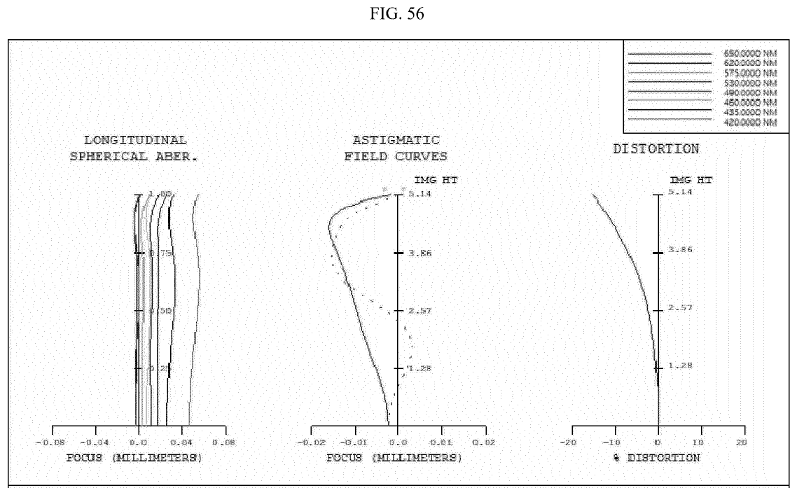

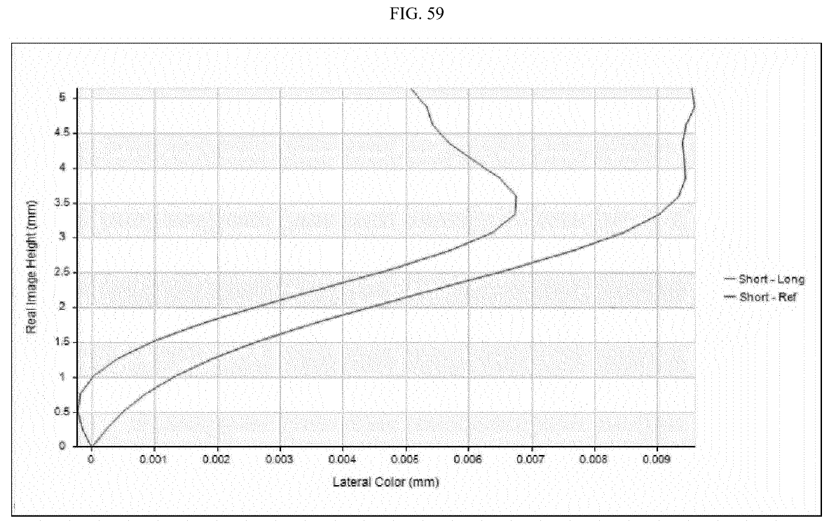

FIG. 48 is a graph showing the ambient light ratio or relative illumination according to the image height in the optical system of FIG. 47, and it may be seen that a peripheral light ratio of 55% or more, for example, 70% or more, appears from the center of the image sensor to the diagonal end. FIG. 49 is a diagram showing the actual FOV and Parax FOV for the horizontal FOV (Field of View) and vertical FOV at room temperature (e.g., 22 degrees) in the optical system of FIG. 47. FIGS. 50 to 52 are graphs showing the diffraction MTF at low temperature, room temperature, and high temperature in the optical system of FIG. 47, and are graphs showing the luminance ratio (modulation) according to the spatial frequency. FIGS. 53 to 55 are graphs showing the MTF at low temperature, room temperature, and high temperature in the optical system of FIG. 47, and are graphs showing the luminance ratio according to the defocusing position. As shown in FIGS. 50 to 55, it may be seen that the luminance ratio (modulation) is hardly changed at a low temperature of −40 degrees, a room temperature of 22 degrees, and a high temperature of 85 degrees. As shown in FIGS. 56 to 58, in the optical system of FIG. 47, longitudinal spherical aberration, astigmatic field curves, and distortion at low temperature, room temperature, and high temperature are ±17 or less (1.0 filed) may be seen As shown in FIGS. 59 to 61, in the optical system of FIG. 47, it may be seen that the actual image heights according to the transverse chromatic aberration at low temperature, room temperature, and high temperature may be within 3 pixels between Red-Green, Green-Blue, and Red-Blue. That is, as shown in FIGS. 50 to 61, it may be seen that the change in data according to the temperature change from low temperature to high temperature is not large, less than 10%.

### Fifth Embodiment

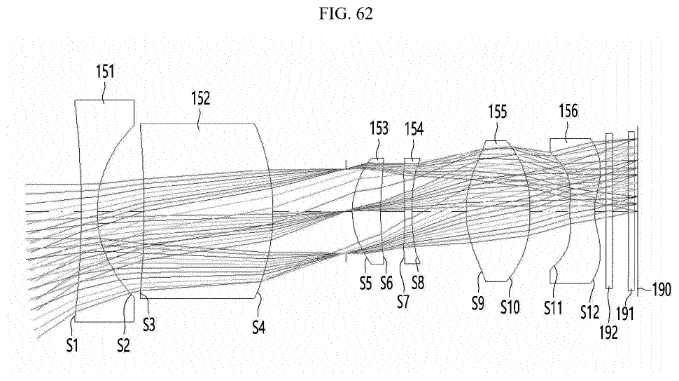

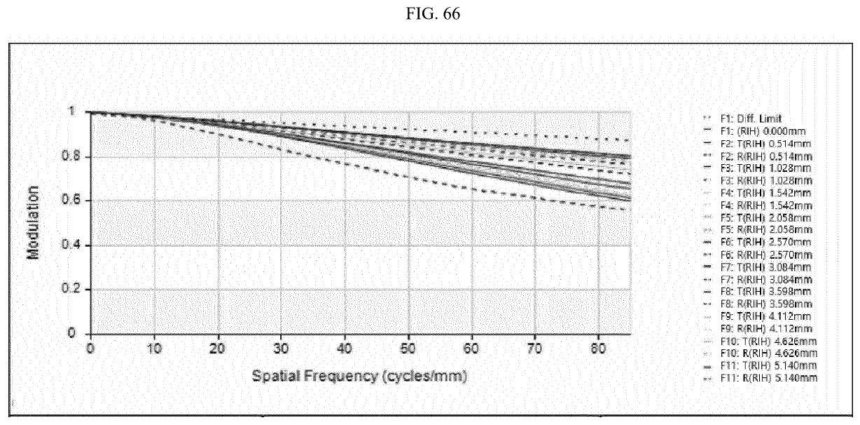

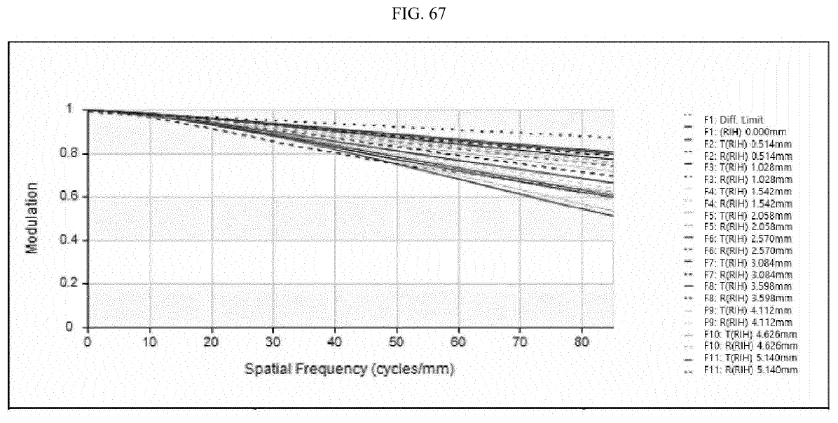

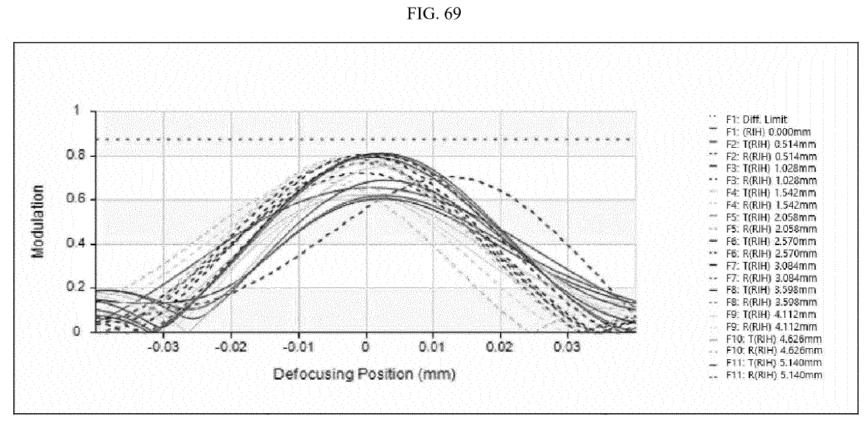

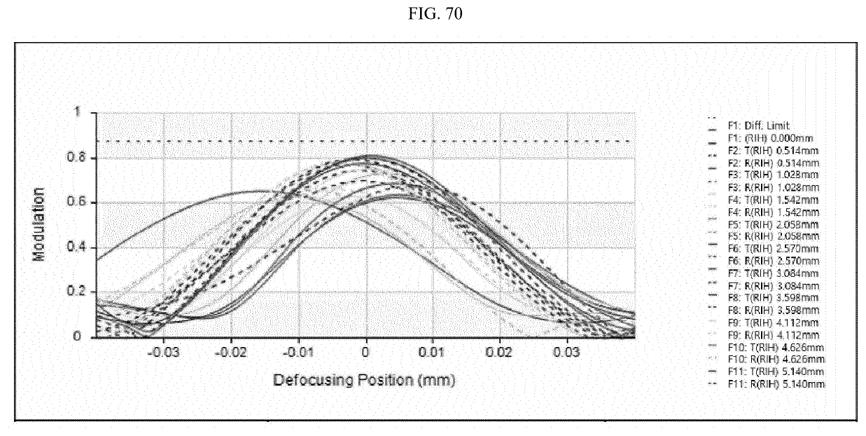

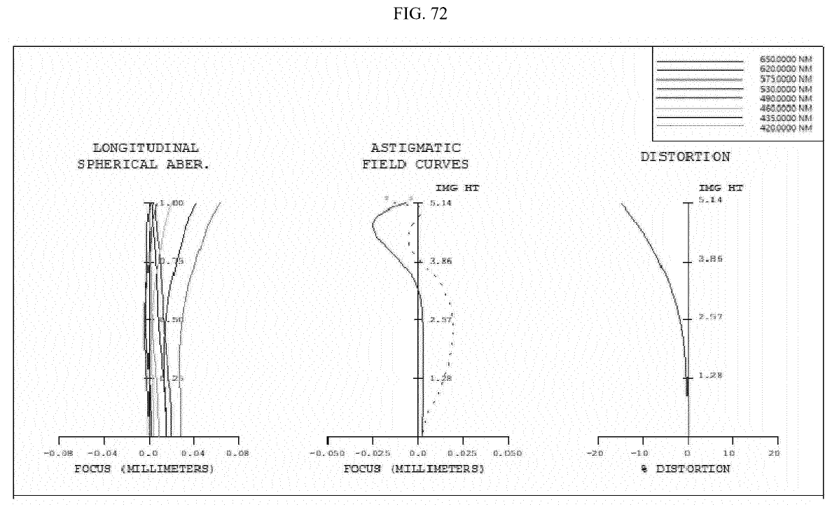

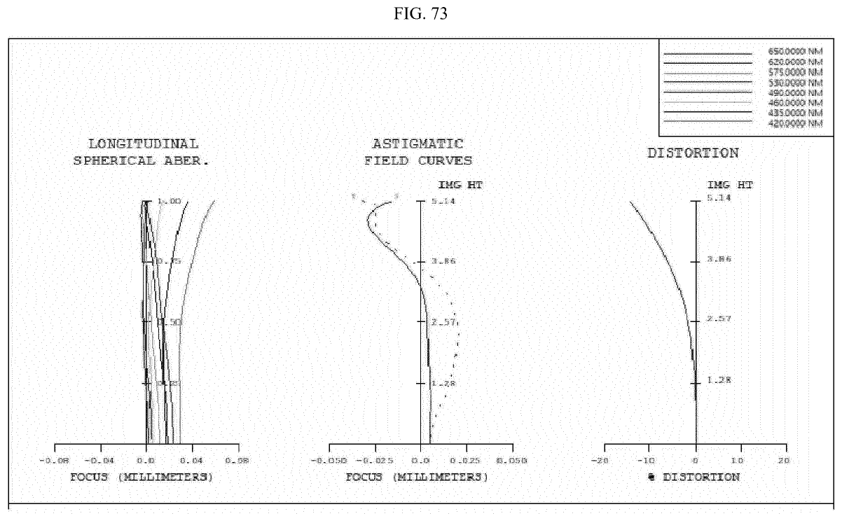

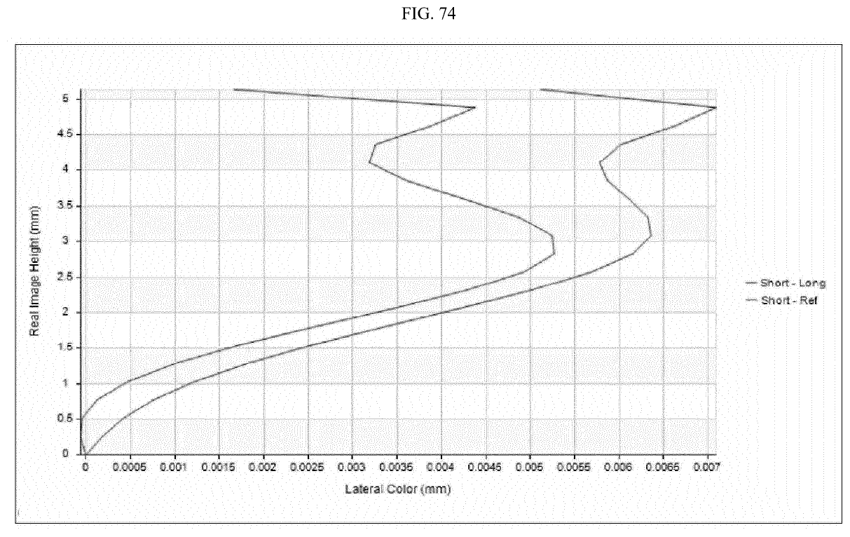

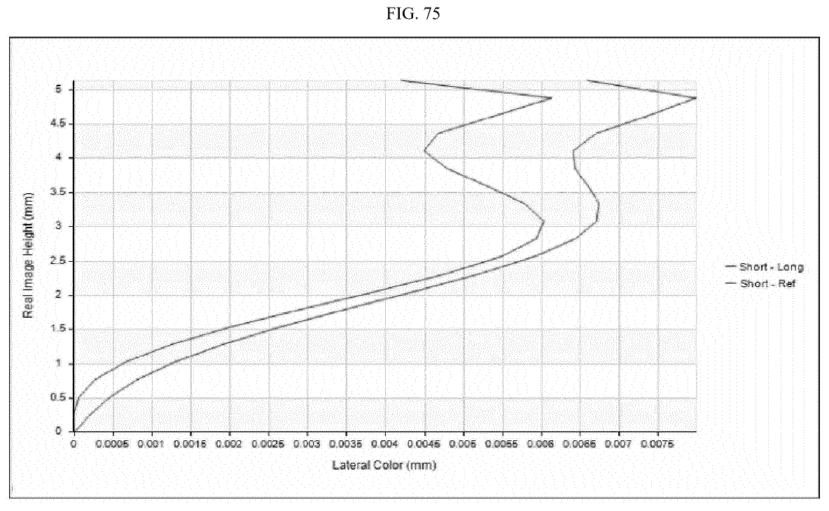

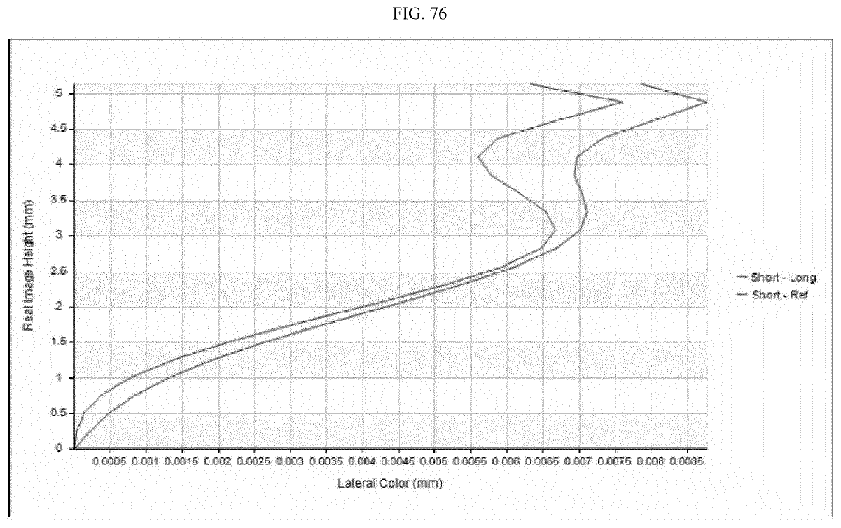

The fifth embodiment will refer to FIGS. 62 to 76. FIG. 62 is a side cross-sectional view showing an optical system for a vehicle according to a fifth embodiment of the invention. In the description of the fifth embodiment, the same configuration as the first to fourth embodiments will be referred to the description of the first to fourth embodiments.

Referring to FIG. 62, the optical system may include a first lens 151, a second Jens 152, a third lens 153, a fourth lens 154, a fifth lens 155 and a sixth lens 156 stacked along the optical axis from the object side to the sensor side. The optical system or a camera module having the same may include an image sensor 190, a cover glass 191 disposed between the image sensor 190 and a last lens 156, and an optical filter 192. The optical system may include an aperture stop ST for adjusting the amount of incident light. Based on the aperture stop ST, the lens group disposed on the object side may be divided into a first lens group and the lens group disposed on the sensor side may be divided into a second lens group. That is, the first lens group may include the first and second lenses 151 and 152, and the second lens group may include the third to sixth lenses 153, 154, 155, and 156. The aperture stop ST may disposed on the outer circumference between the second lens 152 and the third lens 153. The circumference of the sensor-side surface of the second lens 152, or the object-side surface of the third lens 152 may function as an aperture stop.

The first lens 151 is a lens closest to the subject and may include a glass material. Since the first lens 151 may be formed of a crown glass material, a light dispersion value may be high. The first lens 151 includes a first surface S1 on which light is incident and a second surface S2 on which light is emitted, and both the first surface S1 and the second surface S2 may be spherical. The first lens 151 may have negative refractive power and a refractive index of less than 1.55. The first lens 151 may have the lowest refractive index among lenses in the optical system. The first surface S1 of the first lens 151 may be convex toward the object, and the second surface S2 may be concave toward the object. The first lens 151 may have a meniscus shape in which both sides S1 and S2 are convex toward the object side. The second surface S2 may include a flat effective region around an outer periphery. Expressed as an absolute value, the radius of curvature of the first surface S1 may be 3 times or more or 4 times greater than the radius of curvature of the second surface S2. The radius of curvature of the first surface S1 obtained as an absolute value may be the largest among the lenses of the optical system.

The first lens 151 may be made of plastic to prevent discoloration when the camera module is exposed to light from inside or outside the vehicle, and may be made of glass or plastic when the camera module is placed inside the vehicle. The distance between the first lens 151 and the second lens 152 on the optical axis may be 3 times or more of the thickness of the center of the first lens 151, for example, 2.5 mm or more A distance between the first lens 151 and the second lens 152 may be smaller than a distance between the second lens 152 and the third lens 153. The center thickness of the first lens 151 may be thinner than the center thickness of the second lens 152 and may be thicker than the center thickness of the fourth lens 154.

Abbe numbers Vd of the first and third lenses 151 and 153 may be the largest among lenses in the optical system. The Abbe number Vd of the first lens 151 may be, for example, twice or more than the Abbe number Vd of the fourth lens 154. The Abbe number Vd of the first lens 151 may be greater than the Abbe numbers of the second, fifth, and sixth lenses 152, 155, and 156. The Abbe number Vd of the first lens 151 may be, for example, 70 or more or in the range of 75 to 90. Expressed as an absolute value, the focal length of the first lens 151 may be 10 or more, for example, in the range of 10 to 25, and may be larger than the focal lengths of the fifth and sixth lenses 155 and 156. An effective diameter through which light is incident on the first lens 151 may be larger than the effective diameters of the other second to sixth lenses 152, 153, 154, 155, and 156. An effective diameter through which light is incident from the first lens 151 may be larger than the effective diameters of the second to fourth lenses 152, 153, and 154.

The second lens 152 may be made of glass. The second lens 152 has positive (+) refractive power and may be formed of a material having a refractive index of 1.6 or more or 1.7 or more. The refractive index of the second lens 152 may have the highest refractive index among lenses in the optical system. The second lens 152 may be disposed between the first lens 151 and the third lens 153. The second lens 152 includes a third surface S3 through which light is incident and a fourth surface S4 through which light is emitted, and both the third surface S3 and the fourth surface S4 may be spherical. The third surface S3 may be concave, and the fourth surface S4 may be convex toward the sensor. Expressed as an absolute value, the radius of curvature of the third surface S3 may be larger than that of the fourth surface S4 and may be twice or more. When expressed as an absolute value, the radius of curvature of the fourth surface S4 may be smaller than that of the first surface S1. A distance between the second lens 152 and the third lens 153 on the optical axis may be 3 mm or more. The center thickness of the second lens 152 may be 1.5 times or more of the distance between the second and third lenses 152 and 153, and may be 7 mm or more, or may range from 7 mm to 9 mm. The Abbe number Vd of the second lens 152 may be 30 or more, for example, 40 or more. The focal length of the second lens 152 may be 20 mm or more. Since the first and second lenses 151 and 152 are made of a glass material on the object side, an expansion problem caused by heat transmitted through the object side may be reduced. The second lens 152 is made of glass and has a high refractive index and a high dispersion value, so that it can improve the aberration of incident light. An effective diameter through which light is incident from the second lens 152 may be larger than the effective diameters of the third and fourth lenses 153 and 154. The aperture stop ST may be disposed around the periphery between the second and third lenses 152 and 153. The aperture stop ST may be disposed between adjacent lenses made of glass.

The third lens 153 may be a glass material The third lens 153 has positive (+) refractive power and may be formed with a refractive index of 1.6 or less or a refractive index in the range of 1.3 to 1.6. The third lens 153 may be disposed between the second and fourth lenses 152 and 154. The third lens 153 includes a fifth surface SS on which light is incident and a sixth surface S6 on which light is emitted, and both the fifth surface S5 and the sixth surface S6 may be spherical. The fifth surface S5 may be convex toward the object, and the sixth surface S6 may be concave. The third lens 153 may have a meniscus shape convex toward the object side. The radius of curvature of the fifth surface S5 may be smaller than the radius of curvature of the sixth surface S6, for example, 10 mm or less. A radius of curvature of the sixth surface S6 may be greater than or equal to 20 mm. The distance between the third lens 153 and the fourth lens 154 on the optical axis may be smaller than the distance between the second and third lenses 152 and 153. A distance between the third lens 153 and the fourth lens 154 may be smaller than a center thickness of the third lens 153. The center thickness of the third lens 153 may be 2 mm or less, for example, in the range of 1.5 mm to 2 mm.

The refractive indices of the first and third lenses 151 and 153 may be the same or may have a difference of 0.3 or less. The Abbe numbers Vd of the first and third lenses 151 and 153 may be the same or may have a difference of 10 or less. The Abbe number Vd of the third lens 153 may be 60 or more, for example, in the range of 70 to 90. The focal length of the third lens 153 may be 25 mm or less, for example, in the range of 15 mm to 25 mm.

The fourth lens 154 may be made of a plastic material. The fourth lens 154 has negative (−) refractive power and may be formed with a refractive index of 1.6 or more or a refractive index in the range of 1.6 to 1.72. The fourth lens 154 may be disposed between the third and fifth lenses 153 and 155. Here, when the material of the fourth to sixth lenses 154, 155, and 156 is formed of a plastic material, the amount of light may be increased by the aspheric surface of the lens. The fourth lens 154 includes a seventh surface S7 on which light is incident and an eighth surface S8 on which light is emitted, and both the seventh surface S7 and the eighth surface S8 may be aspheric surfaces. The seventh surface S7 may be concave, and the eighth surface S8 may be concave. Expressed as an absolute value, the radius of curvature of the seventh surface S7 may be greater than that of the fifth surface S5 and may be greater than the radius of curvature of the eighth surface S8. Expressed as an absolute value, the difference between them between the radius of curvature of the eighth surface S8 and the radius of curvature of the seventh surface S7 may be 20 mm or less.

The distance between the fourth lens 154 and the fifth lens 155 on the optical axis may be larger than the distance between the third and fourth lenses 153 and 154. The distance between the fourth lens 154 and the fifth lens 155 may be greater than the center thickness of the fourth lens 154, for example, twice or more. The center thickness of the fourth lens 154 may be 1 mm or less, for example, in the range of 0.2 mm to 0.8 mm, and the distance between the fourth lens 154 and the fifth lens 155 may be 2 mm or more, and, for example, it may be in the range of 2 mm to 3 mm. The center thickness of the fourth lens 154 may be the smallest among the lenses of the optical system.

The refractive index of the fourth lens 154 may be higher than that of the fifth lens 155. The Abbe number Vd of the fourth lens 154 may be smaller than the Abbe number of the fifth lens 155, and may be less than 30, for example, in the range of 15 to 29. When the focal length of the fourth lens 154 is obtained as an absolute value, it may be 18 mm or more, for example, in the range of 18 mm to 30 mm.

The fifth lens 155 may be made of a plastic material. The fifth lens 153 may have positive (+) refractive power. The refractive index of the fifth lens 155 is lower than that of the fourth lens 154, and may be formed with a refractive index of 1.6 or less or a refractive index in the range of 1.5 to 1.6. The fifth lens 155 may be disposed between the fourth and sixth lenses 154 and 156. The fifth lens 155 includes a ninth surface S9 on which light is incident and a tenth surface S10 on which light is emitted, and both the ninth surface S9 and the tenth surface S10 may be aspheric surfaces. The ninth surface SS may be convex toward the object, and the tenth surface S10 may be convex. The fifth lens 155 may have a convex shape on both sides. When expressed as an absolute value, the radius of curvature of the ninth surface S9 may be smaller than that of the tenth surface S10, and the difference between them may be 5 mm or more when expressed as an absolute value. The distance between the fifth lens 155 and the sixth lens 156 on the optical axis may be smaller than the distance between the second and third lenses 152 and 153. A distance between the fifth lens 155 and the sixth lens 156 may be smaller than a center thickness of the fifth lens 155. The center thickness of the fifth lens 155 may be the second largest among the lenses of the optical system, and may be greater than or equal to 3 mm, for example, in the range of 3 mm to 4.2 mm. The refractive index of the fifth lens 155 may be smaller than the refractive index of the sixth lens 156, and the Abbe number Vd of the fifth lens 155 may be greater than the Abbe number of the sixth lens 156. The Abbe number Vd of the fifth lens 155 may be 50 or more, for example, in the range of 50 to 60. When the focal length of the fifth lens 155 is obtained as an absolute value, it may be 15 mm or less, for example, in the range of 5 mm to 15 mm.

The sixth lens 156 is a lens closest to the image sensor 190 and may be made of a plastic material. The sixth lens 156 has a negative (−) refractive power, and may be formed with a refractive index of 1.55 or more, for example, in the range of 1.55 to 1.7. The sixth lens 156 includes an eleventh surface S11 on which light is incident and a twelfth surface S12 on which light is emitted, and both the eleventh surface S11 and the twelfth surface S12 may be aspheric surfaces. The eleventh surface S7 may be convex toward the sensor, and the twelfth surface S12 may be concave. At least one or both of the eleventh surface S11 and the twelfth surface S12 of the sixth lens 156 may have an inflection point. The radius of curvature of the eleventh surface S11 may be greater than that of the twelfth surface S12.

The center thickness of the sixth lens 156 may be thicker than the center thickness of the first lens 151, and may be 1 mm or more or may range from 1 mm to 2 mm. The Abbe number Vd of the sixth lens 156 may be 30 or less, for example, in the range of 20 to 30. When the focal length of the sixth lens 156 is obtained as an absolute value, it may be 20 mm or less, for example, in the range of 10 mm to 20 mm. An effective diameter through which light is incident from the sixth lens 156 may be larger than the effective diameters of the third and fourth lenses 153 and 154. Here, the ratio of the lenses disposed on the sensor side and the lenses disposed on the object side based on the aperture stop ST may be 2:1.

For the image sensor 190, the optical filter 192, and the cover glass 191, the description of the above-described embodiment will be referred to. In the optical system according to the fifth embodiment of the invention, the angle of view (diagonal line) may be 70 degrees or more, for example, in the range of 73 degrees to 77 degrees. The effective focal length may be greater than or equal to 7 mm, such as in the range of 7 mm to 8 mm. The F number of the optical system or camera module may be 2.2 or less, for example, in the range of 1.7 to 2.2. The chief ray angle (CRA) may be greater than or equal to 10 degrees, such as in the range of 10 to 15 degrees. In the optical system, a distance (TTL) between the image sensor 190 and the vertex of the first lens 151 may be 40 mm or less. In addition, the wavelength of light used in the optical system may be in the range of 400 nm to 700 nm.

Table 9 shows lens data in the optical system of FIG. 62.

TABLE 9

| | | | | | Refractive | Abbe | | | |
|---|---|---|---|---|---|---|---|---|---|
| | | | Radius of | Thickness/ | index | number | | Focal | Effective |
| | Surface | Shape | curvature | Distance | Nd | Vd | Diopter | length | radius |
| Lens 1 | S1 | Sphere | −280.070 | 0.700 | 1.497 | 81.607 | −57.45 | −17.41 | 7.301 |
| | S2 | Sphere | 8.973 | 2.718 | | | | | 5.966 |
| Lens 2 | S3 | Sphere | −63.835 | 8.406 | 1.774 | 49.624 | 33.60 | 29.76 | 5.749 |
| | S4 | Sphere | −17.968 | 4.413 | | | | | 5.000 |
| Stop | | Flat | 1.E+18 | | | | | | |
| Lens 3 | S5 | Sphere | 6.446 | 1.709 | 1.497 | 81.607 | 61.19 | −16.34 | 3.292 |
| | S6 | Sphere | 28.004 | 1.023 | | | | | 3.268 |
| Lens 4 | S7 | Asphere | −38.152 | 0.450 | 1.545 | 19.246 | −42.21 | −23.69 | 3.305 |
| | S8 | Asphere | 28.260 | 2.437 | | | | | 3.297 |
| Lens 5 | S9 | Asphere | 7.148 | 3.984 | 1.637 | 56.095 | 105.46 | 9.48 | 4.621 |
| | S10 | Asphere | −15.202 | 0.591 | | | | | 4.600 |
| Lens 6 | S11 | Asphere | 19.683 | 1.464 | 1.637 | 23.901 | −88.83 | −11.26 | 4.206 |
| | S12 | Asphere | 5.147 | 0.788 | | | | | 4.873 |
| BPF | Sa | Flat | 1.E+18 | 0.400 | 1.517 | 64.166 | | | |
| | Sb | Flat | 1.E+18 | 1.000 | | | | | |
| | Sc | Flat | 1.E+18 | 0.400 | 1.517 | 64.166 | | | |
| Cover | Sd | Flat | 1.E+18 | 0.200 | | | | | |
| glass | | | | | | | | | |
| CIS | | Flat | 1.E+18 | 0.000 | | | | | |

In Table 9, the refractive indices of the first to sixth lenses 151, 152, 153, 154, 155, and 156 are the refractive indices at 587 nm, the Abbe numbers Vd of the first to sixth lenses 151, 152, 153, 154, 155, and 156 at d-line (587 nm) may be less than 30 for the fourth lens 154 and the sixth lens 156 and may be 50 or more for the first, third and fifth lenses 151, 153 and 155. Based on Table 9 above, the values of the radius (mm) of curvature, thickness (mm), distance (mm), refractive index, Abbe number, and focal length (mm) can also be expressed by the above relational expression. For example, looking at the Abbe number, the relational expression may be in the order of first and third lenses>fifth lens>second lens>fifth lens>fourth lens. Table 10 is the aspherical coefficient of each surface of each lens in the optical system of FIG. 62.

TABLE 10

| | | Aspherical coefficient | | | | |
|---|---|---|---|---|---|---|
| Item | Surface | K | A | B | C | D |
| Lens 1 | S1 | | | | | |
| | S2 | | | | | |
| Lens 2 | S3 | | | | | |
| | S4 | | | | | |
| Lens 3 | S5 | | | | | |
| | S6 | | | | | |
| Lens 4 | S7 | 39.2490976 | 0.0001875 | 0.0000810 | 0.0000007 | −1.07E−07 |
| | S8 | 15.9872457 | 0.0000588 | 0.0001095 | 0.0000010 | −1.05E−07 |
| Lens 5 | S9 | −2.4578343 | 0.0000320 | −0.0000007 | −0.0000003 | 6.87E−09 |
| | S10 | 6.3473556 | −0.0011846 | 0.0000385 | −0.0000012 | 4.14E−08 |
| Lens 6 | S11 | −99.0000000 | −0.0083581 | 0.0000252 | 0.0000149 | −2.22E−07 |
| | S12 | −5.1365465 | −0.0058209 | 0.0002027 | −0.0000039 | −5.25E−09 |
| | | Aspherical coefficient | | | | |
| Item | Surface | E | F | G | H | J |
| Lens 1 | S1 | | | | | |
| | S2 | | | | | |
| Lens 2 | S3 | | | | | |
| | S4 | | | | | |
| Lens 3 | S5 | | | | | |
| | S6 | | | | | |
| Lens 4 | S7 | −9.49E−09 | −3.04E−10 | 3.35E−11 | 4.17E−12 | −2.42E−13 |
| | S8 | −7.05E−09 | 1.51E−10 | 3.76E−11 | −1.50E−12 | −2.16E−14 |
| Lens 5 | S9 | 3.56E−10 | 2.40E−12 | −2.69E−13 | −4.53E−15 | 3.21E−16 |
| | S10 | 5.33E−10 | −1.97E−11 | −8.08E−13 | 6.98E−15 | 8.70E−16 |
| Lens 6 | S11 | −5.14E−09 | −2.10E−10 | 1.31E−12 | 3.22E−13 | −4.80E−15 |
| | S12 | 2.76E−09 | 2.94E−11 | −3.09E−12 | −6.54E−14 | 2.49E−15 |

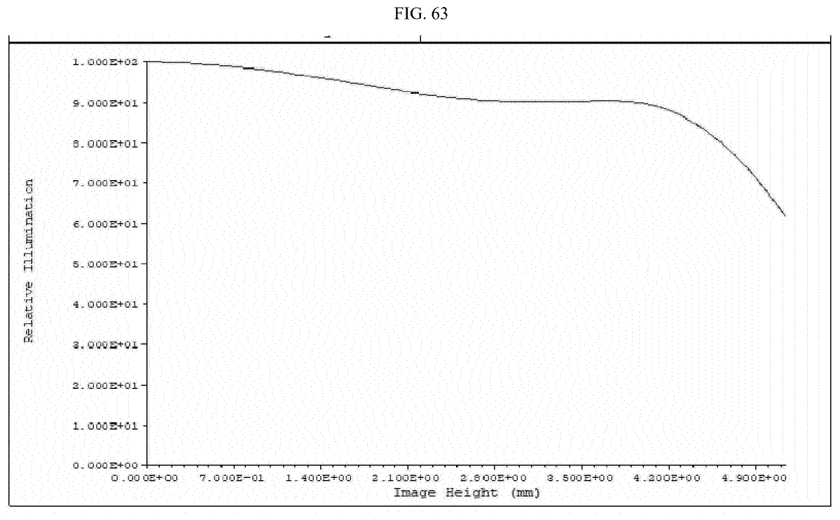

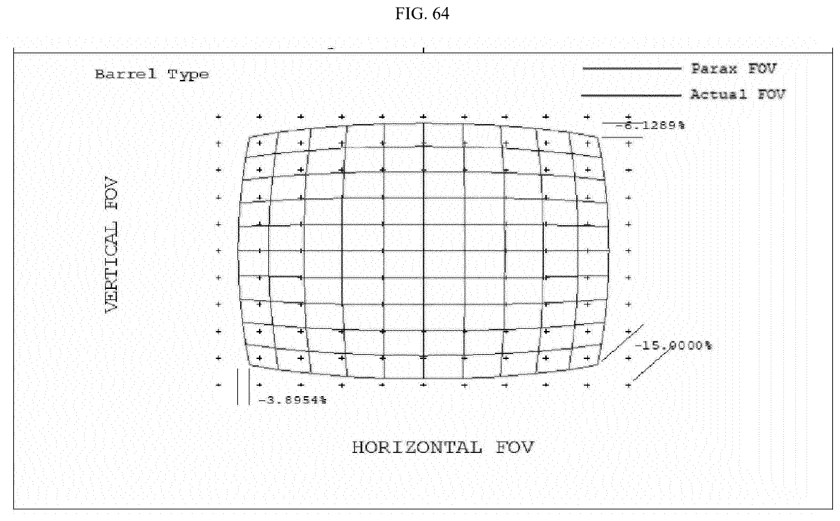

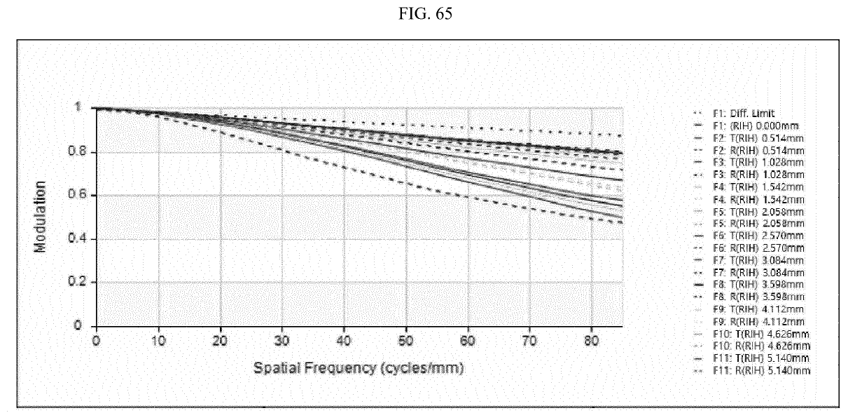

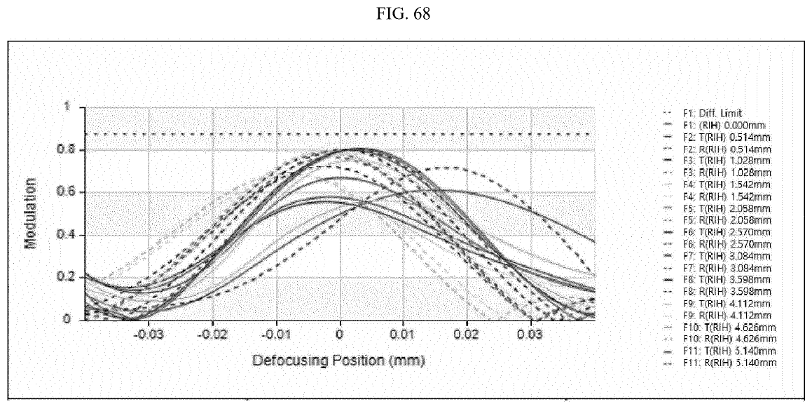

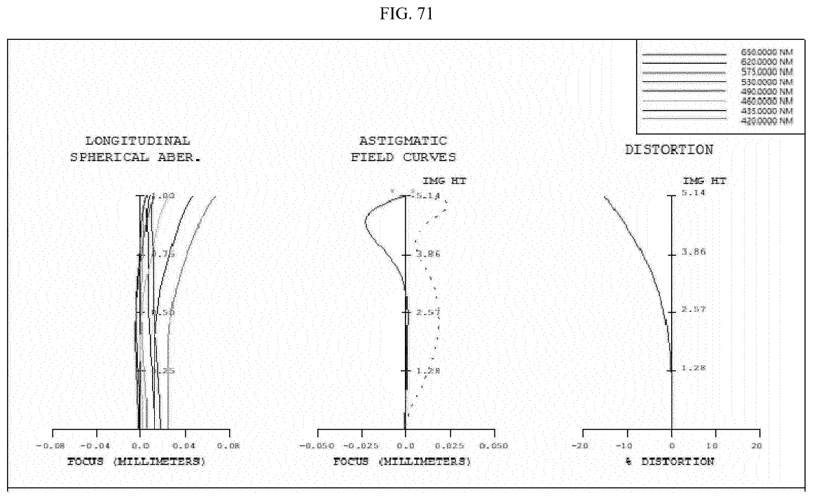

FIG. 63 is a graph showing the ambient light ratio or relative illumination according to the image height in the optical system of FIG. 62, and it may be seen that a peripheral light ratio of 55% or more, for example, 70% or more, appears from the center of the image sensor to the diagonal end. FIG. 64 is a diagram showing the actual FOV and Parax FOV for the horizontal FOV (Field of View) and vertical FOV at room temperature (e.g., 22 degrees) in the optical system of FIG. 62. FIGS. 65 to 67 are graphs showing the diffraction MTF at low temperature, room temperature, and high temperature in the optical system of FIG. 62, and are graphs showing the luminance ratio (modulation) according to the spatial frequency. FIGS. 68 to 70 are graphs showing diffraction MTF at low temperature, room temperature, and high temperature in the optical system of FIG. 62, and are graphs showing the luminance ratio according to the defocusing position. As shown in FIGS. 65 to 70, it may be seen that the luminance ratio (modulation) is hardly changed at a low temperature of −40 degrees, a room temperature of 22 degrees, and a high temperature of 85 degrees. As shown in FIGS. 71 to 73, in the optical system of FIG. 62. longitudinal spherical aberration, astigmatic field curves, and distortion at low temperature, room temperature, and high temperature are ±17 or less (1.0 filed) may be seen. As shown in FIGS. 74 to 76, in the optical system of FIG. 62, it may be seen that the actual image heights according to the transverse chromatic aberration at low temperature, room temperature, and high temperature may be within 3 pixels between Red-Green, Green-Blue, and Red-Blue. That is, as shown in FIGS. 65 to 76, it may be seen that the change in data according to the temperature change from low temperature to high temperature is not large, less than 10%.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention.

In addition, although the above has been described with a focus on the embodiments, these are only examples and do not limit the invention, and those skilled in the art to which the invention belongs can exemplify the above to the extent that does not deviate from the essential characteristics of the present embodiment. It will be seen that various variations and applications that have not been made are possible. For example, each component specifically shown in the embodiment may be modified and implemented. And differences related to these modifications and applications should be construed as being included in the scope of the invention as defined in the appended claims.

1. An optical system comprising:
a first lens, a second lens, a third lens, a fourth lens, a fifth lens, and a sixth lens disposed along an optical axis in a direction from an object side to a sensor side,
wherein the first lens includes an object-side first surface convex and a sensor-side second surface concave on the optical axis,
wherein the second lens includes a third surface on the object side and a fourth surface on the sensor side,
wherein the third lens includes a fifth surface on the object side and a sixth surface on the sensor side,
wherein the fourth lens includes a seventh surface on the object side and an eighth surface on the sensor side,
wherein the fifth lens includes a ninth surface on the object side and a tenth surface on the sensor side,
wherein the sixth lens includes an object-side eleventh surface convex and a sensor-side twelfth surface concave on the optical axis,
wherein an effective diameter of the first lens is larger than an effective diameter of each of the second to sixth lenses,
wherein the first lens includes a glass material,
wherein the eleventh and twelfth surfaces of the sixth lens have aspheric surfaces and the sixth lens is made of plastic material,
wherein at least three of the second to sixth lenses are made of plastic,
wherein a center thickness of the fifth lens is a thickest among center thicknesses of the first to sixth lenses, and
wherein a distance between the first and second lenses on the optical axis is a largest among distances between adjacent lenses.

2. The optical system of claim 1, wherein the second lens is made of glass, and
wherein a ratio of the lenslenses made of plastic to a lenslenses made of glass is 1:1 in the optical system.

3. The optical system of claim 1, wherein the second lens is made of glass, and
wherein a ratio of lenses made of plastic to lenses made of glass is 2:1 in the optical system.

4. The optical system of claim 1, wherein a distance between a vertex of the first surface of the first lens and an image sensor in the optical axis is TTL, wherein the TTL in the optical system is 40 mm or less, and F number is 1.7 to 2.2.

5. (canceled)

6. (canceled)

7. The optical system of claim 1, wherein an Abbe number of the first lens is a largest among lenses in the optical system and is 70 or more.

8. The optical system of claim 7, wherein the second lens has the third surface convex and the fourth surface convex on the optical axis,
wherein the third lens has the fifth surface convex and the sixth surface concave on the optical axis,
wherein the fourth lens has the seventh surface convex and the eighth surface concave on the optical axis, and
wherein the fifth lens has the ninth surface convex and the tenth surface convex on the optical axis.

9. A camera module comprising:
an image sensor;
an optical filter on the image sensor;
a cover glass disposed between the optical filter and the image sensor;
an optical system including a first lens, a second lens, a third lens, a fourth lens, a fifth lens, and a sixth lens disposed along an optical axis in a direction from an object side to a sensor side; and
an aperture stop disposed around a sensor-side surface of the third lens or around an object-side surface of the third lens,
wherein the first lens includes an object-side first surface convex and a sensor-side second surface concave on an optical axis,
wherein the sixth lens includes an object-side eleventh surface convex and a sensor-side twelfth surface concave on the optical axis,
wherein an effective diameter of the first lens is larger than an effective diameter of each of the second to sixth lenses,
wherein the first and second lenses include a glass material,
wherein the eleventh and twelfth surfaces of the sixth lens are aspheric and the sixth lens is made of plastic material,
wherein at least three of the second to sixth lenses are made of plastic, wherein a ratio of plastic lenses to glass lenses among the first to sixth lenses is 1:1 to 2:1,
wherein a center thickness of the fifth lens is a thickest among center thicknesses of the first to sixth lenses, and
wherein a distance between the first and second lenses on the optical axis is a largest among distances between adjacent lenses.

10. The optical system of claim 9,
wherein the first to third lenses are made of glass material, and
wherein the fourth to sixth lenses are made of plastic material.

11. The optical system of claim 10, wherein a distance between a vertex of the first surface of the first lens and the image sensor is 40 mm or less.

12. The optical system of claim 9, wherein the first lens has a negative refractive power and a refractive index of less than 1.55.

13. The optical system of claim 9, wherein the fifth lens has a positive refractive power, and
wherein the fifth lens has a ninth surface convex and a tenth surface convex on the optical axis.

14. An optical system comprising:
a first lens, a second lens, a third lens, a fourth lens, a fifth lens, and a sixth lens disposed along an optical axis in a direction from an object side to a sensor side,
wherein the first lens includes an object-side surface convex and a sensor-side surface concave on the optical axis,
wherein the sixth lens includes an object-side surface convex and a sensor-side surface concave on the optical axis,
wherein an effective diameter of the first lens is larger than an effective diameter of each of the second to sixth lenses;
wherein the first lens includes a glass material,
wherein an object-side surface and a sensor-side surface of the sixth lens are aspheric surfaces,
wherein the sixth lens is made of a plastic material,
wherein the fifth lens has a positive refractive power,
wherein an object-side surface of the fifth lens has a convex shape on the optical axis,
wherein a center thickness of the fifth lens is greater than a center thickness of the sixth lens,
wherein at least one of a distance between the first and second lenses and a distance between the second and third lenses on the optical axis is greater than a distance between the fifth lens and the sixth lens on the optical axis, and
wherein a refractive index of the first lens is smaller than a refractive index of the second lens and is less than 1.55.

15. The optical system of claim 14, wherein the refractive index of the first lens is smaller than a refractive index of each of the fifth and sixth lenses.

16. The optical system of claim 14, wherein a center thickness of the second lens is greater than a center thickness of the fifth lens,
wherein a sensor-side surface of the fifth lens has a convex shape on the optical axis, and
wherein a distance between the first and second lenses on the optical axis is a largest among distances between adjacent lenses.

17. The optical system of claim 14, wherein the refractive index of the first lens is smaller than a refractive index of each of the fourth to sixth lenses.

18. The optical system of claim 17, wherein the first and second lenses are made of glass material.

19. The optical system of claim 17, wherein the fourth to sixth lenses are made of a plastic material.

20. The optical system of claim 14, wherein the center thickness of the fifth lens is greater than a center thickness of each of the first and second lenses.

21. The optical system of claim 14, wherein a center thickness of the second lens is greater than a center thickness of each of the first and fifth lenses.

22. The optical system of claim 14, wherein a ratio of plastic lenses to glass lenses among the first to sixth lenses is 1:1 to 2:1.
